(19) United States
(12) Patent Application Publication
(10) Pub. No.: US 2025/0190357 A1
(43) Pub. Date: Jun. 12, 2025

(54) SCALING CHIPS WITH OPTICAL MEMORY APPLIANCES

(71) Applicant: Celestial AI Inc., Santa Clara, CA (US)

(72) Inventors: Francisco José Maia Da Silva, Porto (PT); Martinus Bos, Santa Clara, CA (US); Philip Winterbottom, San Jose, CA (US)

(21) Appl. No.: 18/974,460

(22) Filed: Dec. 9, 2024

Related U.S. Application Data
(60) Provisional application No. 63/608,109, filed on Dec. 8, 2023.

(51) Int. Cl. G06F 12/0893; G02B 6/122; G06F 12/0806

(52) U.S. Cl. CPC G06F 12/0893; G02B 6/122; G06F 12/0806

(57) ABSTRACT

The subject matter of this specification can be embodied in, among other things, a method that includes receiving, by a first memory switch of a first processor node, data from a first on-chip memory of the first processor node, wherein the first processor node comprises a first processor circuit, receiving, by a first photonic transceiver, the data from the first memory switch, transmitting, by the first photonic transceiver, the data over a photonic link, receiving, by a second photonic transceiver, the data from the photonic link, transmitting, by the second photonic transceiver, the data to a second memory switch of a second processor node comprising a second processor circuit, wherein the second photonic transceiver is in electrical communication with the second memory switch in parallel with the second processor circuit, and storing, by the second memory switch, the data in a second on-chip memory of the second processor node.

### CROSS-REFERENCE TO RELATED APPLICATIONS

The present application claims priority to and incorporates by reference U.S. Provisional Patent Application Ser. No. 63/608,109 entitled MEMORY NETWORK, filed on Dec. 8, 2023. The present application incorporates by reference U.S. Provisional Patent Application Ser. No. 63/441,689, entitled LOAD/STORE UNIT FOR A TENSOR ENGINE AND METHODS FOR LOADING OR STORING A TENSOR, filed Jan. 27, 2023 and U.S. patent application Ser. No. 18/423,210, entitled LOAD/STORE UNIT FOR A TENSOR ENGINE AND METHODS FOR LOADING OR STORING A TENSOR, filed Jan. 25, 2024.

### TECHNICAL FIELD

The present disclosure relates to multiple-processor computing systems with optically linked memory subsystems.

### BACKGROUND

Current electronic processing systems are increasingly constrained by memory latency and bandwidth. As silicon processing node sizes have decreased, the speed and energy consumption of computation have improved while the interconnection to memory has not kept pace. Where improvements in memory bandwidth and latency have been achieved, it has been at the cost of imposing significant constraints on signal integrity and complexity of packaging. State-of-the-art high bandwidth memory (HBM) dynamic random-access memory (DRAM) generally requires the memory to be mounted on a silicon interposer to be placed within a few millimeters of the client device that uses the memory, with pins that run over electrical wires at over 3 GHz, for example, imposing signal-integrity as well as thermal constraints that are both complex and expensive to meet. Moreover, the need to place the memory elements close to the chips that use them highly constrains the number and arrangement of HBM stacks around the client device and places significant restrictions on the total amount of memory that can be integrated into such a conventional system.

Demands for artificial intelligence (AI) computing, such as machine learning (ML) and deep learning (DL), are increasing faster than they can be met by increases in available processing capacity. This rising demand and the growing complexity of AI models drive the need to connect many chips into a system where the chips can send data between each other with low latency and at high speed. Performance when processing a workload is limited by memory and interconnect bandwidth. In many conventional systems, data movement leads to significant power consumption, poor performance, and excessive latency. Thus, multi-node computing systems that can process and transmit data between nodes quickly and efficiently may be advantageous for the implementation of (ML) models.

### SUMMARY

In general, this document describes multiple-processor computing systems with optically linked memory subsystems. In order to reduce the amount of time and power needed to perform memory operations in a system with multiple interconnected compute nodes, the systems described in this document utilize optical communication channels to communicatively interconnect on-chip memories of multiple compute nodes to form a distributed, collective (e.g., virtual) memory that is available to the processor(s) of the participating compute nodes. By utilizing on-chip memories, data movements can occur more quickly and with less power (e.g., compared to using high-bandwidth memory), and by utilizing photonics, data movements can happen more quickly and over greater distances (e.g., compared to using electronic communications) and promote system design flexibility and scalability. Furthermore, the optical communication is implemented in a way that reduces space and power consumption and heat generation by optical transceivers by offloading light-generating components (e.g., lasers, LEDs) to remotely located light engines that can be shared by, and powered and/or cooled apart from, the compute nodes.

The systems and techniques described here may provide one or more of the following advantages. First, a system can provide increased computing bandwidth. Second, the system can improve scalability of computer systems. Third, the system can reduce the production of waste heat. Fourth, the system can reduce energy consumption used for computing operations. Fifth, the system can reduce energy consumption used for cooling operations. Sixth, the system can reduce and/or prevent greenhouse gas emissions through reduced consumption of power that may be at least partly obtained from greenhouse gas-emitting fossil fuel based electrical generators.

### DESCRIPTION OF DRAWINGS

FIG. 1-1 is a diagram schematically illustrating components of an example system-in-package (SIP), according to at least one embodiment of the present disclosure.

FIG. 1-2 is a block diagram illustrating various components of the example of the computing node of FIG. 1-1.

FIG. 1-3 is a block diagram illustrating various components of the example computing node of FIG. 1-1.

FIG. 1-4 is a diagram illustrating a side view of an example structural implementation of the circuit package of FIG. 1-1.

FIG. 2-1 illustrates an example of a circuit package implementing an intra-chip bidirectional photonic channel between a first compute node and a second compute node, according to at least one embodiment of the present disclosure.

FIG. 2-2 illustrates an example circuit package implementing an inter-chip bidirectional photonic channel between a compute node and an additional compute node located on an additional circuit package, according to at least one embodiment of the present disclosure.

FIG. 3-1 is a diagram illustrating an example of a circuit package implementing a plurality of compute nodes, according to at least one embodiment of the present disclosure.

FIG. 3-2 is a diagram illustrating an example of the circuit package of FIG. 3-1.

FIG. 3-3 is a diagram illustrating an example of the circuit package of FIG. 3-1.

FIG. 3-4 is a diagram illustrating an example of the circuit package of FIG. 3-1.

FIG. 3-5 is a diagram illustrating an example of the circuit package of FIG. 3-1.

FIG. 4 is a diagram illustrating an example implementation of four of the circuit packages of FIG. 2-1 being interconnected.

FIG. 5-1 is a diagram illustrating an example implementation of an inter-chip electro-photonic network, according to at least one embodiment of the present disclosure;

FIG. 5-2 is a diagram illustrating an example implementation of a higher-dimensional inter-chip electro-photonic network, according to at least one embodiment of the present disclosure;

FIG. 6 is a block diagram that shows an example of a system for scaling memory access by using a shared collection of memory devices, according to at least one embodiment of the present disclosure.

FIG. 7 is flow chart that shows an example of a process for scaling memory access by using a shared collection of memory devices, according to at least one embodiment of the present disclosure.

FIG. 8 is a timeline diagram of an example of a process for retrieving data from a shared collection of memory devices, according to at least one embodiment of the present disclosure.

FIG. 9 is a timeline diagram of another example of a process for retrieving data from a shared collection of memory devices, according to at least one embodiment of the present disclosure.

FIG. 10 is flow chart that shows an example of a process for handling request addressing in a shared collection of memory devices, according to at least one embodiment of the present disclosure.

FIG. 11 is a flow chart that shows an example of a process for a computerized matrix multiplication operation, according to at least one embodiment of the present disclosure.

FIGS. 12 and 13 are flow charts that show an example of a process for another computerized matrix multiplication operation, according to at least one embodiment of the present disclosure.

FIGS. 14 and 15 are conceptual illustrations of an example computerized matrix multiplication operation, according to at least one embodiment of the present disclosure.

FIGS. 16 and 17 are flow charts that show an example of a process for another computerized matrix multiplication operation, according to at least one embodiment of the present disclosure.

FIGS. 18A-18D are conceptual illustrations of an example computerized matrix multiplication operation, according to at least one embodiment of the present disclosure.

FIGS. 19 and 20 are flow charts that show an example of a process for another computerized matrix multiplication operation, according to at least one embodiment of the present disclosure.

FIG. 21 is a conceptual illustration of an example computerized matrix multiplication operation, according to at least one embodiment of the present disclosure.

FIGS. 22 and 23 are flow charts that show an example of a process for another computerized matrix multiplication operation, according to at least one embodiment of the present disclosure.

FIG. 24 is a block diagram of a tensor engine with a load/store unit (LDSU) according to one implementation.

FIG. 25 is a diagram that illustrates a prior art three-dimensional tensor walking process according to one implementation.

FIG. 26 is a top-view of a tensor engine with an LDSU according to one implementation.

FIG. 27 is a top-view of a compute element that can be used in a tensor engine with an LDSU according to one implementation

FIG. 28 is a top-view of a node with a tensor engine with an LDSU that resides in an ML accelerator according to one implementation.

FIG. 29 is a block diagram illustrating details of the operation of an LDSU according to one implementation.

FIG. 30 is a block diagram illustrating details of the operation of an LDSU according to one implementation.

FIG. 31 is a block diagram illustrating details of the operation of an LDSU according to one implementation.

FIG. 32 is a block diagram illustrating details of the operation of an LDSU according to one implementation.

FIG. 33 is a block diagram illustrating details of the operation of an LDSU according to one implementation.

FIG. 34 is a block diagram illustrating details of the operation of an LDSU according to one implementation.

FIG. 35 is a block diagram illustrating details of a striding module according to one implementation.

FIG. 36 is a block diagram illustrating details of a walking module according to one implementation.

FIG. 37 is a flowchart illustrating the operation of a tensor engine with an LDSU according to one implementation.

FIG. 38 is a flowchart illustrating the operation of a tensor walking module according to one implementation.

FIG. 39 is a flowchart illustrating the operation of a method for processing a tensor according to one implementation.

### DETAILED DESCRIPTION

The present disclosure provides computing systems, implemented by one or more circuit packages (e.g., SIPs), that achieve reduced power consumption, reduced heat productions, and/or increased processing speed. In accordance with various embodiments, power consumed for, in particular, data movement is reduced by maximizing data locality in each circuit package and reducing energy losses when data movement is needed. Power-efficient data movement, in turn, can be accomplished by moving data over small distances in the electronic domain, while leveraging photonic channels for data movement in scenarios where the resistance in the electronic domain and/or the speed at which the data can move in the electronic domain leads to bandwidth limitations that cannot be overcome using existing electronic technology. Thus, in some embodiments, each circuit package includes an electronic integrated circuit (EIC) comprising multiple circuit blocks (hereinafter “processing elements” or “compute nodes”) that are connected by bidirectional photonic channels (e.g., implemented in a photonic integrated circuit (PIC) in a separate layer or chip of the package) into a hybrid, electronic-photonic (or electro-photonic) network-on-chip (NoC). Multiple such NoCs may be connected, by inter-chip bidirectional photonic channels between respective circuit packages (e.g., implemented by optical beam, fiber, or waveguide), into a larger electro-photonic network, to scale the computing system to arbitrary size without incurring significant power or speed losses.

This document describes systems describes multiple-compute nodes computing systems with optically linked memory subsystems. In general, conventional compute nodes use one or more processors and random-access memory (RAM), however accessing the RAM can incur delays that can impact overall computing speeds. Processors generally implement a memory cache in which a small and fast (e.g., relative to the amount and speed of conventional RAM) bank of memory is used in order to speed up operations that use frequently accessed data before the data is committed to RAM. Computing speeds of conventional computer architectures suffer further bandwidth issues when data needs to be shared between two or more processors, generally requiring data to be retrieved by one processor from its local RAM, transmitted over some form of electronic data bus, received by a remote processor, and placed in the remote RAM for processing by the remote processor.

In general, the systems described in this document implement a computer architecture in which two or more high-speed on-chip memories of two or more corresponding compute nodes are optically interconnected. As will be explained in more detail below, the separate on-chip memories (or portions thereof) become physical portions of a larger collective memory with a universal addressing space. Each compute node can access data stored across the collective memory by requesting and/or storing data to and/or from addresses in the universal addressing space. Access operations to/from portions of the addressing space that correspond to physically local memory (e.g., electronically accessible by a processor) are handled locally, while access operations to/from portions of the addressing space that correspond to physically remote (e.g., at another computing node) are identified and communicated over an optical bus.

Generally speaking, and as will be discussed in more detail below, computing operations that use multiple compute nodes can be accelerated by allowing information to be stored, updated, and retrieved within high speed on-chip memories at optical speeds instead of (or in addition to) more conventional techniques for sharing data among multiple compute nodes (e.g., accessing conventional RAM, communicating over an electronic backplane, bus, or network). Inter-node data transfer latencies can be further reduced by operating at optical rather than electronic speeds, which allows the connected compute nodes to be physically further separated from each other. Furthermore, the use of optics in such architectures can reduce the amount of electrical power consumed by, and the amount of waste heat generated by, compute nodes for the purposes of inter-node communications. The reductions in direct power consumption (e.g., by the compute node) and indirect power consumption (e.g., used for cooling compute nodes) can reduce and/or prevent greenhouse gas emissions from power obtained from greenhouse gas-emitting fossil fuel based electrical generators.

The foregoing high-level summary of various beneficial aspect and features of the disclosed computing systems and underlying concepts will become clearer from the following description of example embodiments.

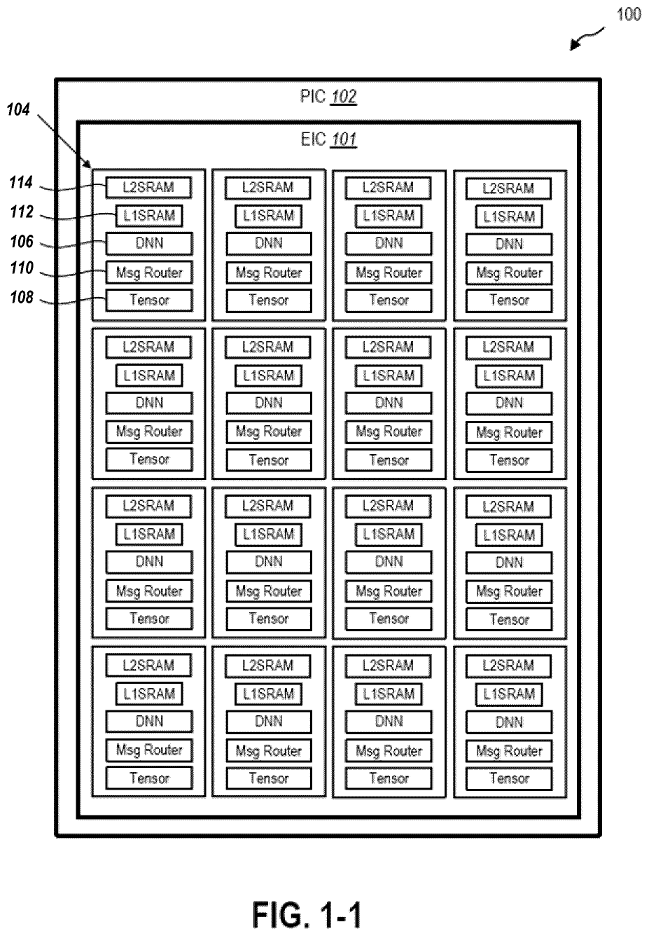

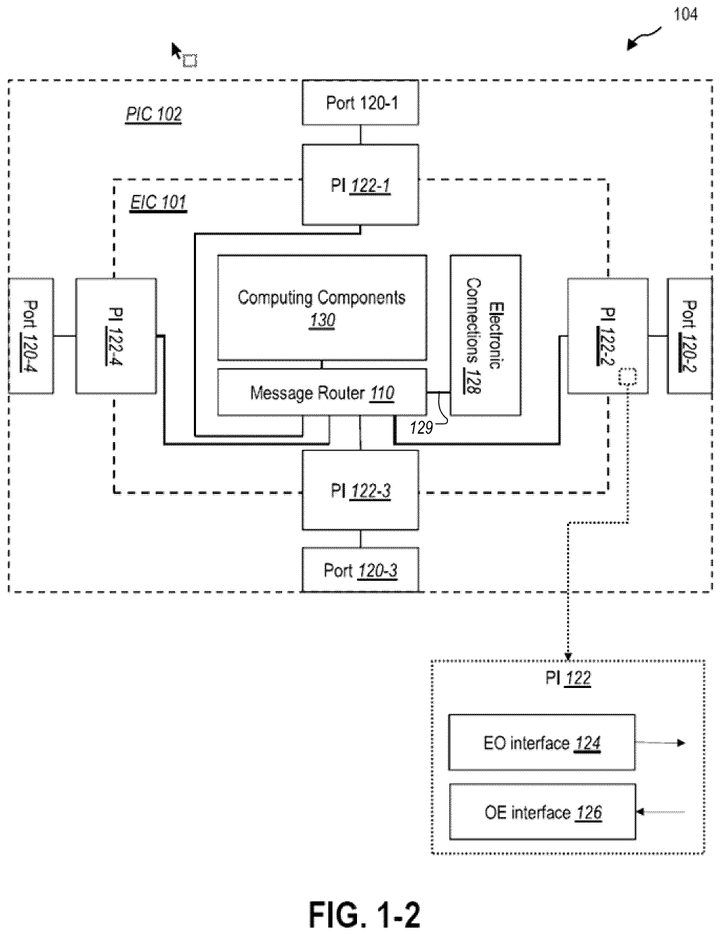

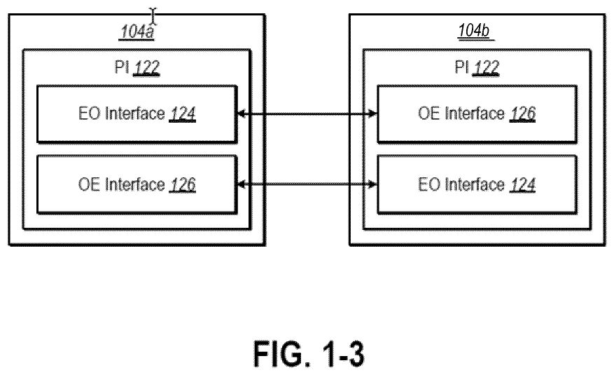

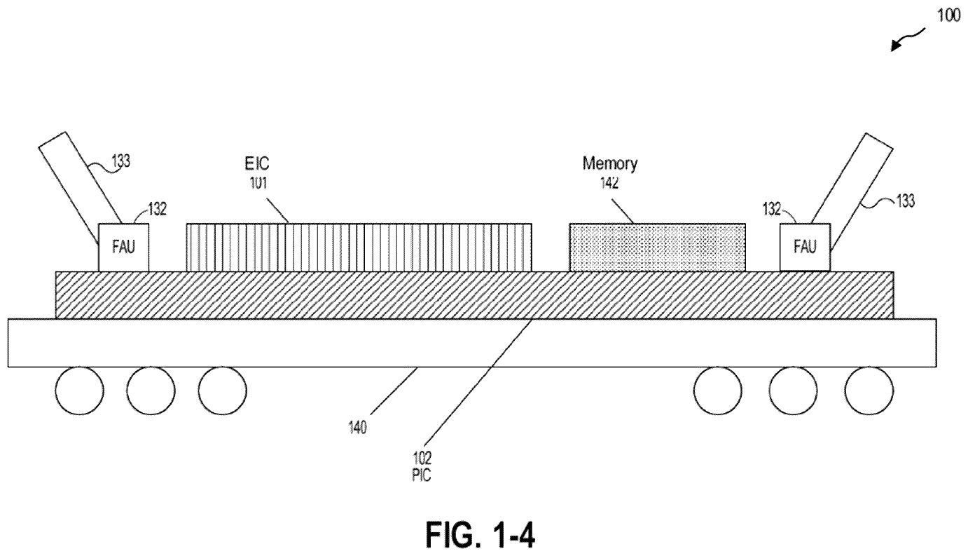

FIG. 1 is a diagram schematically illustrating components of an example circuit package 100 (e.g., SIP), according to at least one embodiment of the present disclosure. The circuit package 100 may serve, for example, as an ML processor. The circuit package 100 includes an electronic integrated circuit 101 (EIC), such as, for example, a digital and mixed-signal application-specific integrated circuit (ASIC), and a photonic integrated circuit 102 (PIC). The EIC 101 and PIC 102 are formed in different layers of the circuit package 100 (herein the “electronic circuit layer” and “photonic circuit layer,” respectively), one stacked above the other, for example, using copper pillars, bump attachments, or other means to create an electrical interconnect to transmit and receive messages, packets, and/or data between the EIC and the PIC, as illustrated further below with reference to FIG. 1-4. The PIC or PICs 102 receive light from one or more laser light sources that may be integrated into the PIC 102 itself or implemented separately from the PIC 102 either within or externally to the circuit package 100 and coupled into to the PIC 102 via suitable optical couplers. The optical couplers and laser sources are omitted from FIG. 1-1, but shown, for example, in FIG. 1-4.

The EIC 101 includes multiple processing elements or compute nodes 104. As will be discussed herein in detail, the compute nodes 104 may communicate with each other via one or more intra-chip bidirectional channels. The intra-chip bidirectional channels may include one or more bidirectional photonic channels (e.g., implemented with optical waveguides in the PIC 102) and/or one or more electronic channels (e.g., implemented in the circuitry of the EIC 101). The compute nodes 104 may (although they need not in all embodiments) be electronic circuits identical (or at least substantially similar) in design, and as shown, may form “tiles” of the same size arranged in an array, matrix, grid, or any other arrangement suitable for performing the techniques described herein. Hereinafter, the words “processing element,” “compute node,” and “tile” are used synonymously.

In some embodiments, a memory network system includes one or more worker nodes, such as CPUs, GPUs, TPUs, AI accelerators, tensor engines, neural compute engines, any other circuit designed to process data, or combinations thereof. In some embodiments, a chip can have four nodes but in practice it could have thousands of nodes operating in parallel. An inter-chip bidirectional photonic channel can be used between one of the nodes and a fiber shuffle in an optical memory appliance (OMA).

An OMA can have optical memory modules (OMMs) connected to the fiber shuffle. In some implementations, a 16×1 connection from the fiber shuffle can be connected to 16 OMMs. In some implementations, OMAs can use two inter-chip links between adjacent fiber shuffles. In some examples like this, the use of two links can provide two lanes that can be used to double the bandwidth between two OMAs. In some implementations, more links could be used depending on the available ports and the needs of the system. In other examples, a single line can be used between OMAs. In the descriptions herein, discussions or illustrations of single lines can represent abstractions of one, two, or more interconnections.

In accordance with at least one embodiment of the present disclosure, the EIC 101 has sixteen compute nodes 104, or tiles, arranged in a four-by-four array, but the number and arrangement of tiles can generally vary. Neither the shape of the tiles nor the grid in which they are arranged need necessarily be rectangular; for example, oblique quadrilateral, triangular, or hexagonal shapes and grids, as well as topologies with 3 or more dimensions can also be used. Further, although tiling may provide for efficient use of the available on-chip real-estate, the compute nodes 104 need not be equally sized and regularly arranged in all embodiments. As shown in FIG. 1-1, in some embodiments, the compute nodes 104 are arranged in a rectilinear array, such as a square (e.g., conceptually) array.

Each compute node 104 in the EIC 101 may include one or more circuit blocks serving as processing engines. For example, in the implementation shown in FIG. 1-1, each compute node 104 includes a dot product engine, or DNN, 106 and a tensor engine 108. The DNN 106 can perform rapid MAC operations at reduced energy per MAC to execute either a convolution function or a dot product function, e.g., as routinely used in neural networks. The tensor engine 108 may be used to perform other, non-MAC operations, e.g., implementing non-linear activation functions as applied to the weighted sums in a neural network. In other embodiments, the compute node 104 can have any combination of processing elements such as CPUs, GPUs, TPUs, and the like, and the DNN 106 and tensor engine 108 can also be included or omitted depending on the application.

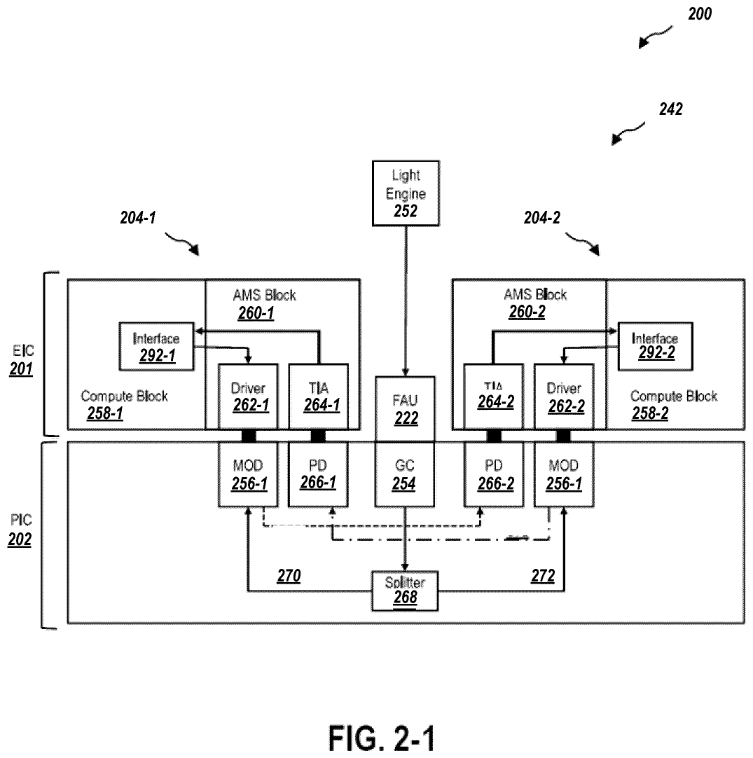

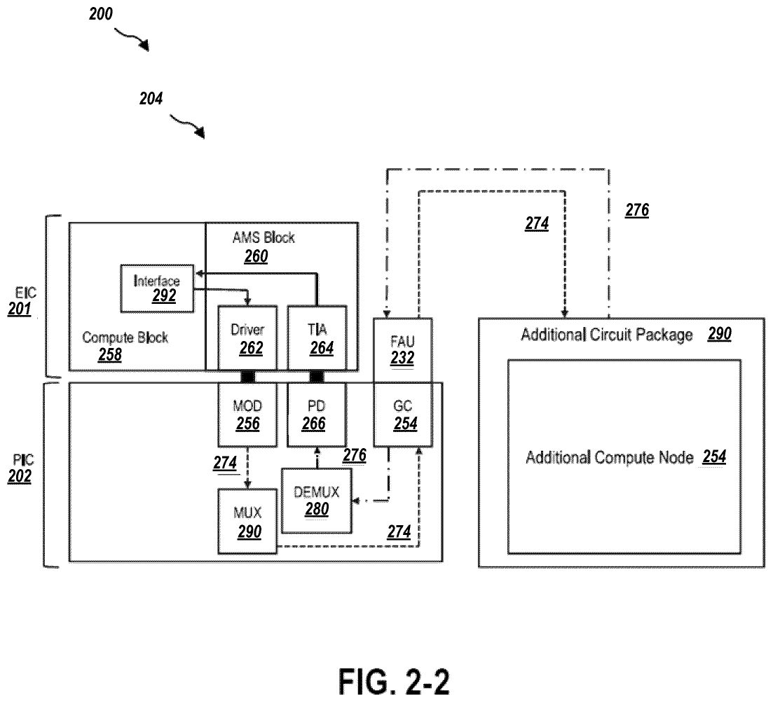

As further shown in FIG. 1-1, each compute node 104 includes a message router 110. The message routers 110 interface with channels (e.g., electronic and/or photonic channels as described below in connection with FIG. 1-2) to facilitate data flow to and from the compute nodes 104. Further, the compute nodes 104 may each have a memory system, e.g., including level-one static random-access memory (L1SRAM) 112 and level-two static random-access memory (L2SRAM) 114. L1SRAM 112 is optional and, if included, can serve as on-chip memory for each compute node 104. L2SRAM 114 may function as the primary memory for each compute nodes 104 and may store certain fixed operands used by the DNN 106 and tensor engine 108, such as the weights of a machine learning model, in close physical proximity to the DNN 106 and tensor engine 108. L2SRAM 114 may also store any intermediate results used in executing the machine learning model or other computation.

FIG. 1-2 is a block diagram illustrating various components of an example of the compute node 104 of FIG. 1-1. The compute node 104 includes various computing components 130, which may include the DNN 106, the tensor engine 108, interface controllers, routing controllers, the L1SRAM 112 and/or the L2SRAM 114 of FIG. 1-1, among other components. In some embodiments, the computing components 130 include memory components (e.g., a memory controller, vertically stacked high-bandwidth memory, etc.) such that the compute node 104 may be a memory node as will be described herein. The computing components 130 are implemented on the EIC 101 of the compute node 104 and are in communication with the message router 110. For example, the message router 110 may receive messages from another computing component via one of the optical ports or block 128, and additionally may send messages generated by the respective compute node 104 of the message router 110 via one of the optical ports or block 128. The message router may be implemented on the EIC 101 and may be implemented through hardware, software, or a combination of hardware and software. The message router is shown as a single block but can also include a message router associated with each photonic interface. The PIC 102 and EIC 101 as shown in FIG. 1-2 may be a portion of the PIC 102 and/or EIC 101 of FIG. 1-1 and may include various other computing componentry.

In some embodiments, the compute node 104 connects to one or more computing components through electronic channels (e.g., intra-chip electronic channels). For example, (as will be discussed below in detail) the various compute nodes 104 in FIG. 1-1 may each connect to adjacent nodes via the electronic channels. The compute node 104 may connect to any other computing component through one or more electronic channels. In some embodiments, the compute node 104 is configured to connect to up to 4 adjacent compute nodes 104 through electronic channels. In some embodiments, the compute nodes 104 are configured to connect to additional componentry and/or nodes through electronic connections, such as other on-chip components, or can process data in the electrical domain within the compute node 104, using an electrical port (not shown) which is included in block 128. The electronic channels connected to the compute node 104 may each connect to the message router 110, represented by electronic connections 129. The electronic connections 129 may be implemented in the EIC 101 of the compute node 104. Messages or packets sent through the electronic connections 129 may therefore pass to and be acted on by the message router 110 in order to forward those messages on to additional computing components, or to pass the messages internally to the computing components 130 of the compute node 104. In this way, the compute node 104 (and more specifically the message router 110) may be configured to connect to and communication with one or more computing components through the electronic connections 129.

In some embodiments, the compute node 104 is configured to connect to one or more optical connections or photonic channels. For example, as shown in FIG. 1-2, the compute node 104 may include one or more photonic ports 120. In some embodiments, the compute node 104 includes four photonic ports 120-1 to 120-4 such that the compute node 104 is configured to connect to four photonic channels. The photonic ports 120 may facilitate connecting a photonic connection to the compute nodes 104. For example, the photonic ports 120 may include and/or may connect to one or more waveguides in order to direct an optical signal to and/or from the compute node 104. The photonic ports 120 may be implemented in the PIC 102. In some embodiments, the photonic channels are bidirectional photonic channels to facilitate both sending and receiving communications through the photonic ports 120. For example, each bidirectional photonic channel may include two or more unidirectional links (e.g., one or more sending links and one or more receiving links). The unidirectional links may be associated with and may connect to respective sending and receiving components of the photonic interfaces 122, as discussed below. In this way, the photonic ports 120 may facilitate connecting the compute node 104 to one or more bidirectional photonic channels in order to communicate photonically with other computing devices.

In some embodiments, each of the photonic ports 120 is associated with and connected to a photonic interface 122 (PI). The photonic interfaces 122 may facilitate converting a message or a signal between the electronic domain and the photonic domain. For example, the photonic interfaces 122 may each include an electrical-to-optical (EO) interface 124 for converting electronic signals to optical (e.g., photonic) signals, and may include an optical-to-electrical (OE) interface 126 for converting signals to electronic signals. While FIG. 1-2 only shows PI 122-2 as having the EO interface 124 and OE interface 126, it should be understood that each of the PIs 122 may include one or both of these interfaces and typically includes a plurality of each to support multiple unidirectional photonic links in both directions connecting to the port, for example, to support wavelength division multiplexing (WDM) or other scheme.

As discussed above, each bidirectional photonic channel may include two or more unidirectional photonic links. Each unidirectional photonic link may include or may be associated with both an EO interface 124 and an OE interface 126. For example, as shown in FIG. 1-4 an EO interface 124 of a compute node 104a may connect (e.g., via photonic ports 120 and waveguides, etc.) to an OE interface 126 of another computing device 104b (e.g., another instance of the compute node) to form a unidirectional photonic link for sending packets from the compute node 104a to the other computing device 104b. Similarly, an EO interface 124 of the other computing device 104b may connect to an OE interface 126 of the compute node 104a to form a unidirectional link for receiving packets to the compute node 104a from the other computing device 104b. In this way, the PIs 122 may facilitate bidirectional communication over the bidirectional photonic channels connected to the photonic ports 120.

In some embodiments, the PIs 122 each include various optical and electronic components. In some embodiments, the EO interface 124 includes an optical modulator and an optical modulator driver. The optical modulator may operate on an optical (e.g., laser light) carrier signal to encode information into the optical carrier signal and thereby transmit information optically/photonically. The optical modulator may be controlled or driven by the optical modulator driver. The optical modulator driver may receive an electronic signal (e.g., packet encoded into an electronic signal) from the message router 110 and may control a modulation of the modulator to convert or encode the electronic signal into the optical signal. In this way the optical modulator and driver may make up the EO interface 124 to facilitate optically transmitting messages from the compute node 104.

In some embodiments, the OE interface 126 includes a photodiode and a transimpedance amplifier (TIA). The photodiode may receive an optical signal (e.g., from another computing device) through a unidirectional link of the bidirectional photonic channel and may decode or convert the optical signal into an electronic signal. The photodiode may be connected to the TIA which may include componentry and/or circuitry for gain control and normalizing the signal level in order to extract and communicate a bit stream to the message router 110. In this way, the OE interface 126 may include the photodiode and the TIA to facilitate optically receiving messages to the compute node 104.

In some embodiments, the PIs 122 are partially implemented in the PIC 102 and partially implemented in the EIC 101. For example, the optical modulator may be implemented in the PIC 102 and may be electrically coupled to the optical modulator driver implemented in the EIC 101. For example, the EIC 101 and the PIC 102 may be horizontally stacked, and the optical modulator and the optical modulator driver may be coupled through an electronic interconnect of the two components such as a copper pillar and/or bump attachment of various sizes. Similarly, the photodiode may be implemented in the PIC 102 and the TIA may be implemented in the EIC 101. The photodiode and the TIA may be coupled through an electronic interconnect of the two components.

In some embodiments, the PIs 122 are in communication with the message router 110. For example, the PIs 122 may be connected to the message router 110 through electronic interconnects in the EIC 101. The PIs 122 may communicate with the message router 110 in order to transmit signals to and/or receive signals to or from the message router 110. For example, in some embodiments, the message router 110 includes electronic circuitry and/or logic to facilitate converting a data packet into an electronic signal and then an optical signal in conjunction with the EO interface 124. Similarly, the message router 110 may include electronic circuitry and/or logic to facilitate converting an optical signal into an electronic signal and then into a data packet in conjunction with the OE interface 126. In this way the message router 110 may facilitate converting and/or operating on data between the electronic domain and the optical domain.

The message router 110 may facilitate routing information and/or data packets to and/or from the compute node 104. For example, the message router 110 may examine an address contained in the message and determine that the message is destined for the compute node 104.

The message router 110 may accordingly forward or transmit some or all of the message internally to the various computing components 130 of the compute node 104 (e.g., via an electronic connection). In another example, the message router 110 may determine that a message is destined for another computing device (e.g., the message either being generated by the compute node 104 or received from one computing device for transmission to another computing device). The message router 110 may accordingly forward or transmit some or all of the message through one or more of the channels (e.g., electronic or photonic) of the compute node 104 to another computing device. In this way, the message router 110 in connection with the electronic connections 129 and the bidirectional photonic channels connected to the photonic ports 120 may facilitate implementing the compute node 104 in a network of computing devices for generating, transmitting, receiving, and forwarding messages between various computing devices. In some embodiments, the compute node 104 is implemented in a network of a plurality of compute nodes 104 such as that shown in FIG. 1-1.

In some embodiments, the PIC 102 includes one or more waveguides. A waveguide may be a structure that guides and/or confines light waves to facilitate the propagation of the light along a desired path and to a desired location. For example, a waveguide may be an optical fiber, a planar waveguide, a glass-etched waveguide, a photonic crystal waveguide, a free-space waveguide, any other suitable structure for directing optical signals, and combinations thereof. In some embodiments, one or more internal waveguides are formed in the PIC 102. In some embodiments, one or more external waveguides are implemented external to the PIC 102, such as an optical fiber or a ribbon comprising multiple optical fibers.

The PIC 102 may include one or more waveguides in connection with the photonic ports 120. For example, as will be discussed below in more detail, one or more of the photonic ports 120 may be connected to another port of another computing node included in the circuit package 100 (e.g., on a same chip) as the compute node 104. Such connections may be intra-chip connections. In some embodiments, an internal waveguide is implemented (e.g., formed) in the PIC 102 to connect these photonic ports internally to the chip. In another example, one or more photonic ports 120 may be connected to a photonic port of another computing device located in a separate circuit package or separate chip to form inter-chip connections. In some embodiments, an external waveguide is implemented in connection with the PIC 102 in order to connect these photonic ports across the multiple chips. For example, the photonic ports 120 may be connected via optical fiber across the multiple chips. In some embodiments, an external waveguide (e.g., optical fiber) connect directly to the photonic ports 120 of the respective computing devices across the multiple chips. In some embodiments, an external waveguide is implemented in connection with one or more internal waveguides formed in the PICs 102 of one or more of the chips. For example, one or more internal waveguides may internally connect the one or more of the photonic ports 120 to one or more additional optical components located at another portion of the circuit package (e.g., another portion of the PIC 102) to facilitate coupling with the external waveguides. For example, the internal waveguides may connect to one or more optical coupling structures including fiber attach units (FAUs) located over grating couplers, or edge couplers. In some embodiments, one or more FAUs are implemented to facilitate coupling the external waveguides to the internal waveguides to facilitate chip-to-chip interconnection to another circuit package to both transmit and receive. In some embodiments, one or more FAUs are implemented to supply optical power from an external laser light source to the PIC 102 to drive the photonics (e.g., provide one or more carrier signals) in the PIC 102.

FIG. 1-4 is a diagram illustrating a side view of an example structural implementation of the circuit package 100 of FIG. 1-1. In this example, the EIC 101 and PIC 102 are formed in separate semiconductor chips (typically silicon chips, although the use of other semiconductor materials is conceivable). PIC 102 is disposed directly on the substrate 140, shown with solder bumps for subsequent mounting to a printed circuit board (PCB). The EIC 101 and FAUs 132 that connect the PIC 102 to external waveguides 133 (e.g., optical fibers) are disposed on top of and optically connected to the PIC 102. Optionally, and as will be discussed below, the circuit package 100 may further include, as shown, an on-chip memory 142 positioned on top of the PIC 102 adjacent to the EIC 101.

As will be appreciated by those of ordinary skill in the art, the depicted structure of the circuit package 100 is merely one of several possible ways to assemble and package the various components. In some embodiments, some or all of the EIC 101 is disposed on the substrate. In some embodiments, some or all of the PIC 102 is placed on top of the EIC 101. In some embodiments, it is also possible to create the EIC 101 and PIC 102 in different layers of a single semiconductor chip. In some embodiments, the photonic circuit layer includes or is made of multiple PICs 102 in multiple sub-layers. Multiple layers of PICs 102, or a multi-layer PIC 102 may help to reduce waveguide crossings. Moreover, the structure depicted in FIG. 1-4 may be modified to included multiple EICs 101 connected to a single PIC 102. For example, the multiple EICs 101 may be connected to each other via photonic channels in the PIC 102.

The EIC 101 and PIC 102 can be manufactured using standard wafer fabrication processes, including, e.g., photolithographic patterning, etching, ion implantation, etc. Further, in some embodiments, heterogeneous material platforms and integration processes are used. For example, various active photonic components, such as the laser light sources and/or optical modulators and photodetectors used in the photonic channels, may be implemented using group III-V semiconductor components.

The laser light source(s) can be implemented either in the circuit package 100 or externally. When implemented externally, a connection to the circuit package 100 may be made optically using a grating coupler in the PIC 102 underneath an FAU 132 as shown and/or using an edge coupler. In some embodiments, lasers are implemented in the circuit package 100 by using an interposer containing several lasers that can be co-packaged and edge-coupled with the PIC 102. In some embodiments, the lasers are integrated directly into the PIC 102 using heterogenous or homogenous integration. Homogenous integration allows lasers to be implemented directly in the silicon substrate in which the waveguides of the PIC 102 are formed, and allows for lasers of different materials, such as indium phosphide (InP), and architectures such as, quantum dot lasers. Heterogenous assembly of lasers on the PIC 102 allows for group III-V semiconductors or other materials to be precision-attached onto the PIC 102 and optically coupled to a waveguide implemented on the PIC 102.

As will be discussed in further detail below, several circuit packages 100, may be interconnected to result in a single system providing a large electro-photonic network (e.g., by connecting several chip-level electro-photonic networks as described below). Multiple circuit packages configured as ML processors may be interconnected to form a larger ML accelerator. For example, the photonic channels within the several circuit packages or ML processors, the optical connections, the laser light sources, the passive optical components, and the external optical fibers on the PCB, may be utilized in various combinations and configurations along with other photonic elements to form the photonic fabric of a multi-package system or multi-ML-processor accelerator.

FIG. 2-1 illustrates an example of a circuit package 200 implementing an intra-chip bidirectional photonic channel 242 between a first compute node 204-1 and a second compute node 204-2. The circuit package 200 may include various electronic and optical components implemented across an EIC 201 and a PIC 202. The compute nodes 204 may each include a compute block 258 which may include various processing, storage, and/or communication functions. The compute nodes 204 may each include an AMS block 260 that includes analog/mixed signal circuits for interfacing with the PIC 202. The compute block 258 may include an interface 292 for communicating with the AMS block 260, or more specifically, with the componentry of the AMS block 260. The AMS block 260 may include an optical modulator driver 262 and a transimpedance amplifier 264.

A light engine 252 may provide an optical carrier signal for communication between the first compute node 204-1 and second compute node 204-2. The light engine 252 may provide the carrier signal to an FAU 222 of the circuit package 200, such as through an optical fiber. The FAU may be optically coupled to a grating coupler 254 (or any other optical interface (OI) configured to receive and pass on light to one or more components) which may facilitate passing the optical carrier signal on to one or more components of the circuit package 200. In some embodiments the circuit package 200 may include a splitter 268. The splitter 268 may receive the optical carrier signal from the grating coupler 254 and may split or distribute the optical signal along one or more optical paths. As shown in FIG. 2-1, the splitter splits the optical carrier signal and distributes it along optical paths 270 and 272. The splitter 268 may distribute the optical carrier signal over any number of photonic paths consistent with that described herein. The optical paths 270 and 272 may be implemented as any suitable optical transmission medium and may include a mixture of waveguides and optical fibers, or any other transmission medium consistent with that described herein. In accordance with at least one embodiment of the present disclosure, the optical paths 270 and 272 may be implemented as waveguides in the PIC.

The optical paths 270 may pass from the splitter 268 to optical modulators 256-1 and 256-2. Each optical modulators 256 modulates the optical carrier signal it receives from the splitter 268 based on information from the optical modulator driver 262 and transmits the modulated signal along the respective optical path. An associated photodetector 266 receives the modulated signal from the optical path (e.g., from the associated modulator 256). The photodetector 266 converts the received modulated signal into an electrical signal and passes the electrical signal to a transimpedance amplifier 264 which facilitates the compute node 204 receiving the information encoded in the signal. In this way, communication may occur, for example, between the compute nodes through the various components just described. For example, the intra-chip bidirectional photonic channel 242 may include two unidirectional photonic links for facilitating communications both to and from each compute node. A first unidirectional photonic link may be defined by the modulator driver 262-1, the optical modulator 256-1, the optical path 270, the photodiode 266-2, and the transimpedance amplifier 264-2. Similarly, a second unidirectional link may be defined by the modulator driver 262-2, the optical modulator 256-2, the optical path 270, the photodiode 266-1, and the transimpedance amplifier 264-1. The first and second unidirectional links may operate in opposite directions. Additionally, one or more of the compute nodes 204 may include one or more serializes and/or a deserializes for further facilitating communications of signals between the compute nodes 204. In this way, the two unidirectional photonic links may form the intra-chip bidirectional photonic channel 242.

FIG. 2-2 illustrates an example circuit package 200 implementing an inter-chip bidirectional photonic channel 244 between a compute node 204-1 and an additional compute node 204-2 located on an additional circuit package 290, such as a memory node on a memory circuit package. The compute node 204 and/or the circuit package 200 may include an EIC 201 and a PIC 202 including the components discussed above in connection with FIG. 2-1.

In the inter-chip configuration shown in FIG. 2-2, the optical modulator transmits a modulated signal along an optical path 274 to a grating coupler 254. The modulated signal may, in some cases, be passed through a multiplexor 278 prior to passing to the grating coupler. From the grating couple, the modulated signal may travel through an FAU 232 and along an optical fiber to another grating coupler of the additional circuit package 290, where the receiving componentry of the additional circuit package 290 may receive and process the incoming signal. The receiving componentry may be the receiving componentry of the circuit package 200 discussed below or may include any other means for receiving and processing the incoming signal.

Similarly, the additional circuit package 290 may generate and transmit a signal to the circuit package 300. The additional circuit package 290 may generate and transmit the signal using transmitting componentry that may include any of the transmitting componentry of the circuit package 200 discussed above, or any other means. The additional circuit package 290 may transmit a signal, for example, along an optical fiber to the FAU 232 and grating coupler 254 of the circuit package 200. The received signal may travel along an optical path 276 to a photodetector 266 which may facilitate converting the optical signal to an electrical signal as discussed herein. In some cases, the received signal may pass through a demultiplexer 280 prior to passing to the photodetector 266. In this way, the inter-chip bidirectional photonic channel may be defined by two unidirectional photonic links. For example, a first unidirectional photonic link may be defined by the optical modulator driver 262, the optical modulator 256, the optical path 274, the multiplexor 278, the grating coupler 254, the FAU 232, an optical fiber, and receiving componentry of the additional circuit package. Similarly, the second unidirectional photonic link may be defined by the transmitting components of the additional circuit package 290, the optical fiber, the FAU 232, the grating coupler 254, the demultiplexer 280, the optical path 276, the photodetector 266, and the transimpedance amplifier 264. The first and second unidirectional photonic links may operate in opposite directions. In this way the two unidirectional photonic links may form the inter-chip bidirectional photonic channel 244.

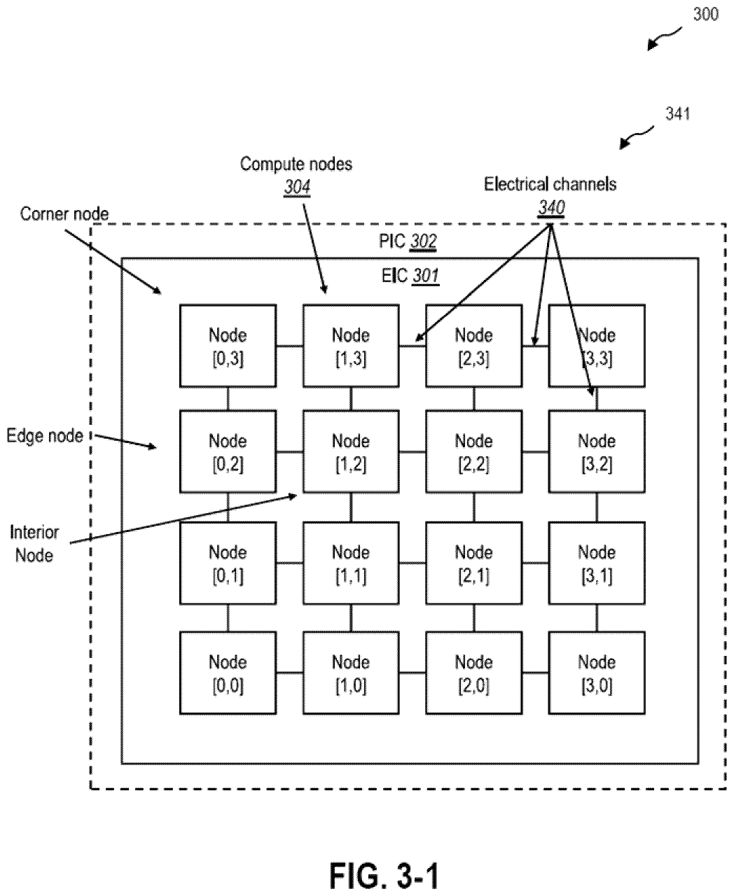

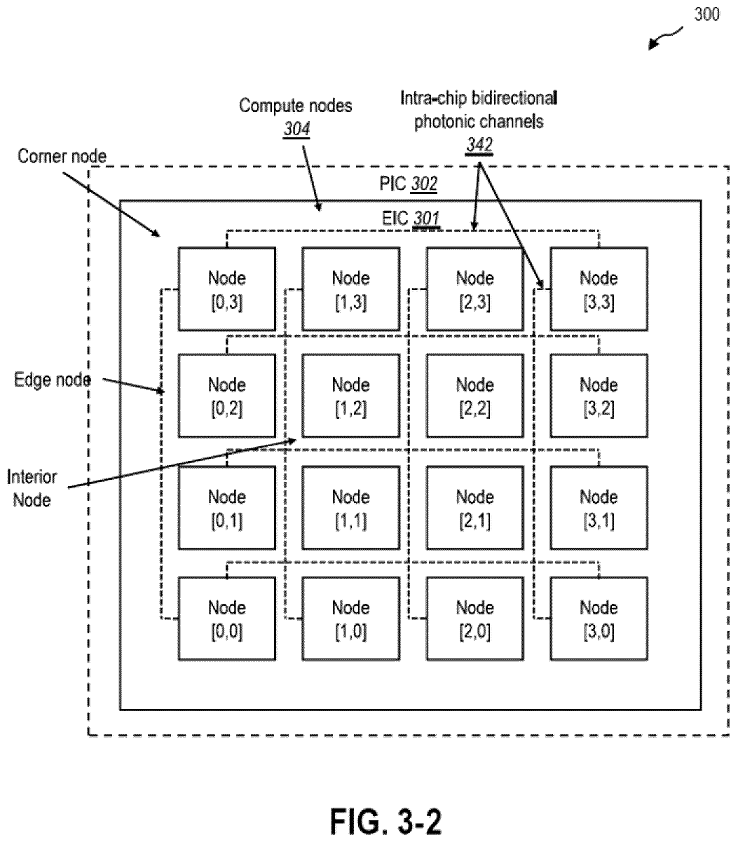

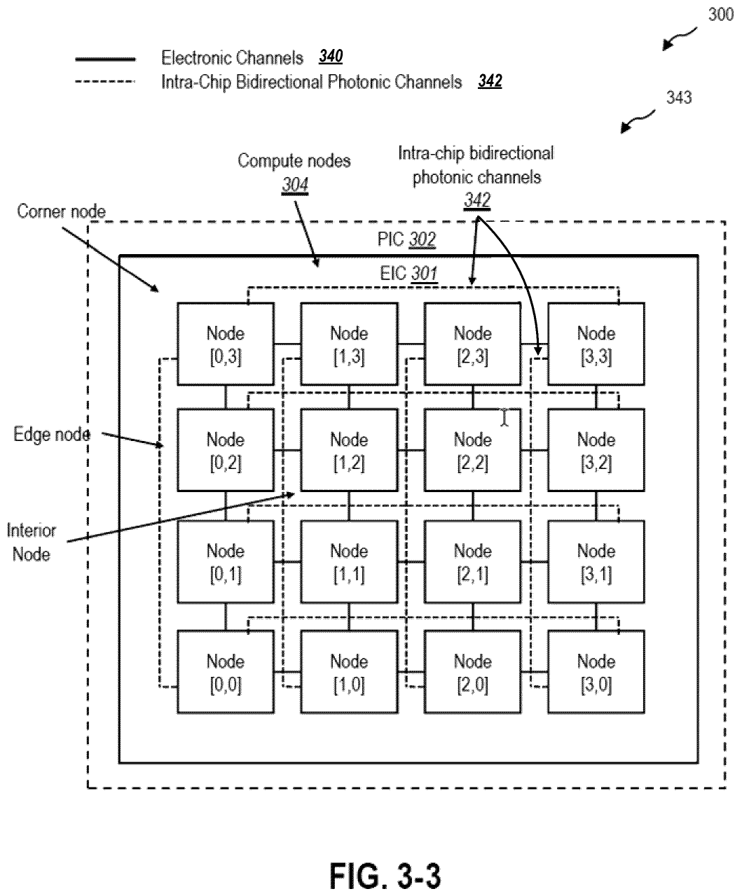

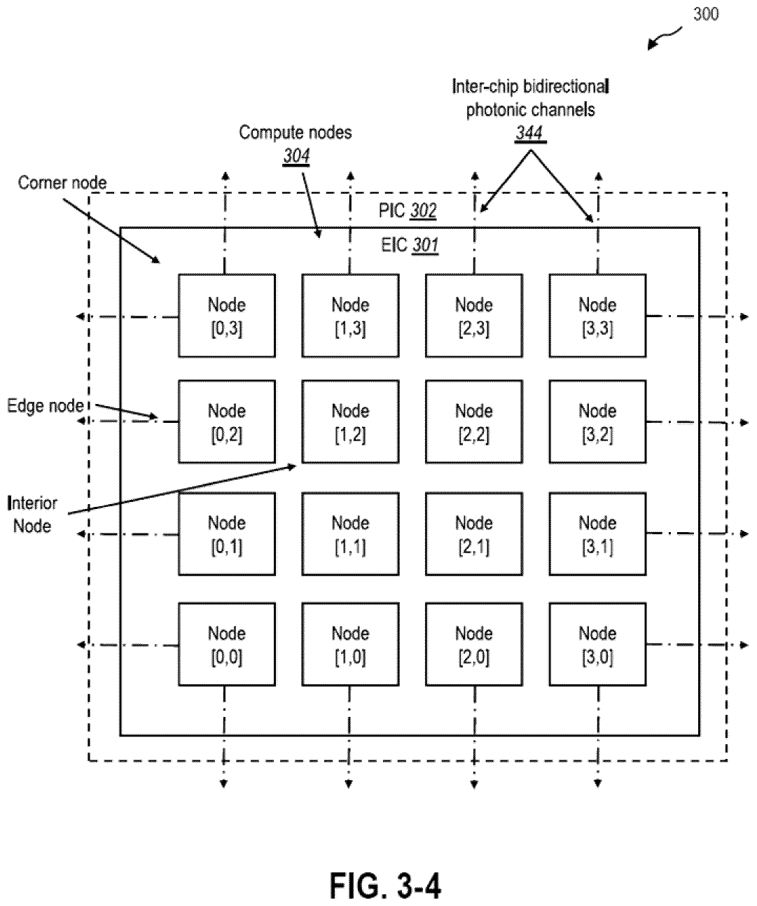

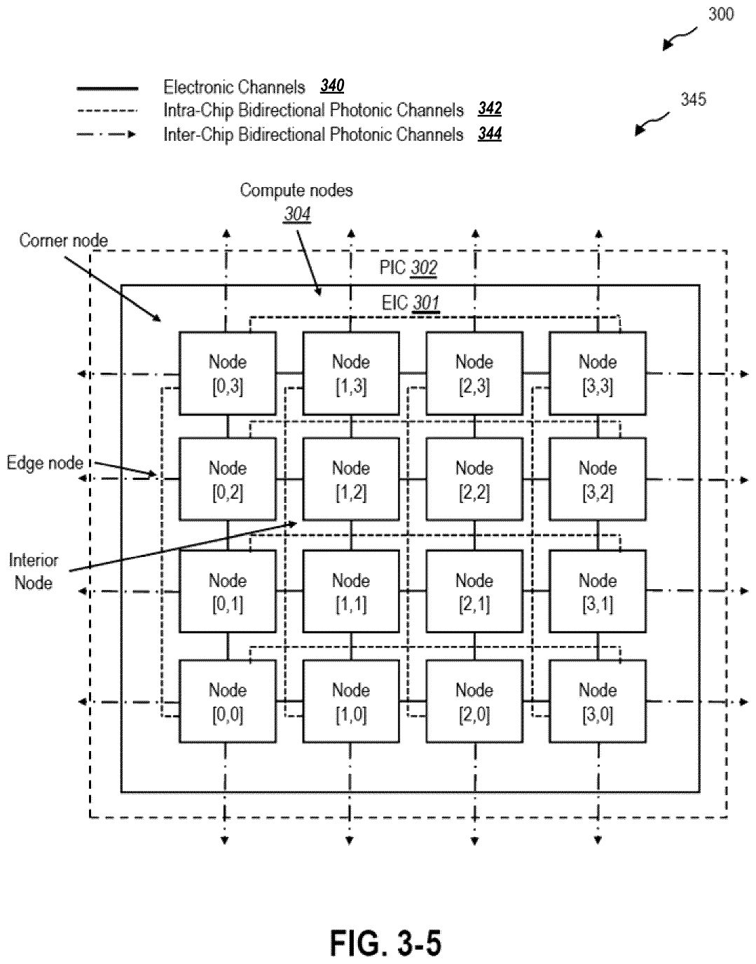

FIG. 3-1 is a diagram illustrating an example of a circuit package 300 implementing a plurality of compute nodes 304, according to at least one embodiment of the present disclosure. Each compute node 304 (and more specifically, a message router in each compute nodes 304) may be configured to connect to one or more electronic channels 340. The compute nodes 304 (e.g., via the message routers) may direct messages transmitted over the electronic channels 340, such as that described herein in connection with FIG. 1-2. Additionally, the circuit package 300 may include an EIC 301 and a PIC 302, with the compute nodes 304, routers, and electronic channels 340 being implemented on the EIC 301 as described herein. The circuit package 300 may include additional circuitry and/or componentry in addition to that shown in FIG. 3-1.

In some embodiments, the compute nodes 304 are arranged in an array such as a rectilinear array or any other configuration. As shown in FIG. 3-1, the circuit package 300 may include 16 compute nodes 304. The 16 compute nodes 304 may be arranged in a two-dimensional array and, for ease of reference, may be referred to according to the cartesian coordinates 0,0 through 3,3 as shown. In some embodiments, the array of the compute nodes 304 includes one or more corner nodes, one or more non-corner edge nodes (hereinafter “edge nodes”), and one or more interior nodes. For example, as shown in FIG. 3-1, the array of compute nodes 304 may include four corner nodes: node [0,3], node [3,3], node [0,0], and node [3,0]. The array of compute nodes 304 may include eight (non-corner) edge nodes: node [1,3], node [2,3], node [3,2], node [3,2], node [2,0], node [1,0], node [0,1], and node [0,2]. The array of nodes may include four interior nodes: node [1,2], node [2,2], node [1,1], and node [2,1]. The circuit package 300 may include any number of compute nodes 304, and the compute nodes 304 may be arranged in any array, configuration, or arrangement consistent with the techniques described herein.

In some embodiments, the compute nodes 304 are intra-connected through a plurality of the electronic channels 340. For example, each compute node 304 may be connected to each adjacent compute node 304 via one of the electronic channels 340. In this way, the corner nodes may be connected to two adjacent nodes through two electronic channels, the edge nodes may be connected to three adjacent nodes through three electronic channels, and the interior nodes may be connected to four adjacent nodes through four electronic channels. In this way, the compute nodes 304 may be intra-connected to form an electronic network 341 for communicating and/or transmitting messages between two or more of the compute nodes 304 via the electronic channels 340. For example, each of the compute nodes 304 may be connected either directly (e.g., to adjacent nodes) or indirectly (through one or more other nodes) to all other compute nodes 304. The connecting of all adjacent compute nodes 304 via the electronic channels 340 in this way may represent a maximum adjacency configuration for the electronic network 341 in that all adjacent nodes are connected. This may facilitate a more complete, faster, and/or more robust electronic network providing a maximum amount of transmission paths between nodes and/or through the network, as will be described herein in further detail. In this way, the electronic network 341 may be configured in a rectangular mesh topology.

In some embodiments, the electronic network 341 is configured according to other topologies. For example, one or more nodes may not be connected to all adjacent nodes (e.g., one or more of the electronic channels 340 of the rectangular mesh topology may be omitted). For example, every node may be connected to at least one other node (and may accordingly be intra-connected to all other nodes) but may not necessarily be connected to each adjacent node. In a non-limiting example, each interior node may be connected to only one edge node and no other nodes. Any number of topologies for electronically intra-connecting all compute nodes 304 without connecting all adjacent nodes will be appreciated by one of ordinary skill in the art, and such configurations are contemplated by this disclosure. The connecting of all nodes with a less-than-maximum adjacency configuration in this way may represent an intermediate adjacency configuration (e.g., less than all adjacent nodes connected) or even a minimum adjacency configuration (e.g., minimum amount of adjacent connections to maintain connectivity of all nodes). Intra-connecting the compute nodes 304 in a less-than-maximum adjacency configuration in this way may simplify the design, production, and/or implementation of the electronic network 341 and/or the circuit package 300. For example, such a configuration may simplify determining transmission paths through the network to facilitate simpler routing of messages.

In some embodiments, one or more electronic channels 340 connects non-adjacent nodes. This may be in connection with either of the maximum adjacency or less-than-maximum adjacency configurations just discussed. Such a configuration may increase or even maximize use of configurable electronic connections for each compute node 304 in order to increase the robustness and speed of the electronic network 341.

The intra-connection of the compute nodes 304 in this way may facilitate transfer of messages through the electronic network 341. For example, messages may be directly transferred between routers of any two compute nodes 304 that are directly connected (e.g., adjacent). Message transfer between any two compute nodes 304 that are not directly connected may also be accomplished by passing the message through one or more intervening compute nodes 304. For example, for a message originating at node [0,3] and destined for transmittal to node [1,2], the router for node [0,3] may transmit the message to the router for node [0,2] which may then ultimately forward or transmit the message to the router for node [1,2]. Similarly, transmittal of the message could be implemented through the path [0,3]-[1,3]-[1,2]. In this way, messages may be transmitted between any two indirectly connected (e.g., non-adjacent) nodes by one or more “hops” along a path through one or more intervening compute nodes 304 within the electronic network 341.

As described herein, each of the compute nodes 304 may be configured to connect to one or more (e.g., up to four) bidirectional photonic channels for two-way data transmission between nodes. As will be appreciated by one of ordinary skill in the art, photonic channels are typically faster and more energy efficient than electronic channels as distance or resistance increases. As will be discussed in connection with the various configurations below, in some embodiments, various compute nodes 304 are connected through bidirectional photonic channels to leverage the speed and energy efficiency of the photonic channels for an improved network. In some embodiments, however, adjacent compute nodes 304 are not intra-connected with bidirectional photonic channels, but rather are still connected through the electronic network 341 shown and described in connection with FIG. 3-1. Implementing the electronic network 341 in this way for adjacent connections may allow the photonic ports of each compute node 304 to be utilized for (e.g., up to four) bidirectional photonic connections with non-adjacent nodes, and nodes included in other circuit packages as described herein. This may help to increase speed, robustness, and completeness of the network of compute nodes 304 despite employing the slower, less-efficient electronic connections for adjacent nodes. For example, transmittal speed and energy efficiency for electronic channels typically diminishes with distance, while photonic channels can maintain a high speed and energy efficiency over longer distances. Accordingly, utilizing the electronic channels 340 for short interconnects between (e.g., closely) adjacent nodes while implementing the faster, more energy efficient photonic connections for connections between more distant nodes can increase the overall (and/or average) speed of the network as well as reduce the energy consumption. In this way, implementing the electronic network 341 may facilitate improved network performance by enabling the various configurations of the photonic channels and network topologies described below. The foregoing hardware configuration can allow for flexibility when code is executed because software schemes, compilers, schedulers, and the like, can take advantage of and/or route packets through electronic or photonic channels in a manner most advantageous for the needs off the algorithm that is being executed.

As is evident in the example network of FIG. 3-1, the further the separation between two nodes, the greater the number of hops and the greater the amount of possible transmission paths between the two nodes. For example, in order to transmit a message from node [0,1] to node [3,2] at least 4 hops are required. In a more extreme case, a message transmitted between node [0,0] and node [3,3], can be accomplished in no less than 6 hops. In some embodiments, one or more non-adjacent compute nodes 304 are connected in order to facilitate reducing a number of hops for one or more transmission paths between the compute nodes 304.

FIGS. 3-2 and 3-3 are each diagrams illustrating an example of the circuit package 300 of FIG. 3-1 with a plurality of connections between non-adjacent compute nodes 304. The plurality of non-adjacent connections may be implemented either separately or in connection with the adjacent connections discussed above in connection with FIG. 3-1.

In some embodiments, the circuit package 300 includes one or more intra-chip bidirectional photonic channels 342. The intra-chip bidirectional photonic channels 342 may be implemented in the PIC 302. In some embodiments, the intra-chip bidirectional photonic channels connect one or more pairs of non-adjacent compute nodes 304. For example, one or more of the compute nodes 304 positioned along a periphery of the array (e.g., corner and edge nodes or “peripheral nodes”) may be connected to another peripheral node through an intra-chip bidirectional photonic channel 342. In some embodiments, all of the peripheral nodes are connected to another peripheral node through an intra-chip bidirectional photonic channel 342. In some embodiments, each peripheral node is connected to a peripheral node at an opposite end of the array. For example, each corner node may be connected to the two corner nodes on adjacent sides of the array, such as node [0,3] being connected to node [3,3] and node [0,0].

Additionally, each edge node may be connected to the (one) edge node positioned on the opposite side of the array (e.g., in a same position on the opposite side of the array). For example, edge node [2,0] may be connected to edge node [2,3], and edge node [0,1] to edge node [3,1]. In some embodiments, one or more (or all) of the interior nodes are not connected to the intra-chip bidirectional photonic channels 342. In this way, each side of the array may be wrapped, or connected to the opposite side of the array through the connections of the peripheral nodes by the intra-chip bidirectional photonic channels 342.

The intra-chip bidirectional photonic channels 342 may be implemented in a PIC of the circuit package 300. For example, as described above, each compute node 304 may include one or more photonic ports in a PIC layer of the compute node 304, and a waveguide may connect photonic ports of a pair of compute nodes 304. In some embodiments, the waveguide is an internal waveguide implemented or formed in the PIC. In this way the PIC may be manufactured with the waveguides included for implementing the intra-chip bidirectional photonic channels 342. In some embodiments, the waveguides include an external waveguide such as an optical fiber for implementing the intra-chip bidirectional photonic channels 342.

The intra-chip bidirectional photonic channels 342 may be implemented in addition to the electronic channels 340 connecting the compute nodes 304 into the electronic network 341. For clarity and for ease of discussion, the electronic channels 340 are not shown in FIG. 3-2 but can be seen implemented in conjunction with the intra-chip bidirectional photonic channels 342 in FIG. 3-3. The combination of the compute nodes 304 being connected through the electronic channels 340 and the intra-chip bidirectional photonic channels 342 in this way may form an electro-photonic network 343 (e.g., an intra-chip electro-photonic network). The electro-photonic network 343 may be an intra-chip network of the compute nodes 304 and may configure the compute nodes as a 2-dimensional torus interconnect. In this way, the electro-photonic network 343 may have a toroidal mesh topology. For example, while the compute nodes 304 may be physically implemented in a 2-dimensional planar array, each side of the plane may “wrap” around to an opposite side (e.g., left-right and top-bottom) such that the array may conceptually take the shape of a torus. In this way, adjacent nodes are directly connected, and peripheral nodes are conceptually “adjacent” and directly connected to the peripheral nodes on the opposite side of the array through the intra-chip bidirectional photonic channels 342.

The toroidal mesh topology of the electro-photonic network 343 in this way helps to reduce an average number of hops between pairs of compute nodes 304 in the network. In the example given above, the transmission path between node [0,1] and node [3,2] required a minimum of four hops through the electronic network 341. By implementing the electro-photonic network 343 including the intra-chip bidirectional photonic channels 342, the transmission of a message from node [0,1] to node [3,2] can be accomplished in just two hops (e.g., [0,1]-[3,1]-[3,2]). Similarly, the transmission path from node [0,0] to [3,3] is reduced from six hops in the electronic network 341 down to two hops in the electro-photonic network 343. In this way, implementing the electro-photonic network 343 may increase the speed, reliability, and robustness of the network of compute nodes 304 by enabling delivery of messages through less hops. Additionally, the electro-photonic network 343 may accordingly reduce an overall amount of traffic that individual routers process as a message traverses the network.

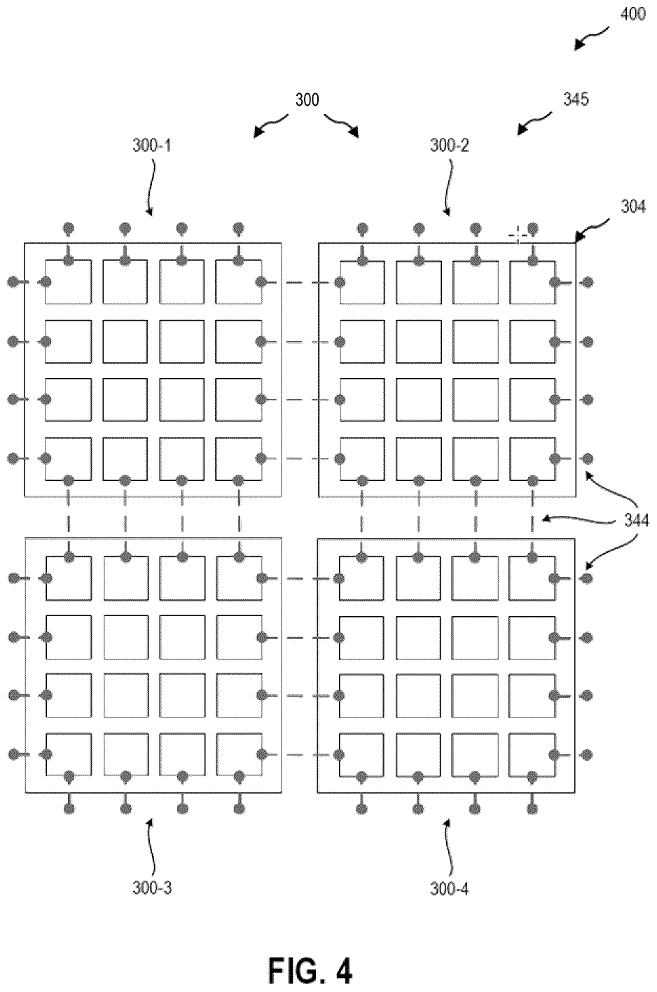

FIG. 3-4 is a diagram illustrating an example of the circuit package 300 of FIG. 3-1 implementing a plurality of connections to one or more additional circuit packages. The circuit package 300 may include one or more inter-chip bidirectional photonic channels 344 to connect one or more of the compute nodes 304 to one or more additional computing devices of other circuit package(s). The inter-chip bidirectional photonic channels 344 may be implemented either separately or in connection with the electronic channels 340 discussed above in connection with FIG. 3-1 and/or the intra-chip bidirectional photonic channels 342 discussed above in connection with FIGS. 3-2 and 3-3.

In some embodiments, the inter-chip bidirectional photonic channels 344 are implemented using exterior waveguides such as optical fibers. For example, an optical fiber may couple with any suitable optical interface, such as a FAU (as described in connection with FIGS. 2-1 and 2-2) included in the circuit package 300 in order to connect to the photonic port(s) of one or more compute nodes 304 through an interior waveguide. In some embodiments, an optical fiber connects directly to a photonic port of one or more compute nodes 304 without an interior waveguide. The optical fiber may have a similar connection with one or more computing devices of a separate circuit package with which it connects. For example, the optical fiber may connect two circuit packages by connecting to an FAU of each circuit package. One or more optical fibers connected in this way may form one or more unidirectional photonic links including drivers, modulators, waveguides, grating couplers, FAUs, photodiodes, and transimpedance amplifiers associated with each circuit package. In this way, the inter-chip bidirectional photonic channels may be formed using any of the components described herein in connection with FIGS. 2-1 and 2-2.

In some embodiments, the inter-chip bidirectional photonic channels 344 connect to one or more of the peripheral nodes. In some embodiments, each of the peripheral nodes connect to an inter-chip bidirectional photonic channel 344. For example, each corner node may connect to two inter-chip bidirectional photonic channels 344, and each edge node may connect to one inter-chip bidirectional photonic channel 344. The connection of the peripheral nodes in this way may facilitate connecting and/or arranging multiple circuit packages into a grid or array. For example, as will be discussed in further detail below, in some embodiments, the multiple circuit packages 300 are connected together in an array to form a larger interconnect and/or network via the inter-chip bidirectional photonic channels 344. In some embodiments, the circuit package 300 connects to similar or complimentary circuit packages in place or in addition to connecting to identical or other instances of the circuit package 300. In this way, the inter-chip bidirectional photonic channels 344 may facilitate incorporating the circuit package 300 and the compute nodes 304 into a larger inter-chip network.

In accordance with at least one embodiment of the present disclosure, the circuit package 300 includes the inter-chip bidirectional photonic channels 344 in addition to the electronic channels 340 and the intra-chip bidirectional photonic channels 342 described above. For clarity and for ease of discussion, only the inter-chip bidirectional photonic channels 344 are shown in FIG. 3-4, but an implementation with all of the channels can be seen in FIG. 3-5. The combination of the compute nodes 304 being connected through the electronic channels 340, the intra-chip bidirectional photonic channels 342, and the inter-chip bidirectional photonic channels 344 in this way may form a larger, inter-chip electro-photonic network 345. For example, the inter-chip bidirectional photonic channels 344 may facilitate joining or connecting the (e.g., intra-chip) electro-photonic network 343 with intra-chip networks of one or more other circuit packages into a larger, more robust network.

In the various embodiment described and shown in connection with FIGS. 3-2 to 3-5 (and other embodiments described herein as well) the various photonic channels (both inter-chip and intra-chip) have been depicted as connected or terminating at an edge of the compute nodes 304. It should be understood, however, that these depictions are intended to be illustrative of the connectivity of the various components described herein and are not intended to be limiting with respect to an actual physical layout or implementation of the various components. For example, the various photonic channels may, in actuality extend within or underneath the compute nodes 304. The various channels may terminate or end at a transceiver or AMS block of the compute nodes 304. The various channels may terminate or end at a central region or location within the compute nodes 304. Additionally, while the compute nodes 304 are shown as connecting to the various channels at North, East, South, and/or West positions of the compute nodes 304, it should be understood that this is merely illustrative and the photonic ports of the compute nodes 304 may be located at any location with respect to the compute nodes 304, including one or more photonic ports at the same or adjacent location. For example, all four photonic ports of a compute node 304 may be located at the same location of the compute node 304.

In accordance with at least one embodiment of the present disclosure, the circuit package 300 may be connected via the inter-chip bidirectional photonic channels 344 to one or more additional circuit packages 300. FIG. 4 is a diagram illustrating an example system 400 of four of the circuit packages 300 of FIG. 2-1 being interconnected. In some embodiments, the circuit packages 300 are arranged in a grid or array, such as the two-dimensional array shown. The circuit packages 300 may be a circuit package 300-1 (top-left), 300-2 (top-right), 300-3 (bottom-left), and 300-4 (bottom-right). As shown, the peripheral (corner, or non-corner, edge) nodes on each side of a circuit package 300 that is adjacent a side of another circuit package 300 may connect directly to a corresponding, “adjacent” node on the adjacent circuit package via inter-chip bidirectional photonic channels 344. In this way, the circuit packages 300-1 to 300-4, may effectively form a grid of 64 compute nodes 304 arranged in eight rows of eight adjacent and directly connected compute nodes 304.

In some embodiments, each of the circuit packages 230 includes the electronic connections between adjacent nodes and/or the intra-chip bidirectional photonic channels between peripheral nodes. For clarity, such connections are not shown in FIG. 4. In this way, the benefits discussed above of the intra-connectivity of the compute nodes 304 within a single circuit package 300 may similarly be applied to the inter-connectivity of multiple circuit packages 300 into a larger, inter-chip network. For example, what would take ten hops through adjacent nodes to transmit a message from the top-left node of circuit package 300-1 to the bottom-right node of circuit package 300-2 may be achieved in four hops by utilizing the intra-chip bidirectional photonic channels connecting peripheral nodes within each circuit package as described above.

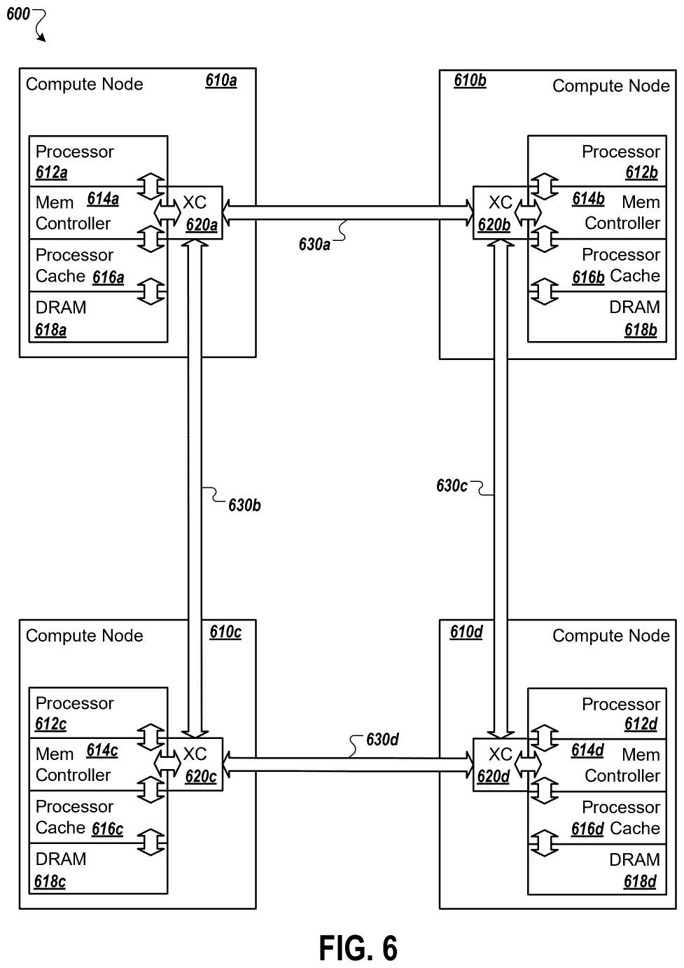

As shown, all of the peripheral nodes of each circuit package 300 may be connected to one or more inter-chip bidirectional photonic channels 344. For example, in addition to adjacent sides of the circuit packages 300 being directly connected, one or more of the peripheral nodes on non-adjacent sides (e.g., on a periphery of the inter-chip grid) may also be directly connected to other nodes. Any number of configurations or topologies of the inter-chip electro-photonic network 345 may be contemplated by inter-connecting nodes with the inter-chip bidirectional photonic channels 344. Such configurations may reduce and/or minimize a number of hops between pairs of compute nodes 304 by leveraging the configurability of each compute node 304 to connect to two or more (or any quantity of) photonic channels (in this embodiment four are shown). In this way, high network efficiency and flexibility for various routing schemes (depending on the algorithm being executed) may be maintained even for networks implementing multiple circuit packages and/or large numbers of compute nodes. FIGS. 6-11 illustrate one or more possible configurations.

In some implementations, an optical switch can efficiently connect up many circuit packages 300 and/or OMAs and can be scaled to have as much memory as needed, so long as there are sufficient optical ports to have transmit and receive ends of the inter-chip channel.

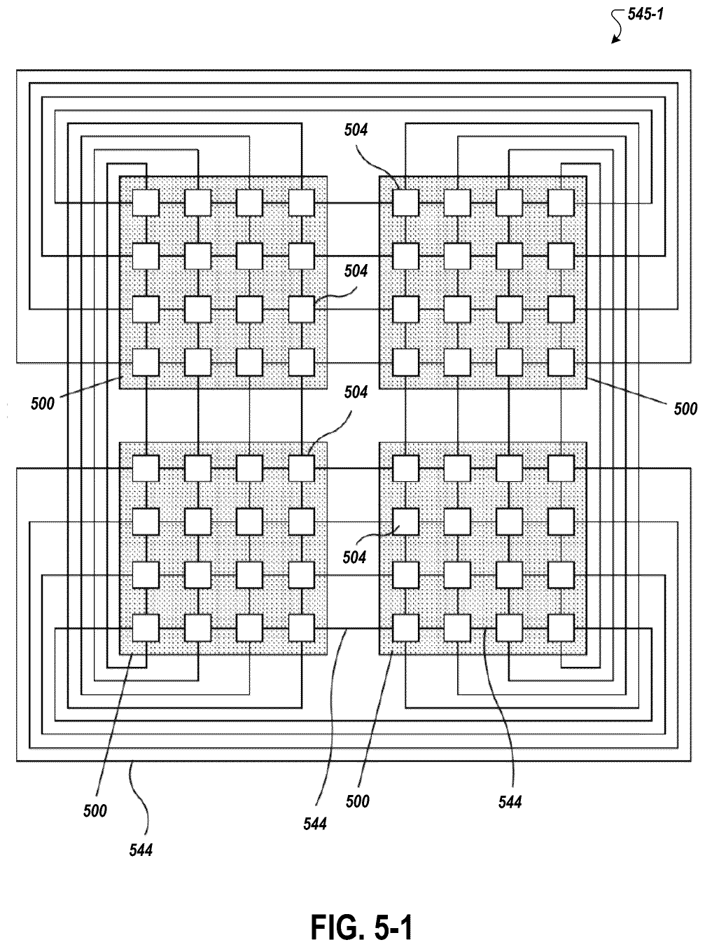

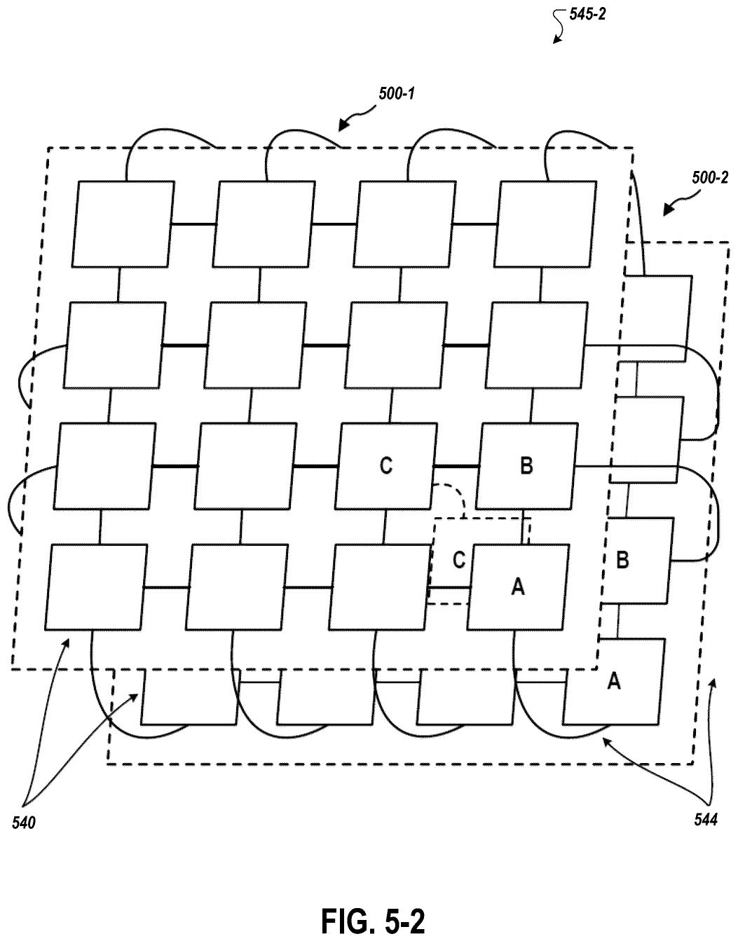

FIG. 5-1 is a diagram illustrating an example implementation of an inter-chip electro-photonic network 545-1, according to at least one embodiment of the present disclosure. The inter-chip electro-photonic network 545-1 (“network 545-1”) is made up of a plurality of circuit packages 500 arranged in a two-dimensional array. Each of the circuit packages 500 includes a plurality of compute nodes 504 arranged in the array. The compute nodes 504 of each circuit package 500 may be intra-connected through a plurality of electronic channels and a plurality of intra-chip bidirectional photonic channels as described herein.

As shown in FIG. 5-1, in some embodiments, the compute nodes 504 positioned at the edges of the chip array may connect to other compute nodes 504 positioned at the edges of the chip array. In some embodiments, these compute nodes 504 connect to compute nodes 504 on an opposite edge of the chip array. For example, the compute nodes 504 on the right side of the chip array may connect to the corresponding opposite compute nodes 504 on the left side of the chip array. Similarly, the compute nodes 504 on the top of the chip array may connect to the corresponding opposite compute nodes 504 on the bottom of the chip array. In this way, the chip array of circuit packages 500 may itself “wrap” both horizontally and vertically (e.g., in addition to each individual circuit package 500 similarly wrapping) to form a 2-dimensional torus interconnect. In this way, network 545-1 may exhibit of a toroidal mesh topology. The configuration of the network 545-1 in this way may provide additional direct connections for many of the peripheral nodes, thereby reducing the average number of hops required for a message to traverse the network.

While various embodiments have been described as being laid out in a single plane with edges of the plane conceptually “wrapped” to form a 2-dimensional toroidal mesh topology, the circuit packages 500 and compute nodes 504 may be connected and configured into three-dimensional, mesh topologies. Such 3-dimensional topologies may further reduce the number of hops between pairs of compute nodes by providing more direct connections between nodes.

As discussed herein, each compute node 504 may be configured to connect to up to four bidirectional photonic channels (both inter-chip and intra-chip). In the embodiment described in connection with FIG. 5-1, only the corner nodes of each circuit package are connected to four photonic channels (e.g., the two inter-chip bidirectional photonic channels shown, and two intra-chip bidirectional photonic channels to nodes on the same circuit packages). By providing additional inter-chip bidirectional channels to connect compute nodes with available photonic ports, further network efficiency can be achieved.

FIG. 5-2 is a diagram illustrating an implementation of a higher-dimensional inter-chip electro-photonic network 545-2, according to at least one embodiment of the present disclosure. In addition to the connections of the network 545-1 shown and discussed in connection with FIG. 5-1, the higher-dimensional inter-chip electro-photonic network 545-2 (“high-dimensional network 545-2”) includes one or more additional inter-chip connections between nodes have available photonic ports in order to implement a 3d mesh network topology. For clarity and ease of discussion, not all of the connections discussed above in connection with FIG. 5-1 are shown, but it should be understood that the higher-dimensional network 545-2 may include some or all of any of the connections between the compute nodes 504 discussed herein, including electronic channels, intra-chip bidirectional photonic channels, the inter-chip bidirectional photonic channels.

In some embodiments, the circuit packages 500 may be arranged (conceptually) in a stacked configuration in order to form the higher-dimensional network 545-2 (e.g., 3d memory fabric). The circuit packages 500 may be arranged as layers in a higher dimension. For example, a compute node in a position A of a circuit package 500-1 may connect to a compute node 504 in the same position A of circuit package 500-2 on an adjacent layer positioned below. Similarly, the compute node 504 may connect to another compute node 504 in a position A on an additional circuit package positioned above. Any corner node A, non-corner edge node B, or interior node C may connect in this way to a corresponding compute node 504 of different circuit packages 500 at different layers. Indeed, any compute node 504 at any position in a circuit package 500 may be connected in this way to another compute at a same position in another circuit package 500. In some embodiments, all of the compute nodes 504 are connected in this way to similarly positioned compute nodes 504 on adjacent circuit packages 500 or layers. These connections may be optical connections and may be made via inter-chip bidirectional photonic channels 544. In this way, any of the configurations of circuit packages and networks described herein may be augmented by higher-dimensional links to form a higher-dimensional inter-chip electro-photonic network 545-2.

Additionally, depending on the nature and topology of the higher-dimensional network 545-2, any number of additional circuit packages 500 and any number of compute nodes 504 may be included in addition to that shown. For example, in various embodiments, the higher-dimensional network 545-2 may form a mesh of different shapes. The higher-dimensional network 545-2 may form a toroid, wrapped toroid, extensible wrapped toroid, or 3d wrapped toroid. The higher-dimensional network 545-2 may form a 3d, 4d, or 5d (or more) mesh topology. In this way, the higher-dimensional network 545-2 may be configured in a higher dimensions to provide more direct connections between compute nodes 540 in order to reduce the number of hops for transmission of a message across the network.

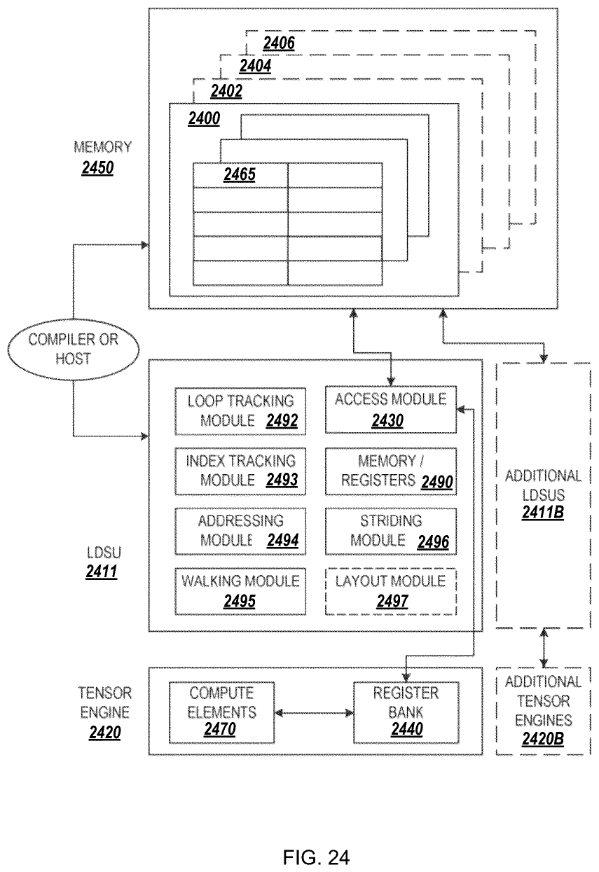

FIG. 6 is a block diagram that shows an example of a memory network system 600 for scaling memory access by using a shared collection of memory devices. The system 600 is a data processing apparatus that includes a collection of compute nodes 610a-610d, such as the example compute nodes 104. In some implementations, the compute nodes 610a-610d can be configured as tensor engines, such as the tensor engines 108. In some implementations, the compute nodes 610a-610d can be configured as load/store units (LDSU) and/or machine-learning (ML) accelerators, which will be discussed in the descriptions of FIGS. 24-36. Each of the compute nodes 610a-610d includes a processor 612 having a processor circuit, a memory controller 614 that is in electrical communication with an on-chip memory 616 (e.g., a bank of SRAM), and a bank of dynamic random-access memory (DRAM) 618. In some implementations, the on-chip memory 616 can be a level 1 (L1) processor cache memory. For example, the compute node 610a includes the processor 612a, the memory controller 614a, the on-chip memory 616a, and the DRAM 618a. Correspondingly, the compute nodes 610b-610d include respective ones of the processors 612b-612-d, the memory controllers 614b-614d, the on-chip memories 616b-616d, and the DRAMs 618b-618d. In some implementations, the on-chip memory 616 can be part of the node 610 or can be positioned on top of a PIC adjacent to an EIC that includes the node 610. However, in some implementations, the on-chip memories 616a-616d can communicatively connected to their corresponding processors 612a-612d by photonic links, such as those discussed throughout this document.

Each of the compute nodes 610z-610d also includes respective ones of a communication transceiver 620a-620d, which are optical or photonic transceivers that each include a photonic transmitter and a photonic receiver. The communication transceivers 620a-620d are configured to communicate with their respective memory controllers 614a-614d in parallel with their respective processors 612a-612d. For example, the communication transceiver 620a can communicate with the memory controller 614a (e.g., to store and/or retrieve data from the on-chip memory 616a or the DRAM 618a) independent from the processor 612a (e.g., the communication transceiver 620a does not need to pass memory requests through the processor 612a). As such, computing cycles of the processors 612a-612d are not required in order to facilitate data transfers between on-chip memories 616a-616d through a collection of photonic links 630a-630d, which will be described in more detail below.

The communication transceivers 620a-620d are communicatively interconnected by the photonic links 630a-630d (e.g., optical waveguides, optical fibers, optical beams). In the illustrated example, a single line is shown between pairs of the compute nodes 610a-610d. In some implementations, two or more links or lanes could be used to multiply the bandwidth between compute nodes (e.g., more links could be used depending on the available ports and the needs of the system). In some implementations, the photonic links 630a-630d can be bidirectional communication links. In some implementations, the photonic links 630a-630d can be unidirectional communication links. In some implementations, the photonic links 630a-630d can be a collection of bidirectional and/or unidirectional communication links (e.g., to expand bandwidth, to use two or more unidirectional links in opposing directions to provide bidirectional communications).

DRAM accesses and refreshes require power, so heavy reliance on DRAM can result in high power draws, as well as high levels of waste heat generation. For example, some conventional systems can consume about 10 pJ/bit to transfer data from DRAM to a processor, and about 50 pJ/bit to transfer data electronically between the communication transceivers. By extension, a system with 256 accelerators based on conventional computing architecture running a one trillion parameter transformer feed-forward neural network (FFN) in FP8 inference can consume 900 J.

Distributed systems frequently require tight synchronization among peer compute nodes. However, conventional systems can also have high communication latencies that require multi-chip collectives to pass data from DRAM to DRAM in order to enqueue sufficiently large amounts of data. The underlying updates can be small and can be sensitive to latency. Sharing data that has fine granularity by conventional systems can result in communication delays that dominate the wait time for updates and slows down some use cases. For example, in a conventional system, transmitting 4 kB at 50 GB/s (400 Gbit/s) can take about 2 microseconds (μs, but communication delays can exceed 10 us on conventional networks. A coherent shared-memory implementation such as the ones that will be discussed in the descriptions of FIGS. 6-10 can significantly reduce such communication delays and latency.

In some implementations, a light engine (e.g., a light source, laser emitter) can be optically connected to the communication transceivers 620a-620d, e.g., by optical waveguides, optical fibers, optical beams. The light engine can provide photonic energy, e.g., light, to the communication transceivers 620a-620d, and the communication transceivers 620a-620d can be configured to modulate the photonic energy as communications signals that are carried by the communication links 630a-630d.

By using the light engine, light generating components (e.g., lasers, light emitting diodes) can be omitted from the circuitry of communication transceivers 620a-620d. However, in some implementations, the communication transceivers 620a-620d can include light generating components instead of or in addition to use of the light engine.

In some implementations, the light engine can be located remotely away from the compute nodes 610a-610d. By locating the light engine remotely, the physical space needed for light generating components within the communication transceivers 620a-620d can be eliminated or reduced. By locating the light engine remotely, the power needed for the generation of light can be routed to the light engine and away from the compute nodes 610a-610d. Furthermore, by locating the light engine remotely, heat energy (e.g., that might otherwise be caused by the generation of light by light-emitting components within the communication transceivers 620a-620d) can be generated and managed away from the compute nodes 610a-610d.

In general, all or parts of each of the on-chip memories 616a-616d forms part of a collective memory system that is distributed across the compute nodes 610a-610d. The collective memory system implements an addressing scheme that organizes the physically separate on-chip memories 616a-616d into a singular virtual memory space that is shared by and is accessible to each of the processor compute nodes 610a-610d.

When performing local (e.g., entirely within the compute node) operations, the processors 612a-612d operate by processing information that is generally stored in the local DRAMs 618a-618d. The processors 612a-612 send requests (e.g., memory requests) for data to their corresponding memory controllers 614a-614d, which responds by determining if the requested data is in the local (e.g., to the requesting one of the memory controllers 614a-614d) on-chip memories 616a-616d. If the data is in the on-chip memory 616a-616b that is local to the requesting one of the memory controllers 614a-614d, then the requesting one of the memory controllers 614a-614d retrieves the data from the corresponding on-chip memory 616a-616d and provides the data to the respective one of the processors 612a-612d. If the data is not in the local one of the on-chip memories 616a-616d, then the respective memory controller 614a-614d retrieves the data from the respective DRAM 618a-618d and provides the data to the requesting one of the processors 612a-612d. In some implementations, all or part of the data can be stored locally in in the on-chip memories 616a-616d.

In an example operation, the processor 612a of the compute node 610a can perform computing operations on data and can store the results to an address within the singular virtual memory space of the collective memory system that is provided by the on-chip memories 616a. A data storage memory request is sent from the processor 612a to the memory controller 614a, and the memory controller 614a is configured to determine if the address corresponds to a portion of the collective memory system that is provided by the local on-chip memory 616a, one of the remote local on-chip memories 616b-616d (e.g., of the compute nodes 610b-610d), or a combination of both.

If the memory controller 614a of the compute node 610a determines that the address is hosted by the on-chip memory 616a of the compute node 610a, then the memory controller 614a stores the data to the on-chip memory 616a of the compute node 610a. In some implementations, such memory operations can be memory coherent (e.g., every read can observe the latest update of value written to a corresponding address, and only a single writer may modify an on-chip memory line at any time.

If the memory controller 614a of the compute node 610a determines that the address is hosted by one of the on-chip memories 616b-616d of the compute nodes 610b, 610c, and/or 610d, then the memory controller 614a routes the request to the communication transceiver 620a of the compute node 610a. The communication transceiver 620a is an optical transceiver that converts the request into optical signals that are transmitted over one or more of the communication links 630a-630d to one or more of the communication transceivers 620b-620d of the compute nodes 610b-610d. The request is routed to and received by the appropriate one or more of the communication transceivers 620b-620d of the compute nodes 610b-610d.

For example, the communication transceiver 620b of the compute node 610b can determine if the address of the request is hosted by the on-chip memory 616b of the compute node 610b. If the address is not physically hosted by the compute node 610b, then the communication transceiver 620b can transmit the request to another one of the compute nodes 610c, 610d, either directly or through intermediate nodes.

If communication transceiver 620b determines that the requested address is physically hosted by the compute node 610b, then the communication transceiver 620b can convert the received optical signals into electrical signals that are provided to the memory controller 614b. The memory controller 614b can the determine whether or not the memory address of the request is hosted by the on-chip memory 616b. If the address is hosted locally, then the data from the compute node 610a is stored in the local on-chip memory 616a. If the memory controller 614a determines that the address of the request is not hosted by the local on-chip memory 616, then the request is routed to one or more of the memory controllers 614b-614d.

In such examples, data from one of the compute nodes 610a-610d can be stored to or retrieved from the on-chip memories 616a-616d in a manner that is transparent to the processors 612a-612d and carries out the data transfer operations in the optical domain. Communicating using optics instead of electronics enables greater physical separation of the compute nodes 610a-610d, thereby enhancing flexibility in the physical architecture of the system 600. For example, the faster speeds of photonic communication than electronic communication can allow communication endpoints to communicate at relatively greater distances with fewer complications due to latencies in high-speed communications. In another example, use of photonics reduces or eliminates complications due to electromagnetic interference, crosstalk, timing skew, ground bounce, and/or signal integrity in high-speed electrical communications.

When performing operations that require high-speed movement of data between the compute nodes 610a-610d, data can be transferred using the collective memory system. For example, computing tasks in which a single conventional compute node would frequently access a local on-chip memory, cache, accumulator, or scratchpad memory to accelerate computing operations can be transformed into a much faster parallel computing system in which the example compute nodes 610a-610d operate in parallel and access the collective memory formed by the on-chip memories 616a-616d to share and transfer data among the compute nodes 610a-610d.

In some implementations, a software compiler can be configured to transform high-level or intermediate software code into machine code that is specific to the system 600. For example, in the illustrated example the system 600 includes four compute nodes 610a-610d, and a compiler can be configured based on the specific architecture of the system 600 in order to generate machine code that is capable of utilizing the features of the system 600, particularly the shared on-chip memory collectively provided by the on-chip memories 616a-616d, the communication transceivers 620a-620d, and the communication links 630a-630d (e.g., to enable the processors 612a-612d to store, retrieve, and transfer data between the on-chip memories 616a-616d) and promote memory coherency among the on-chip memories 616a-616d. In some implementations, the memory network system 600 can include one or more worker nodes, such as central processor units (CPUs), graphics processing units (GPUs), tensor processing units (TPUs), artificial intelligence (AI) accelerators, tensor engines, neural compute engines, any other appropriate circuit designed to process data, or combinations thereof. As shown in the illustrated example, the system 600 has four compute nodes, but in practice systems could have other numbers (e.g., two, eight, sixteen, sixty-four, hundreds, thousands) of nodes operating as an optically interconnected system.

In some implementations, the compiler can schedule operations on worker nodes, splitting up tensors such that the right slices are stored in the right OMAs. In some implementations, the compiler algorithm for a 2×2 matrix can be substantially same for a 10000×10000 matrix. In some implementations, the computational graph can be tailored to the hardware system (e.g., the compiler can have data that represents the structure of the hardware system).

In systems in which multiple components (e.g., CPUs, GPUs, accelerators) are configured to work in parallel, memory coherency can become an issue that can lead to errors or performance bottlenecks. For example, two separate processors working on a shared task may conflict if both processors cache a portion of shared system memory and one processor performs an operation that modifies that portion of memory while the other processor continues to operate on the outdated cached version. The system 600 can be configured to promote memory coherency across portions, or the entirety of, the on-chip memories 616a-616d.

For example, reads and writes to/from the on-chip memories 616a-616d can be implemented by using a messaging protocol that implements a request and response approach to transport or compliment memory load and store commands, in which the availability of a targeted memory location (e.g., the address is not locked, reserved, or otherwise actively being accessed by another process or processor) and/or the status of a targeted memory location (e.g., the content of the address is not flagged as outdated or expired). In some implementations, the system 600 can have two coherency biases that direct how coherent data is moved between devices: host bias and device bias.

In some operational situations, a device can be working on data between a time-of-work submission to a host device and the submissions' completion. In examples such as this, the device bias mode can be used to ensure that the device can access its device-attached memory directly without engaging the host device's coherency engines. Thus, the device can function with an assurance that the host does not have the line cached. This improves latency performance of the device.

The host bias mode can prioritize coherent access from the host to device-attached memory. In some implementations, the host bias mode can be used during work submission, when data is being written from the host to device-attached memory, and it can be used for work completion when the data is being read out of the device-attached memory by the host. In host bias mode, the device-attached memory can be accessible to the device just like host-attached memory, and if the device requests access to host-attached memory, the request can be handled by a request to the host. In some implementations, the coherency protocol can be asymmetric.

In some implementations, memory coherency can be achieved by implementing a protocol that adheres to, or is based on, the Compute Express Link (CXL) protocol. In some implementations, the protocol can be extended or modified based on the specific architecture of the system 600. For example, a compiler can be created to generate machine instructions that take advantage of the shared common memory space provided by the on-chip memories 616a-616d by implementing memory coherency protocols to facilitate memory reads and writes that move data among the compute nodes 610a-610d.

In some implementations, the system 600 can be configured to execute software instructions that cause the processors 612a-612d and/or the communication transceivers 620a-620d to perform operations to promote coherency across the on-chip memories 616a-616d. For example, the compute nodes 610a-610d can be configured to implement the CXL standard, in which can promote the use of disaggregated memory and on-chip memory coherence.

Disaggregation of memory, in general terms, can separate compute from memory and allow independent scaling of compute and memory. Disaggregated memory can also permit system components to be upgraded and maintained independently and can provide a level of hardware fault tolerance. CXL protocols can accommodate various hardware topologies and access control, so in some implementations different memory segments located on a given compute node 610a-610d can be shared with different ones of the compute nodes 610a-610d substantially simultaneously. In some implementations, the entire address space of the combined on-chip memories 616a-616d may be shared in a coherent manner.

In some implementations, memory coherence can be used to assert that each load operation observes an outcome of the most recent store to the same memory address. Memory coherency prevents reads from a selected on-chip memory location when a write is in process and prevents writes to a selected on-chip memory location when a read is in process. As such, concurrent writes can be prevented. Examples of memory coherence protocols that can be implemented by the system 600 can include, but are not limited to, as Modified Exclusive Shared Invalid (MESI), Modified Owned Exclusive Shared Invalid (MOESI), and Modified Exclusive Shared Invalid Forward (MESIF). Some cache coherence protocols can provide coherence in a distributed setting, for example, by defining a state machine for each on-chip memory line. In use, memory accesses and evictions can cause transition between states. The state, in turn, can determine the behavior for the next memory access or eviction.

In operation, the system 600 can operate with low communication latencies, allow the fusing of multi-chip collectives with compute kernels in order to get improved or complete reuse on DRAM transfers, and running the inter-chip collectives between on-chip SRAMs. By operating at least partly in the optical domain, the example system 600 can also operate with reduced power consumption and waste heat generation. For example, the system 600 can consume about 10 pJ/bit to transfer data from the DRAM 618a to the processor 612a, and about pJ/bit (e.g., one tenth the amount of power used by some conventional systems) to transfer data between the communication transceivers 620a-620d.

In some implementations, the architecture of the system 600 can be used to perform inference or training of large language models. For example, as a model's size increases to the trillion parameter range to improve performance, performance limitations emerge when using a small number of accelerators. More specifically, inference latency can become much larger than what a user-facing application would be able to accommodate. As such, there is an increasing need to distribute such operations over a larger number of accelerators for the implementation to make commercial sense. For dense transformer models with a trillion parameters or more, the required number of accelerators can reach into the low hundreds, such as 256 accelerators. By using implementations of the systems described in this document, systems of large numbers of accelerators can be used, inference latency can be reduced, and power consumption can be reduced (e.g., relative to traditional systems).

Distributing the matrix multiplication over 256 accelerators can be done by sharding the output feature dimension, which in the case of a typical FFN1 of a transformer model corresponds to a matrix multiplication [ctxlen, dmodel]×[dmodel, 4dmodel]. When sharded over output dimension over Naccelerators, this will result in each accelerator running a matrix multiplication sized [ctxlen, dmodel]×[dmodel, 4dmodel/Naccelerators].

The input to this operation has been calculated in a previous operation which itself was distributed over all accelerators, hence we consider that each accelerator contains 1/Naccellerators portion of the data. To satisfy the data dependencies of this operation (e.g., in which all workers use the full input matrix as an input), the input [ctxlen, dmodel] needs to be broadcast over all accelerators, which can be done with an all gather communication collective. Such a collective requires at least ctxlen*dmodel*(Naccelerators−1)/Naccelerators*bytesperelement*2 bytes of off-chip input and output per accelerator.

The total energy spend on matrix multiplication can be represented as ctxlen*dmodel*4dmodel*energyperMAC. The value of energyperMAC is assumed to be equivalent to 1 pJ/MAC for a matrix multiplication with FP8 inputs and FP32 outputs. The total energy per bit for off-chip communication is of the order of 50 pJ/bit for conventional solutions, and 10 pJ/bit for system 600. Each bit loaded or stored to off-chip memory is considered to have an energy cost of 10 pJ/bit. Each bit loaded or stored to an on-chip memory is considered to have an energy cost of 1 pJ/bit.

In some conventional solutions, the communication collectives copy data between off-chip memories, incurring the total additional energy cost of loading/storing ctxlen*dmodel*(Naccelerators-1)*bytesperelement*2 bytes from/to off-chip memories as well as transmitting them over the communication fabric, with an energy cost of about 70 pJ/bit.

In the system 600, the communication collectives copy data between on-chip memories, only spending the additional energy cost of transmitting them over the fabric specific to system 600, resulting in an energy cost of 10 pJ/bit (e.g., about 1/7^{th} or about 15% of the power used by conventional solutions)

Both solutions perform the matrix multiplication and load the inputs/store the output from/to off-chip memory, incurring ctxlen*dmodel*4dmodel*energyperMAC+ctxlen*(1+1+4*4)*dmodel*8*10 pJ/bit minimum energy cost (excluding the communication collective). An example trillion parameter transformer model scaled using the GPT3 architecture would have dmodel=32 k. A representative context length is ctxlen=128 k. In such an example, executing the algorithm would have a minimum energy cost excluding the communication collective of about 282 J.

In the conventional solution, executing the collective between off-chip memories using a conventional fabric would consume an additional 876J, resulting in a total energy of 1158J. System 600 would require only an additional 175J by running the collectives between off-chip memories using the celestial fabric, resulting in a total energy of 457J. This figure represents an approximate 61% improvement in power efficiency relative to the conventional solution.

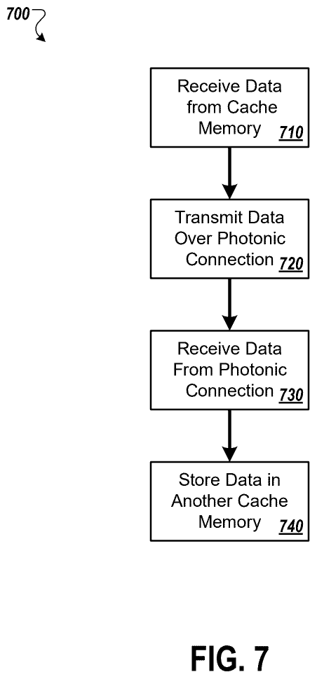

FIG. 7 is flow chart that shows an example of a process 700 for scaling memory access by using a shared collection of memory devices. In some implementations, the process 700 can be a computer program performed by all or part of the example memory network system 600 of FIG. 6.

At 710, data is received from an on-chip memory. In some implementations, the on-chip memory can be a dedicated memory, some or all of a processor cache, or scratchpad memory. For example, the processor 612a of the compute node 610a can send a memory request data from the on-chip memory 616a. This request is handled by the memory controller 614a, which receives the requested data from the on-chip memory 616a.

At 720, the data is transmitted over a photonic connection. For example, the memory controller 614a can pass the received data to the communications transceiver 620a. The communications transceiver 620a can convert the data into a photonic signal that can be transmitted over the communication link 630b, which can be a photonic connection.

At 730, the data is received from the photonic connection. For example, the communications transceiver 620c of the compute node 610c can receive the photonic signal sent by the communications transceiver 620a and convert the photonic signal back into an electronic signal that is provided to the memory controller 614c of the compute node 610c.

At 740, the data is stored in another on-chip memory. For example, the memory controller 614 of the compute node 610c can receive the data as an electronic signal provided by the communications transceiver 620c and can store the received data in the on-chip memory 616c of the compute node 610c.

In some implementations, a similar process can be performed in order to retrieve data from a portion of on-chip memory that is physically hosted on a remote compute node. For example, the compute node 610a can send a data request to the compute node 610b, and the compute node 610b can respond by retrieving the requested data and transmitting it back to the compute node 610a using a process that is substantially similar to the example process 700.

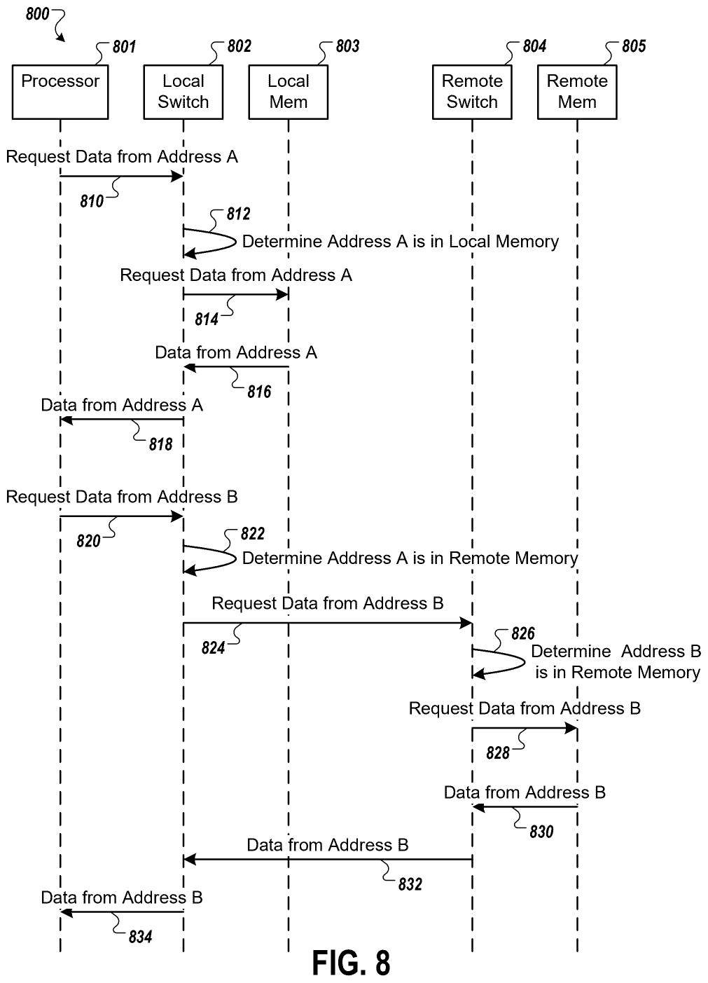

FIG. 8 is a timeline diagram of an example of a process 800 for retrieving data from a shared collection of memory devices. In some implementations, the process 800 can be a computer program performed by all or part of the example memory network system 600 of FIG. 6.

In an example data request, a processor 801 (e.g., one of the example processors 612a-612d) sends a request 810 to a local memory switch 802 (e.g., a corresponding one of the example memory controllers 614a-614d that is electronically and architecturally proximal to the processor). The request 810 is a request for data from a memory address “A”.

The local memory switch 802 inspects the address and determines 812 that address “A” is physically located in a local memory (e.g., one of the on-chip memories 616a-616d proximal to the corresponding memory controller 614a-614d). In response to this determination, the local memory switch 802 sends a request 814 to a local memory 803 for data from address “A”. In response, the local memory 803 provides 816 the data from address “A” to the local memory switch 802, and the local switch 802 provides 818 the data from address “A” to the processor 801.

In another data request, the processor 801 sends a request 820 to the local memory switch 802 for data from a memory address “B”. The local memory switch 802 inspects the address and determines 822 that address “B” is physically located in a remote memory (e.g., the on-chip memory 616b of the compute node 610b). In response to this determination, the local memory switch 802 sends a request 824 to a remote memory switch 804 for the data from address “B”.

The remote memory switch 804 receives the request 824 and determines 826 that address “B” is physically located in the remote memory 805. In response to this determination 826, the remote memory switch 804 sends a request 828 to the remote memory 805 for data from address “B”. In response, the remote memory 805 provides 830 the data from address “B” to the remote memory switch 804, which provides 832 the data to the local memory switch 802. The local memory switch 802 receives the data and provides 834 the data from address “B” to the processor 801.

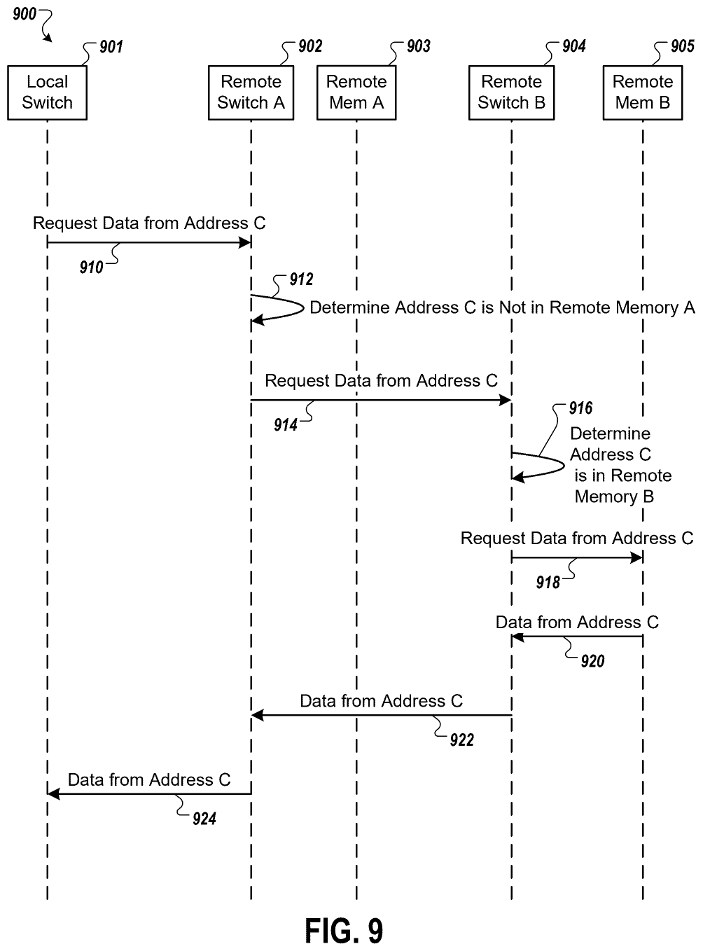

FIG. 9 is a timeline diagram of another example of a process 900 for retrieving data from a shared collection of memory devices. In some implementations, the process 900 can be a computer program performed by all or part of the example memory network system 600 of FIG. 6.

In an example data request, a local memory switch 901 (e.g., the example memory controller 614a of the compute node 610a) sends a request 910 to a remote memory switch 902 (e.g., the memory controller 614b of the compute node 610b). The request 910 is a request for data from a memory address “C”.

The remote memory switch 902 inspects the address and determines 912 that address “C” is not physically located in a remote memory 903 (e.g., the on-chip memory 616b of the compute node 610b). In response to this determination, the remote memory switch 902 sends a request 914 to a remote memory switch 904 (e.g., the example memory controller 614c of the compute node 610c) for the data from address “C”.

The remote memory switch 904 receives the request 914 and determines 916 that address “C” is physically located in the remote memory 905 (e.g., the example on-chip memory 616c of the compute node 610c). In response to this determination 916, the remote memory switch 904 sends a request 918 to the remote memory 905 for data from address “C”. In response, the remote memory 905 provides 920 the data from address “C” to the remote memory switch 904, which provides 922 the data to the remote memory switch 902. The remote memory switch 902 receives the data and provides 924 the data from address “C” to the local memory switch 901.

In some implementations, the process 900 can use an absolute addressing scheme in which the origin and/or destination addresses are directly representative of a predetermined memory location within a predetermined physical on-chip memory (e.g., address “C” is always within compute node 610c regardless of the layout of the example system 600). For example, the process 900 can implement a routing algorithm or lookup table that can translate a memory address to a physical memory location.

In some implementations, the process 900 can use a relative addressing scheme in which the origin and/or destination addresses are representative of a memory location relative to the sender's and/or requestor's address. For example, a sender can view its own address as “0” (zero). When the processor of the node “0” sends a request for data from address “0” to its memory switch, the memory switch can recognize that “0” corresponds to local on-chip memory and can retrieve the requested data locally.

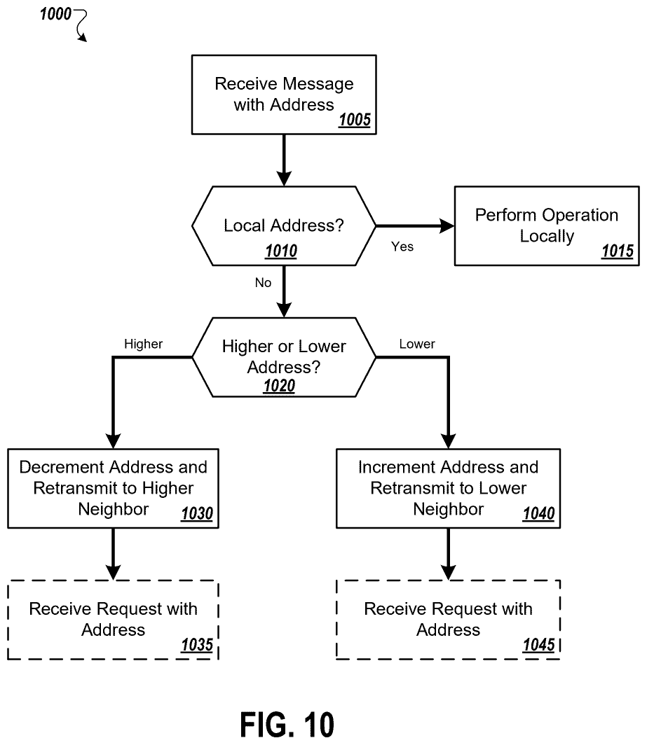

In another example, the processor of the node “0” can send a request for data from an address of “2”, which is representative of a memory location that is two locations or computing nodes away. The memory switch of node “0” can recognize that the address “2” is not a local address, and respond by decrementing the address (e.g., “2” becomes “1”) and pass the request to its neighbor node “1”. Node “1”, which views its own address as “0”, can receive the address and recognize that the address “1” does not match “0”. In response, node “1” can decrement the address (e.g., “1” becomes “0”) and pass the request to its neighbor node “2”. Node “2”, which views its own address as “0”, can receive the address and recognize that the address “0” matches the address “0” and respond by retrieving the data from its local on-chip memory. The data is routed back to the node “0” by substantially reversing the process to pass the response back from node “2” to node “1” to node “0”. An example of relative addressing is discussed further in the description of FIG. 10.

FIG. 10 is a flow chart that shows an example of a process 1000 for handling request addressing in a shared collection of memory devices. In some implementations, the process 1000 can be a computer program performed by all or part of the example memory network system 600 of FIG. 6.

At 1005, a message with an address is received. For example, the memory controller 614a can receive a request for data from the processor 612a.

At 1010, a determination is made. If the requested address is determined to be a local address, then at 1015 the operation is performed locally. For example, the memory controller 614a can be configured to recognize an address of “0” (zero) as being a local address (e.g., an address in the on-chip memory 616a of the same compute node as the memory controller 614a). When the memory switch receives a data request with an address of “0”, then the memory switch 614a can respond by retrieving the requested data from the on-chip memory 616a of the same compute node.

If at 1010, the requested address is determined to not be a local address, then the process 1000 continues at 1020. For example, if one of the memory controllers 614a-614d receives a non-zero address, then the memory controller 614a-614d can recognize that the address is not local to the compute node.

At 1020, another determination is made. If at 1020, the requested address is higher than the local address, then at 1030 the address is decremented and retransmitted to a next higher neighbor. For example, processor 612c can make a request for data from address “1”. The memory switch 614c can recognize that address “1” is not the local address “0” and can recognize that the address is higher than the local address (e.g., “1”>“0”), and respond by decrementing the address (e.g., “1” becomes “0”) and pass the request to its “higher” neighboring compute node 610d.

At 1030, the request with the decremented address is received. For example, the compute node 610d can receive the request, including the decremented address, from the compute node 610c. In some implementations, the receiving node can perform the process 1000 again in order to determine if the message can be acted upon locally or if it needs to be relayed on to another neighboring node. For example, the compute node 610d can receive the message with the decremented address of “0”, determine that the address is a local address (e.g., step 1010) and respond by performing the operation locally (e.g., step 1015). If the received address is not a local address, then the compute node 610d can determine how to route the message (e.g., step 1020).

If at 1020, the requested address is lower than the local address, then at 1040 the address is incremented and retransmitted to a next lower neighbor. For example, processor 612d can make a request for data from address “−1”. The memory switch 614d can recognize that address “−1” is not the local address “0” and can recognize that the address is lower than the local address (e.g., “−1”<“0”), and respond by incrementing the address (e.g., “−1” becomes “0”) and pass the request to its “lower” neighboring compute node 610c.

At 1045, the request with the incremented address is received. For example, the compute node 610c can receive the request, including the incremented address, from the compute node 610d. In some implementations, the receiving node can perform the process 1000 again in order to determine if the message can be acted upon locally or if it needs to be relayed on to another neighboring node. For example, the compute node 610c can receive the message with the decremented address of “0”, determine that the address is a local address (e.g., step 1010) and respond by performing the operation locally (e.g., step 1015). If the received address is not a local address, then the compute node 610d can determine how to route the message (e.g., step 1020).

While the preceding example process 1000 used a single address value in a one-dimensional (e.g., daisy-chained) arrangement of nodes for the sake of simplicity, other relative addressing schemes could be used. For example, a two-dimensional addressing format and architecture could be used, such as the 2×2 grid shown in the example system 600. For example, in an 8×8 grid of nodes, an address of “4, −3” could represent a location that is offset four locations above and three locations to the left of the originating node within the grid). In another example, higher (e.g., three, four, five) dimensional architecture and relative addressing format could be used.

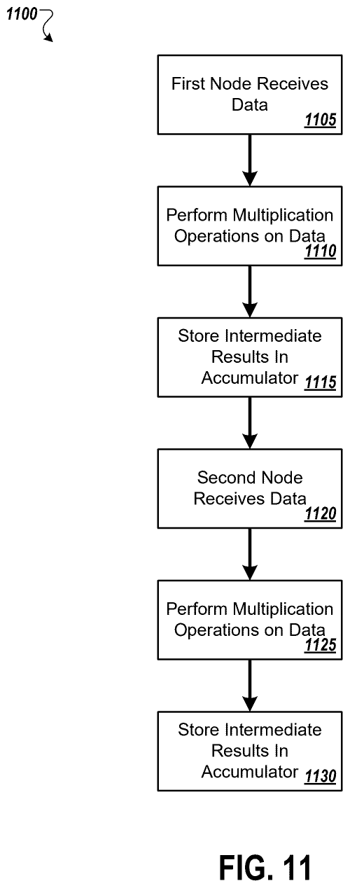

FIG. 11 is a flow chart that shows an example of a process 1100 for a computerized matrix multiplication operation. In some implementations, the process 1100 can be a computer program performed by all or part of the example memory network system 600 of FIG. 6.

At 1105a first compute node receives a first collection of data. The first compute node includes a first on-chip memory. For example, the compute node 610a can receive a collection of data, either from the DRAM 618a, the on-chip memory 616a, or from an external system. In some implementations, the data can be row and/or column data for matrix mathematical operations.

At 1110, multiplication operations are performed on the first collection of data. For example, the processor 612a of the compute node 610a can perform matrix multiplication (matmul) operations on the data.

At 1115, the first compute node stores first intermediate results of the multiplication operations in an accumulator partly defined by at least a portion of the first on-chip memory. For example, the processor 612a of the compute node 610a can store matmul results in the on-chip memory 616a, which is part of a larger collective memory space that also includes portions of the on-chip memories 616b-616d.

At 1120, a second compute node receives a second collection of data. The second compute node includes a second on-chip memory. For example, the compute node 610b can receive a collection of data, either from the DRAM 618b, the on-chip memory 616b, or from an external system. In some implementations, the data can be row and/or column data for matrix mathematical operations.

At 1125, multiplication operations are performed on the second collection of data. For example, the processor 612b of the compute node 610b can perform matmul operations on the data.

At 1130, the first compute node stores first intermediate results of the multiplication operations in an accumulator partly defined by at least a portion of the first on-chip memory, wherein the first on-chip memory and the second on-chip memory are communicatively connected by one or more photonic links. For example, the processor 612b of the compute node 610b can store matmul results in the on-chip memory 616b, which is part of a larger collective memory space that also includes portions of the on-chip memories 616a, 616c, and 616d. The on-chip memories 616a-616d are interconnected by the communication transceivers 620a-620d and the photonic links 630a-630d.

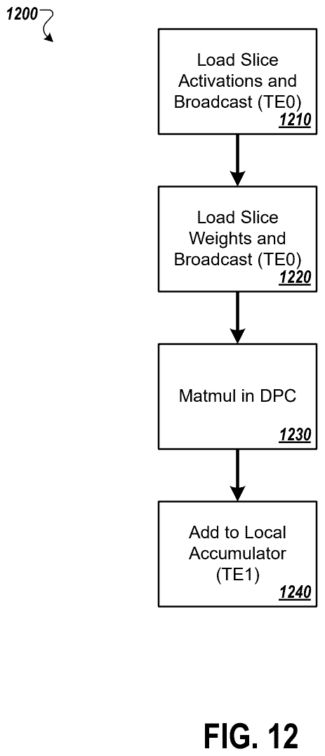

FIGS. 12-21 show several examples of pipelining operations across time. In general, matmul requires column and row broadcast of data to worker nodes, and the worker nodes continue to perform multiplication operations until they go through the entire dimension of the matrix and reach the end. Each of the worker nodes can have a local accumulator that can store the intermediate results at each time the node multiplies again. The photonic links are used to move the patches down the row and column at each iteration.

This algorithm is for pipelining in time, where you spread computation in time, so computing resource use is overlapped. The computations can be scheduled in a unique way that is enabled by the example embodiments of the present disclosure.

FIG. 12 shows an example of a process 1200 for another computerized matrix multiplication operation, according to at least one embodiment of the present disclosure. In some implementations, the process 1200 can be performed by all or part of the example memory network system 600 of FIG. 6.

At 1210, slice activations are loaded and broadcast by a first tensor engine (TE0). For example, the activations can be loaded to and/or from the on-chip memory 616a of the compute node 610a, over the photonic links 630a-630d if the activations are not already in a local on-chip memory, and then broadcast by the compute node 610a over the photonic links 630a-630d.

At 1220, slice weights are loaded and broadcast by the first tensor engine (TE0). For example, the weights can be loaded to and from the on-chip memory 616a, over the photonic links 630a-630d if the weights are not already in a local on-chip memory, and then broadcast over the photonic links 630a-630d.

At 1230, a matrix multiplication (matmul) operation is performed in a differentiable predictive control (DPC) process. For example, a neural network-based process can be performed by one or more of the processors 612a-612d for learning control policies from data, in which the system's behavior can be identified using a neural model to ensure realistic predictions, and then control policies can be optimized without supervision. To provide a system capable of learning various control strategies through advanced optimization techniques.

At 1240, the results of the matmul are added to a local accumulator by a second tensor engine (TE1). For example, the results can be stored to the on-chip memory 616b of the compute node 610b.

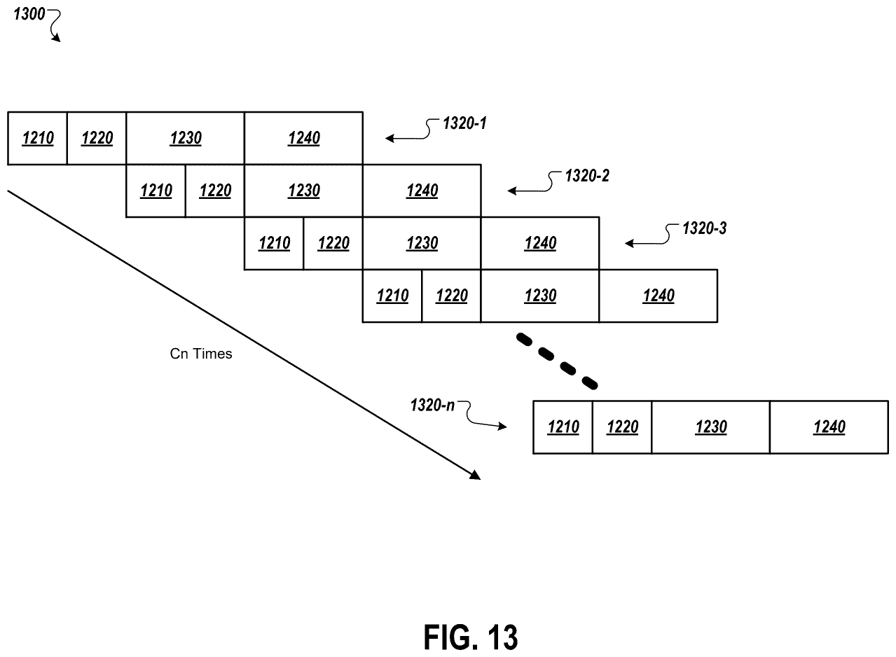

FIG. 13 is a flow chart that show an example of a process 1300. In general, the process 1300 is the example process 1200 at various stages of a pipeline operation, according to at least one embodiment of the present disclosure.

At a stage 1320-1, steps 1210 to 1240 are performed. However, once step 1220 of 1320-1 has been completed, a new stage 1320-2 begins with steps 1210 and 1220 of stage 1320-2 being performed while step 1230 stage 1320-1 is being performed. As such, the steps 1210 and 1220 of stage 1320-2 are performed substantially in parallel (timewise) as the step 1230 of stage 1320-1, and step 1230 of step 1320-2 is performed substantially in parallel (timewise) as the step 1240 of stage 1320-1. Step 1240 of stage 1320-2 is performed after step 1230 of stage 1320-2 is completed.

Once step 1220 of 1320-2 has been completed, a new stage 1320-3 begins with steps 1210 and 1220 of stage 1320-3 being performed while step 1230 stage 1320-2 is being performed. Step 1240 of stage 1320-2 is performed while step 1230 of stage 1320-3 is being performed, followed by step 1240.

This pipeline (e.g., cascade, waterfall) pattern of operations continues “n” times until a stage 1320-n is performed. In some implementations, each of the stages 1320-1 to 1320-n can represent a separate thread block that can be executed in at least partly in parallel with the other thread blocks. In some implementations, various ones of the stages 1320-1 to 1320-n can be performed by different compute nodes such as the compute nodes 610a-610d.

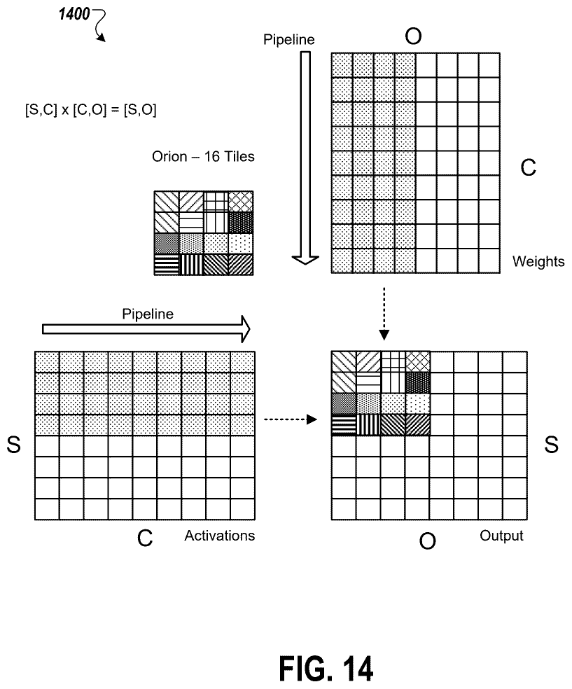

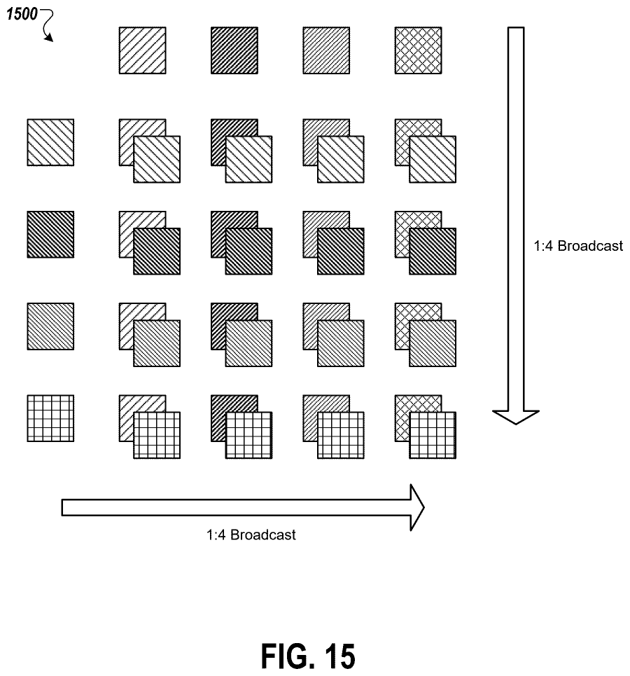

FIGS. 14 and 15 are conceptual illustrations of an example computerized matrix multiplication operation 1400, according to at least one embodiment of the present disclosure. Matrix multiplication operations are the building blocks for many operations in the neural networks that power large language model (LLM) artificial intelligence systems. In the illustrated example, an activation matrix having S rows and C columns is multiplied against a weights matrix having C rows and O columns to produce an output matrix having S rows and O columns.

Compute nodes such as the compute nodes 610a-610d can implement matrix multiplication operations by partitioning the output matrix into tiles, which are then assigned to thread blocks. Tiling matrix multiplication is a technique that can be used to optimize resource utilization, such as power, compute, and memory. In some implementations, tiling can reduce overall latency, especially for implementations that rely on dense matrix multiplication. Use of the photonic links 630a-630d can further reduce overall latency (e.g., relative to conventional electronic links) by communicating information between the on-chip memories 616a-616d as part of the tiling operations.

Tile size usually refers to the dimensions of these tiles. For example, FIG. 14 shows S tiles×O tiles. Each thread block can be computed to determine its output tile by stepping through the C dimension in tiles, loading the required values from the activations and weights matrices, and multiplying and accumulating them into the output.

In the context of the systems described herein, the operation 1400 is performed by running partial accumulation in the compute node, such as the example compute nodes 610a-610d, that will store the accumulation to HBM. 4×4 partial accumulations are performed at a time. Such operations implement vertical broadcast on weights, and horizontal broadcast on activations. FIG. 15 shows a conceptual representation 1500 of a 1:4 broadcast of weights and activations. Such broadcasts can be performed across the photonic links 630a-630d of the memory network system 600.

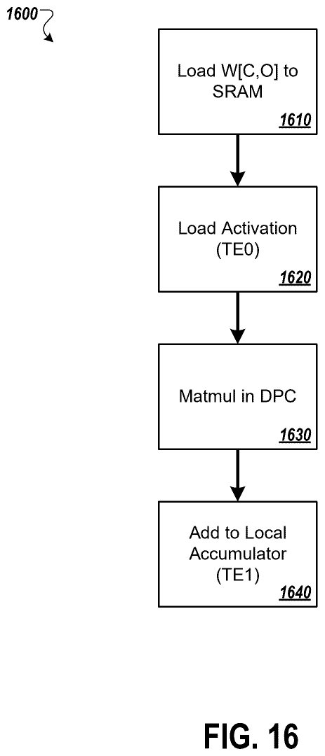

FIG. 16 shows an example of a process 1600 for another computerized matrix multiplication operation, according to at least one embodiment of the present disclosure. In some implementations, the process 1600 can be performed by all or part of the example memory network system 600 of FIG. 6.

At 1610, weights [[W[C,O]]] are loaded to on-chip memory. For example, the weights can be loaded to and from the on-chip memories 616a-616d, over the photonic links 630a-630d if the weights are not already in a local on-chip memory, and then broadcast over the photonic links 630a-630d.

At 1620, activations are loaded by a first tensor engine (TE0). For example, the activations can be loaded to and from the on-chip memory 616a of the compute node 610a, over the photonic links 630a-630d if the activations are not already in a local on-chip memory, and then broadcast by the compute node 610a over the photonic links 630a-630d.

At 1630, a matrix multiplication (matmul) operation is performed in DPC.

At 1640, the results of the matmul are added to a local accumulator by a second tensor engine (TE1).

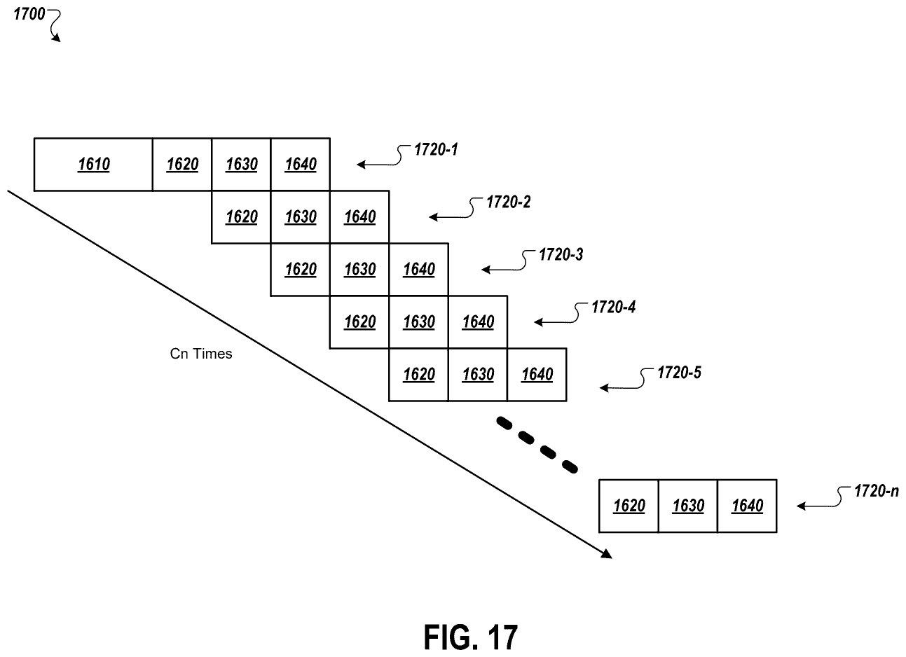

FIG. 17 is a flow chart that show an example of a process 1700. In general, the process 1700 is the example process 1600 at various stages of a pipeline operation, according to at least one implementation of the present disclosure.

At a stage 1720-1, step 1610 is performed, followed by steps 1620-1640. The weights loaded during step 1610 remain loaded and are reused during subsequent stages of the process 1700. Once step 1620 of stage 1720-1 has completed, step 1620 is performed again in stage 1720-2 while step 1630 is performed in stage 1720-1. As such, step 1620 of stage 1720-2 is performed substantially in parallel (timewise) with the step 1630 of stage 1720-1. Once step 1630 of stage 1720-1 has completed, step 1630 is performed again in stage 1720-2 while step 1640 is performed in stage 1720-1. As such, step 1630 of stage 1720-2 is performed substantially in parallel (timewise) with the step 1640 of stage 1720-1.

This pipeline (e.g., cascade, waterfall) pattern of operations continues “n” times until a stage 1720-n is performed. In some implementations, each of the stages 1720-1 to 1720-n can represent a separate thread block that can be executed in at least partly in parallel with the other thread blocks. In some implementations, various ones of the stages 1720-1 to 1720-n can be performed by different compute nodes such as the compute nodes 610a-610d.

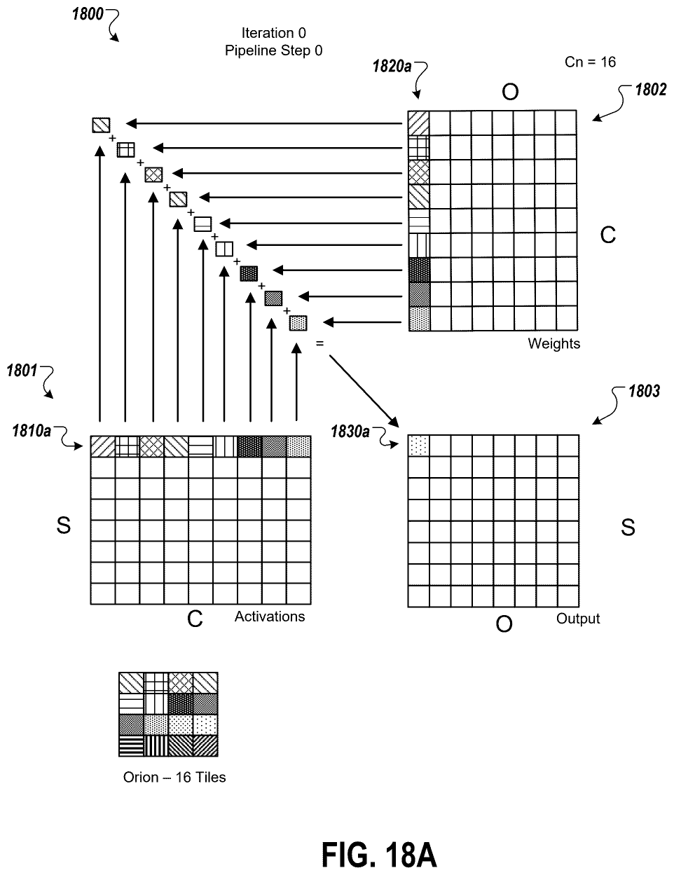

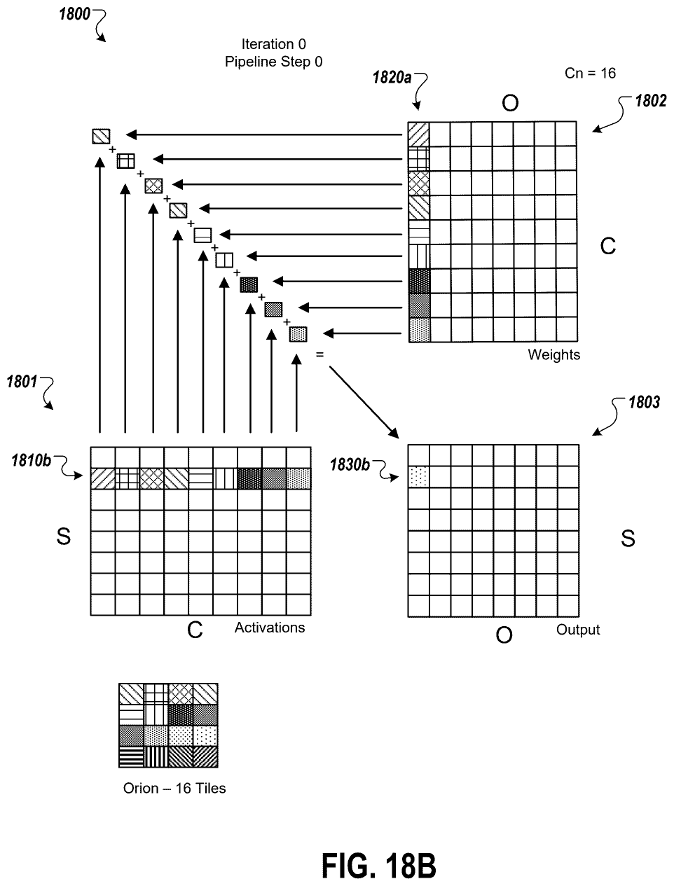

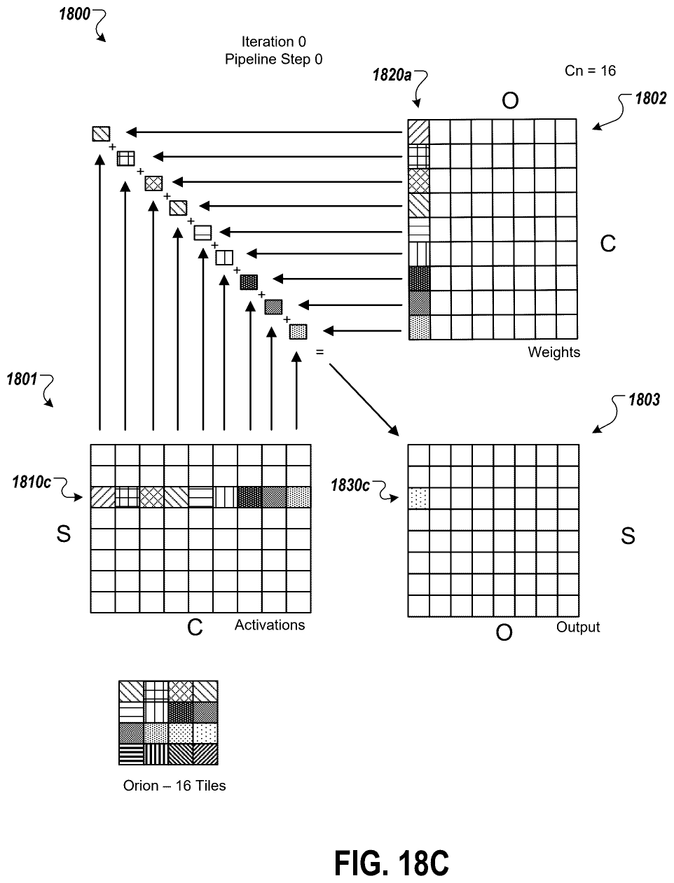

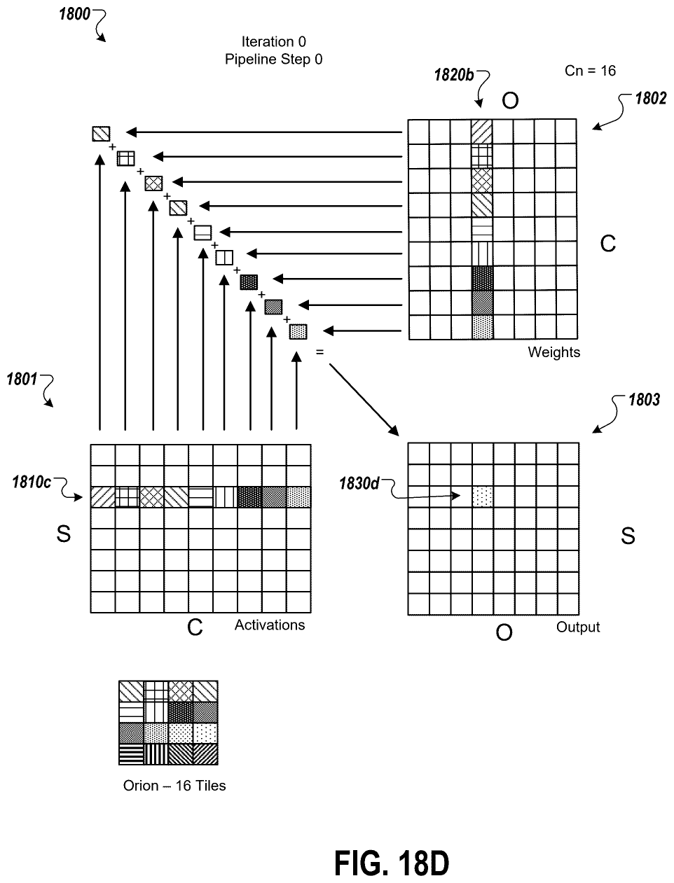

FIGS. 18A-18D illustrate an example computerized matrix multiplication operation 1800 with local inputs. In the context of the systems described herein, the operation 1800 is performed by dividing the matmul operation into 16 partial accumulations, with each accumulation running a separate compute node, such as the example compute nodes 610a-610d.

The operations can be pipelined over S or O. In some implementations, each weights slick can be loaded once and can then be pipelined over S. In some implementations, each activation slice can be loaded once and can then be pipelined over O. In some implementations, a reduction over all tiles can be performed for every pipeline stage.

In FIG. 18A, a first row 1810a of activations 1801 is multiplied against a first column 1820a of weights 1802 and summed to determine a first cell 1830a, such as [0,0], of an output matrix 1803.

In FIG. 18B, a second row 1810b of activations 1801 is multiplied against the first column 1820a of weights 1802 and summed to determine a second cell 1830b, such as [0,1], of the output matrix 1803.

In FIG. 18C, a third row 1810c of activations 1801 is multiplied against the first column 1820a of weights 1802 and summed to determine a third cell 1830c, such as [0,2], of the output matrix 1803.

In FIG. 18D, the third row 1810c of activations 1801 is multiplied against a fourth column 1820b of weights 1802 and summed to determine a fourth cell 1830d, such as [3,2], of the output matrix 1803.

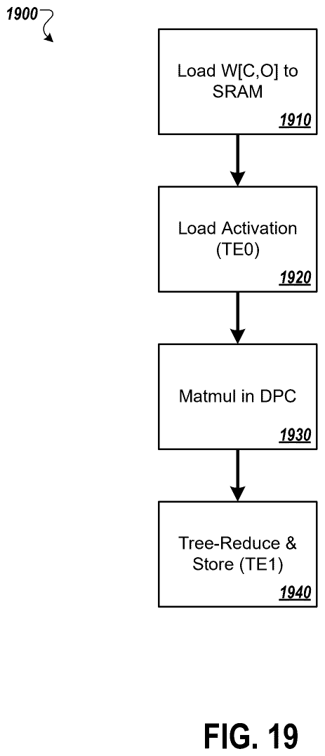

FIG. 19 shows an example of a process 1900 for another computerized matrix multiplication operation, according to at least one implementation of the present disclosure. In some implementations, the process 1900 can be performed by all or part of the example memory network system 600 of FIG. 6.

At 1910, weights [[W[C,O]]] are loaded to on-chip memory. For example, the weights can be loaded to and from the on-chip memories 616a-616d, over the photonic links 630a-630d if the weights are not already in a local on-chip memory, and then broadcast over the photonic links 630a-630d.

At 1920, activations are loaded by a first tensor engine (TE0). For example, the activations can be loaded to and from the on-chip memory 616a of the compute node 610a, over the photonic links 630a-630d if the activations are not already in a local on-chip memory, and then broadcast by the compute node 610a over the photonic links 630a-630d.

At 1930, a matrix multiplication (matmul) operation is performed in DPC.

At 1940, the results of the matmul are tree-reduced and stored by a second tensor engine (TE1). In the illustrated example, the reduction is a 16:1 reduction.

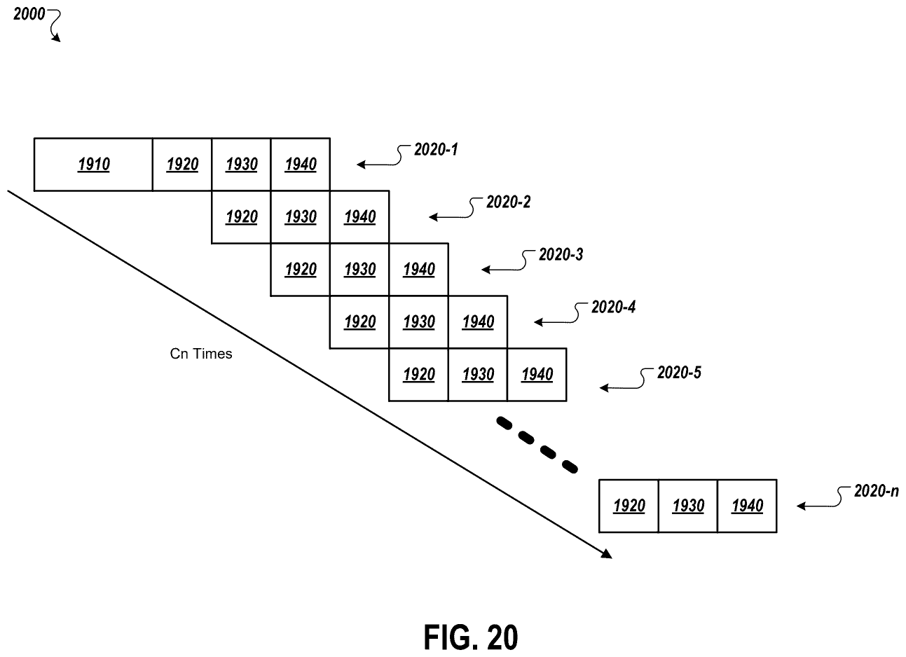

FIG. 20 is a flow chart that show an example of a process 2000. In general, the process 2000 is the example process 1900 at various stages of a pipeline operation, according to at least one implementation of the present disclosure.

At a stage 2020-1, step 1910 is performed, followed by steps 1920-1940. The weights loaded during step 1910 remain loaded and are reused during subsequent stages of the process 2000. Once step 1920 of stage 2020-1 has completed, step 1920 is performed again in stage 2020-2 while step 1930 is performed in stage 2020-1. As such, step 1920 of stage 2020-2 is performed substantially in parallel (timewise) with the step 1930 of stage 2020-1. Once step 1930 of stage 2020-1 has completed, step 1930 is performed again in stage 2020-2 while step 1940 is performed in stage 2020-1. As such, step 1930 of stage 2020-2 is performed substantially in parallel (timewise) with the step 1940 of stage 2020-1.

This pipeline (e.g., cascade, waterfall) pattern of operations continues “n” times until a stage 2020-n is performed. In some implementations, each of the stages 2020-1 to 2020-n can represent a separate thread block that can be executed in at least partly in parallel with the other thread blocks. In some implementations, various ones of the stages 2020-1 to 2020-n can be performed by different compute nodes such as the compute nodes 610a-610d.

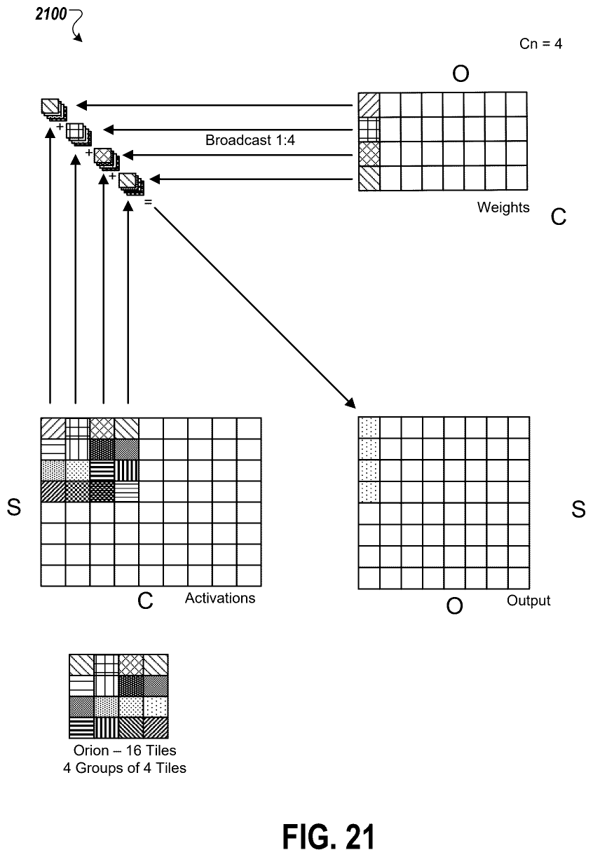

FIG. 21 is a conceptual illustration of an example computerized matrix multiplication operation 2100. In the context of the systems described herein, the operation 2100 is performed by dividing the matmul operation into four partial accumulations, with each accumulation running a separate compute node, such as the example compute nodes 610a-610d.

The operations can be pipelined over S or O. In some implementations, each weights slick can be loaded once and can then be pipelined over S. In some implementations, each activation slice can be loaded once and can then be pipelined over O. In some implementations, a reduction over 4 tiles can be performed for every pipeline stage, and weights can be broadcast between groups.

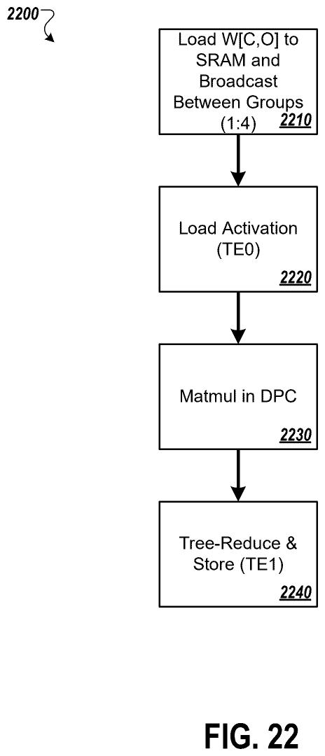

FIG. 22 shows an example of a process 2200 for another computerized matrix multiplication operation, according to at least one implementation of the present disclosure. In some implementations, the process 2200 can be performed by all or part of the example memory network system 600 of FIG. 6.

At 2210, [[W[C,O]]] is loaded to on-chip memory, such as the on-chip memories 616a-616d, and broadcast between groups. In some implementations, the broadcast can be a 1:4 broadcast. In some implementations, the broadcast can be performed using one or more of the photonic links 630a-630d.

At 2220, activations are loaded by a first tensor engine (TE0). For example, the activations can be loaded to and from the on-chip memory 616a, over the photonic links 630a-630d if the activations are not already in a local on-chip memory.

At 2230, a matrix multiplication (matmul) operation is performed in DPC.

At 2240, the results of the matmul are tree-reduced and stored by a second tensor engine (TE1). In the illustrated example, the reduction is a 4:1 reduction.

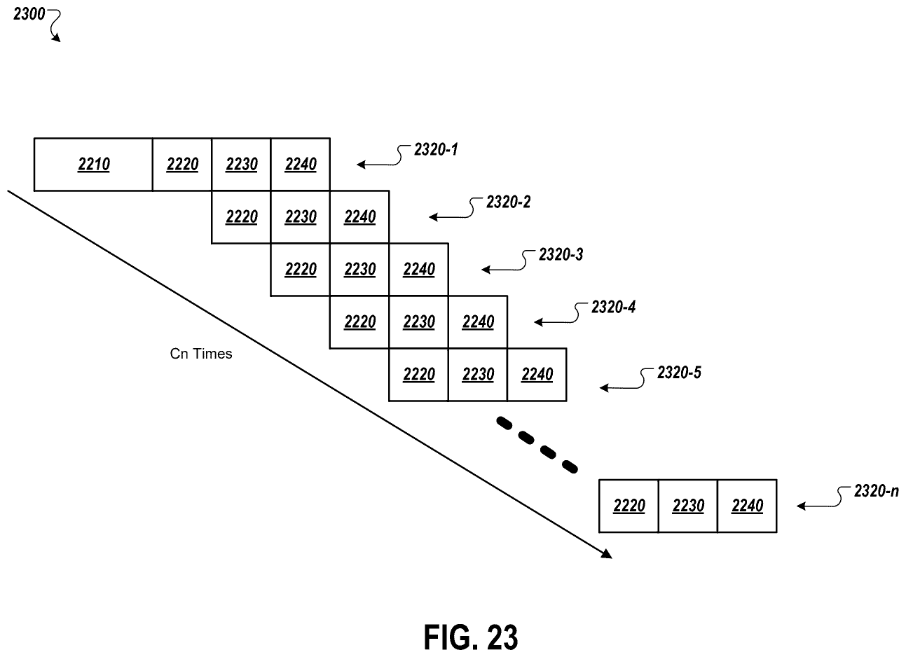

FIG. 23 is a flow chart that show an example of a process 2300. In general, the process 2300 is the example process 2200 at various stages of a pipeline operation, according to at least one implementation of the present disclosure.

At a stage 2320-1, step 2210 is performed, followed by steps 2220-2240. The weights loaded during step 2210 remain loaded and are reused during subsequent stages of the process 2300. Once step 2220 of stage 2320-1 has completed, step 2220 is performed again in stage 2320-2 while step 2230 is performed in stage 2320-1. As such, step 2220 of stage 2320-2 is performed substantially in parallel (timewise) with the step 2230 of stage 2320-1. Once step 2230 of stage 2320-1 has completed, step 2230 is performed again in stage 2320-2 while step 2240 is performed in stage 2320-1. As such, step 2230 of stage 2320-2 is performed substantially in parallel (timewise) with the step 2240 of stage 2320-1.

This pipeline (e.g., cascade, waterfall) pattern of operations continues “n” times until a stage 2320-n is performed. In some implementations, each of the stages 2320-1 to 2320-n can represent a separate thread block that can be executed in at least partly in parallel with the other thread blocks. In some implementations, various ones of the stages 2320-1 to 2320-n can be performed by different compute nodes such as the compute nodes 610a-610d.

The following disclosure describes a load/store unit (LDSU) as well as example machine-learning (ML) accelerators that can take advantage of the benefits provided by the LDSU. In some implementations, the LDSU is configured for operation with a tensor engine.

As shown in FIG. 24, a memory 2450 can have a plurality of tensors 2400, 2402, 2404, and 2406. A tensor is an n-dimensional array of items, where each of the items are of a primitive data type 2465. Each of the tensors 2400-2406 can have a different number of dimensions and/or primitive data types 2465. The primitive data type 2465 can vary depending on the system that processes tensors 2400-2406 and the type of tensors. The primitive data type 2465 can also be hard coded into a system that only processes a certain type of tensor with a fixed data type. In some implementations, primitive data type 2465 (e.g., item type) can include, but is not limited to, various bit lengths representing integers, floating point numbers, or boolean values. Examples include bits, bytes, integers, words, boolean values, (brain floating-point) BF-16, or FP-32, and the like.

Tensor engine 2420 includes register bank 2440 and compute elements 2470. Compute elements 2470 are configured to perform one or more mathematical operations on the data obtained from register bank 2440 and optionally write the results back to register bank 2440. LDSU 2411 includes an access module 2430. In operation, the LDSU 2411 uses the access module 2430 to read the tensor 2400 from the memory 2450 and to write the tensor 2400 to the register bank 2440. Alternatively, although not shown explicitly in FIG. 24, the LDSU 2411 uses the access module 2430 to read the tensor 2400 from the register bank 2440 and to write the tensor 2400 to the memory 2450.

LDSU 2411 includes a loop tracking module 2492 (e.g., an iteration tracking module), an index tracking module 2493, an addressing module 2494, a walking module 2495, a striding module 2496, and a layout module 2497. The modules 2492-2497 can be implemented in hardware, software, firmware, or any applicable combination of these elements. The tensor 2400 can be obtained by walking through each data element of data type 2465 in the tensor 2400 using one or more of the modules 2492-2497. LDSU 2411 walks through tensor 2400 using a memory 2490 which can be loaded in advance of the processing tensor 2400, either from a compiler, a host, or any applicable form of input capable of setting up memory 2490 in advance of execution. The memory can be updated when each item from tensor 2400 is accessed by the LDSU 2411. In one implementation, when the LDSU 2411 is moved to the next position in tensor 2400 an effective address (e.g., in a memory region) for the next item is computed which can be used by the access module 2430 to read the next item from memory 2450 or register bank 2440.

Memory 2490 can include one or more registers. At least some of the registers correspond to a first counter for the number of items in tensor 2400 and a second counter for the number of items in each of a plurality of dimensions of tensor 2400 (e.g., the size of the arrays for C, H, and W). In one implementation, the first counter is set to the number of items in tensor 2400 and for each step, the counter is decremented until it reaches zero, at which time the system knows it has reached the end of tensor 2400. Other implementations for the first counter are possible as well. The second counter can be set as indices for each dimension of tensor 2400, such that for each step the second counter can be used to determine whether the next step in tensor 2400 is in the current dimension, or whether the last item in the current dimension has been reached and the next stride is in the next axis of tensor 2400 that needs to be traversed. In one implementation, the first counter can be determined by taking the indices for each dimension representing the number of items in each dimension and taking the product of all of the values.

The loop tracking module 2492 can access one or more registers to determine when the end of the tensor has been reached. The index tracking module 2493 can access one or more registers for each dimension of the tensor to determine if it is the end of the tensor or the last element in a dimension. After the LDSU 2411 moves to the next item, the loop tracking module 2492 and the index tracking module 2493 update, decrement, increment, and/or otherwise modify the registers.

Addressing module 2494 can be used to determine the effective address for the next item in the tensor each time the LDSU 2411 moves to the next item. In the implementation where memory 2450 has a plurality of registers, the addressing module 2494 uses a base register and one or more offset registers to provide the effective address (e.g., in a memory region) to the access module 2430. The base register can have a value that corresponds to the memory location (e.g., memory region) where the first bit of the first item in the tensor resides, either in memory 2450 or register bank 2440.

Striding module 2496 can be used to determine the stride in each of the dimensions of tensor 2400. The stride values can be stored in memory 2490 in a stride register for each dimension, for example. In one implementation, a compiler, host, or other process loads the stride registers in advance of processing a tensor. At each step in the processing of the tensor, the striding module 2496 updates the appropriate stride registers to correspond to the next position of the LDSU 2411.

Walking module 2495 can be used to move the LDSU 2411 to the next item in tensor 2400 so that the access module 2430 can obtain (load or store) the next item from either memory 2450 or register bank 2440. In one implementation, memory 2490 includes a plurality of offset registers, at least one for each dimension of tensor 2400. To obtain the next item in tensor 2400 and/or to move the LDSU 2411 to the next position, the current values in the offset registers are added together. In one implementation, additional LDSUs 2411B and additional tensor engines 2420B are used such that each of tensors 2402, 2404, and 2406 have their own LDSU and tensor engine that can operate in parallel with LDSU 2411 and tensor engine 2420. In some implementations, a layout module 2497 can be used which makes the manner and/or order in which tensor walking module 2495 walks through tensor 2400 configurable. The order can be set at compile time in advance of the processing tensor 2400, either from a compiler, a host, or any applicable form of input capable of setting up memory 2490 and/or providing input and output to the layout module 2497. In implementations where registers are used for each dimension of the tensor, the registers can form a 2-dimensional array where the layout module 2455 selects each row for processing in the order specified by the layout and the tensor is processed accordingly.

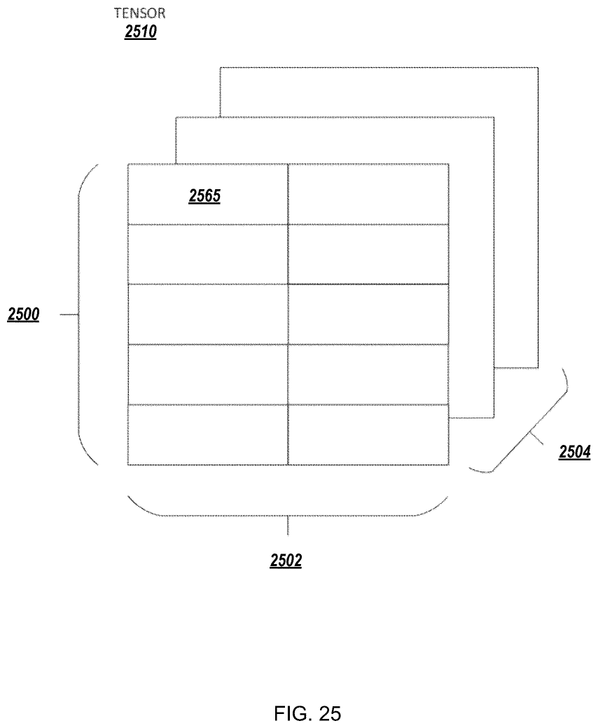

FIG. 25 is a diagram that illustrates a prior art three-dimensional tensor walking process. Tensor 2510 is shown as being three-dimensional having dimensions of height (H) 2500, width (W) 2502, and depth (C) 2504, also called channel. Tensor 2510 is made up of elements of primitive data type 2565. Tensor 2510 is shown as having a height of 5, a width of 2, and a channel size of 5. In other examples, any number of height, width, and channel sizes can be used as well as an arbitrary number of dimensions. To walk the 3-dimensional tensor 2510 using a prior art scheme, three nested loops are required. For example, the following pseudo-code could be applied to tensor 2510, if processed in C, H, W order.

```
for (C = 0; C < 5; C++);
{
  for (H = 0; H < 5; H++);
  {
    for (W=0; W < 2; W++);
    {
      // find effective address
      // load or store next item of tensor 2510;
  }
  }
}
```

Using three nested loops to process tensor 2510 is inefficient for use in an ML accelerator. The computation to find the effective address occurs at every step of the loop as well as pointer math with array indices. The size and amount of tensors that are typically processed coupled with the number of inefficient operations makes the prior art tensor engine of FIG. 25 inadequate for modern applications such as DLRM, machine vision, and the like. As will be understood by someone having ordinary skill in the art, and in the subsequent description, various implementations the use LDSUs are capable of processing n-dimensional tensors without any nested loop structure and the associated drawbacks therewith.

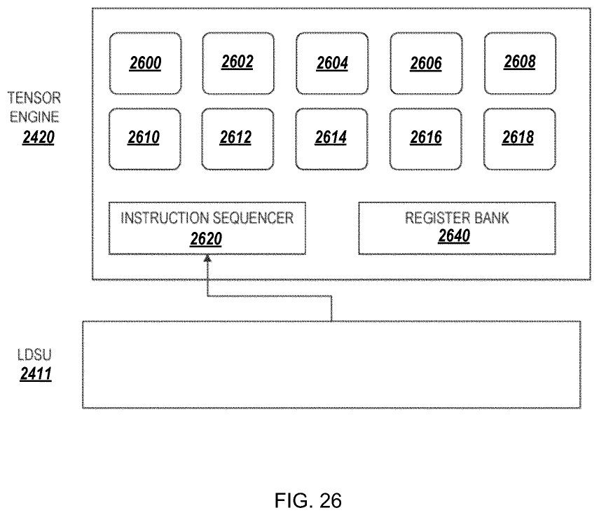

FIG. 26 shows an overview of one implementation of a tensor engine 2420 with an LDSU 2411. Each tensor engine in a system may be assigned to perform a portion of, for example, inference calculations for the specific machine learning model being used by an ML processor. Tensor engines in different nodes (not shown) in an ML processor can perform the machine learning tasks in parallel or in sequence. Machine learning computations of ML processor may be performed in one or more tensor engines, forming a data flow between the LDSUs and the tensor engines. Various implementations for the tensor engine 2420 can be used without departing from the scope of the present application. The current implementation includes LDSU 2411, an instruction sequencer 2620, a register bank 2440, and compute elements 2600, 2602, 2604, 2606, 2608, 2610, 2612, 2614, 2616, and 2618. Other implementations can have other configurations and can have any number of compute elements.

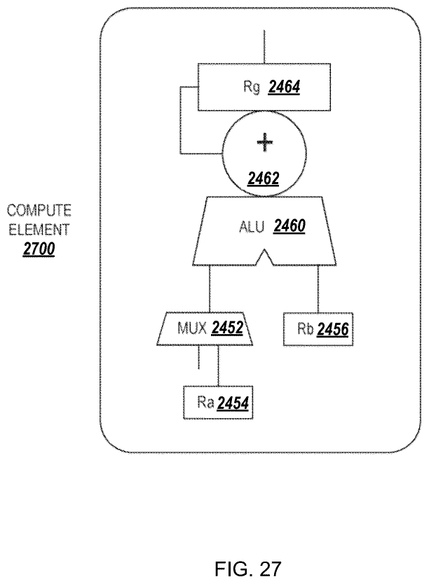

One example of a compute element 2700 is shown in FIG. 27. FIG. 27 can correspond to the structure of compute elements 2600-2618 not specifically shown in FIG. 26, although that is not required. Compute element 2700 includes multiplexers 2452, Ra registers 2454, Rb registers 2456, arithmetic logic units (ALUs) 2460, adders 2462, and Rg registers 2464. Tensor engine 2420 uses instruction sequencer 2620 to perform register write, accumulate, and register read operations in a manner known in the art. For example, tensor engine 2420 may write two values to registers Ra 2454 and Rb 2456, accumulate them with the aid of ALU 2460, and save the result in register Rg 2464. Thereafter two more values are written into registers Ra 2454 and Rb 2456, are accumulated with the aid of ALU 2460, read from ALU 2460 and added to the previous content in register Rg 2464 and written into register Rg 2464. This routine may repeat again, for example, up to 32 times to generate a 32-bit output from each output register of the tensor engine 2420. In one implementation, tensor engine 2420 is a single-instruction, multiple data processor using an instruction set purpose-designed for execution of machine learning algorithms.

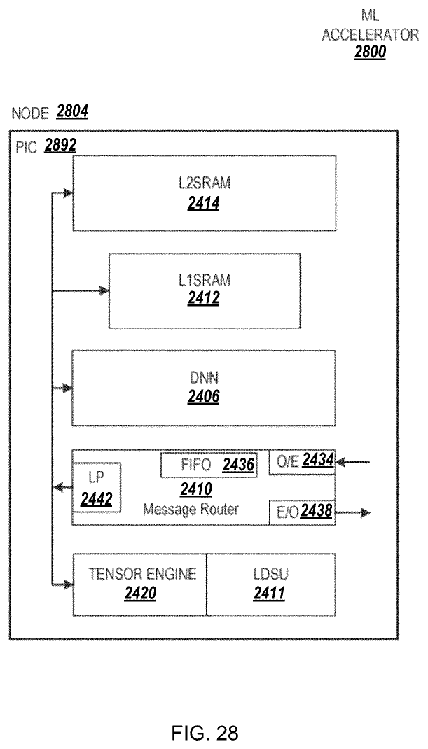

As shown in FIG. 28, a top-view of a node 2804 that resides in ML accelerator 2800 is shown according to one implementation. In one implementation, DNN 2406 is implemented in electronic form and resides within an ASIC 2888. DNN 2406 can perform, for example, multiply-accumulate operations to execute either a convolution function or a dot product function as required by neural networks of the ML accelerator 2800. The node 2804 includes an LDSU 2411, tensor engine 2420, message router 2410, level one static random-access memory (L1SRAM) 2412, and level two static random-access memory (L2SRAM) 2414. L1SRAM 2412 can serve as scratchpad memory for each node 2404, while L2SRAM 2414 functions as the primary memory for each node and stores the weights of a machine learning model in close physical proximity to DNN 2406 and tensor engine 2420, and also stores any intermediate results required to execute the machine learning model. In one implementation, the L1SRAM 2412 is optional. Weights are used in each layer of a neural network within each ML processor in, for example, inference calculations, each layer being typically implemented by several nodes in ML processor.

Activations from an originating node in ML processor or from an originating node in another ML processor in the ML accelerator 2800 are streamed into a destination node in the ML processor. DNN 2406 and tensor engine 2420 perform computations on the streamed activations using the weights stored in L2SRAM 2414. By pre-loading weights into L2SRAM 2414 of each node 2804, ML models (also referred to as execution graphs) are pre-loaded in each ML processor of the ML accelerator 2800.

In general, a machine learning model is distributed onto one or more nodes where each node might execute several neurons. In the implementation of FIG. 28, activations flowing between neurons in the same node are exchanged via memory whereas activations that move between nodes can utilize PIC 2892 and be placed in the memory of the destination node. Input activations stream to nodes that are allocated to each neuron of the ML model (or each node of execution graph). Output activations, (i.e., results of computations using input activations and the pre-loaded weights), are transmitted in part using PIC 2892 to the next node in the same ML processor or another ML processor.

In the implementation of FIG. 28, although not required for other implementations, a message containing the packet data arrives through a photonic network situated on the PIC 2892 and is received at the optical/electrical interface 2434, which can be for example a photo diode and related circuit. The message can then be buffered in electronic form in a register such as FIFO 136 (“first in first out” register). An address contained in the message header is then examined by electronic message router 2410, and the electronic message router determines which port and which destination the message should be routed to. For example, the message can be routed to a destination tile through electrical/optical interface 2438, which can be for example a driver for an optical modulator. Examples of applicable modulator technology include EAM (“electro-absorptive modulator” or “electro-absorption modulator”), MZI (“Mach Zender Interferometer”), Ring modulator, and QCSE EAM (“Quantum Confined Stark Effect electro-absorptive modulator”). In this example, the message is routed to the destination determined by electronic message router 2410 using an optical path situated on the PIC 2892. As another example, the electronic message router 2410 may determine that the destination of the message is L1SRAM 2412, L2SRAM 2414, DNN 2406 or tensor engine 2420. In that case, the message would be routed to local port 2442.

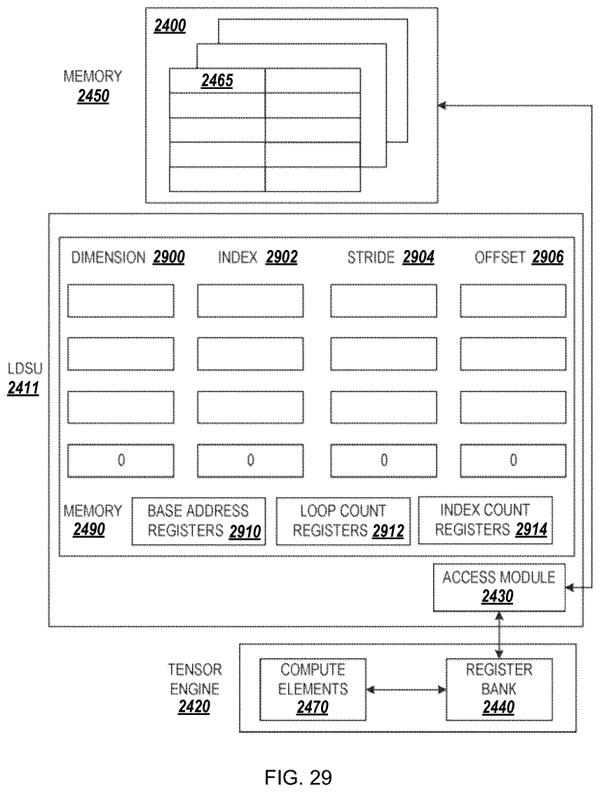

FIGS. 29-34 are block diagrams illustrating details of the operation of an LDSU according to one implementation.

As shown in FIG. 29, LDSU 2411 includes a memory 2490. The memory includes registers for dimension 2900, index 2902, stride 2904, and offset 2906. In the current implementation, each column of registers 2900-2906 has four rows. Any number of rows can be used. In the current implementation, tensor 2400 has three dimensions so only 3 rows of registers 2900-2906 are needed, so the fourth row of registers is loaded with zeroes and remains in that state while tensor 2400 is being processed. If subsequently a 4-dimensional tensor was processed, then the fourth row of the registers could be used. In addition, memory 2490 also has a base address register 2910. The value loaded into the base address register 2910 corresponds to the memory address in memory 2450, which is the first bit of the first item of tensor 2400. Memory 2490 also includes an item counting register 2912 and an index counting register 2914. In the current implementation, the item counter 2912 is loaded with the product of the size of the three dimensions in the tensor, in this case (2×5×3). The item counter can be decremented whenever the LDSU 2411 moves to the next item, for example, in order to track when the last item of tensor 2400 is reached. The index counting register 2914 is associated with the index column of registers 2902. The index counting register 2914 can be modified whenever the LDSU 2411 moves to the next item and compared to the size of the current dimension, for example, in order to track when the next stride needs to account for the stride in the next axis of the tensor that is to be traversed.

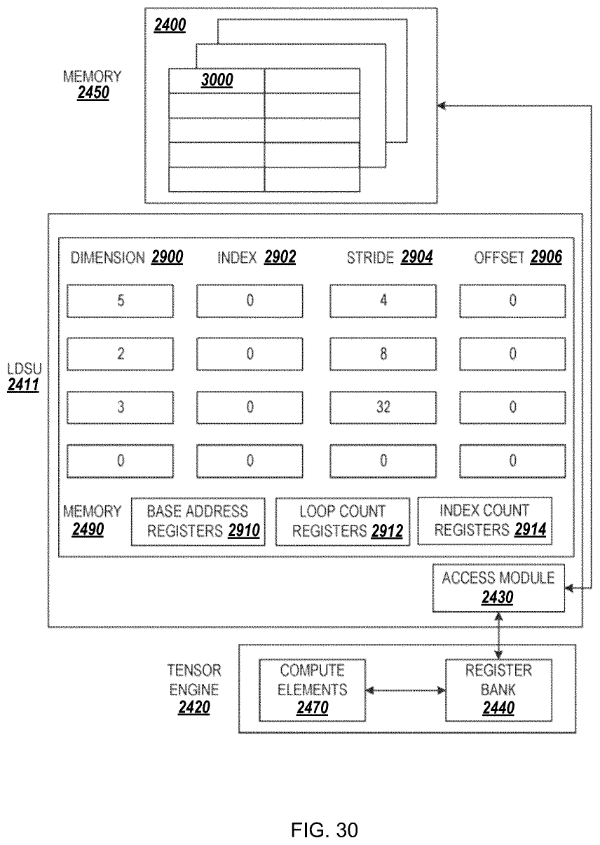

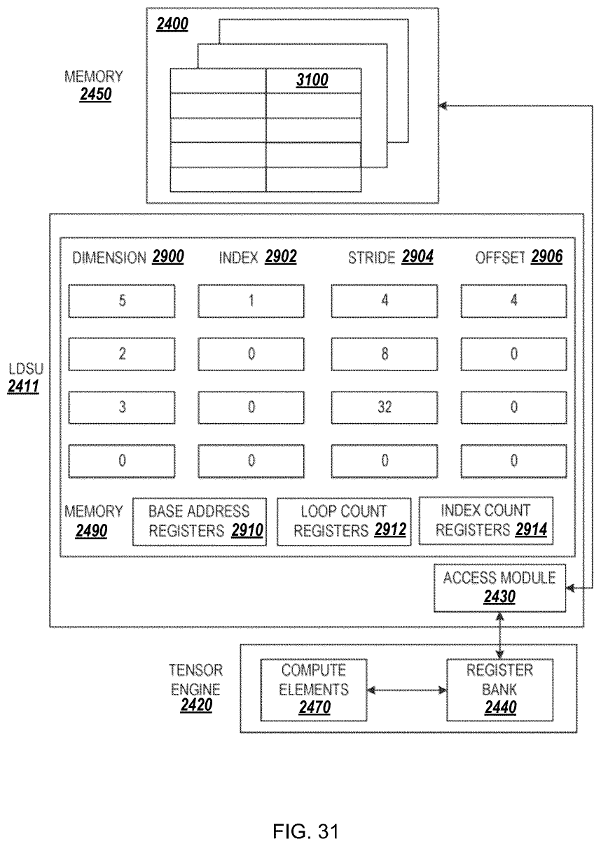

As shown in FIG. 30, the dimension column of registers 2900 is loaded with values from a compiler or host. The values represent the number of items in each axis of tensor 2400. In the current implementation, tensor 2400 has a height of 5, a width of 2, and a channel dimension of 3. A first item counting register 2912 can be set to the product of each value in the dimension column of registers 2900. In one implementation, the product of these values can be stored in the loop counter register 2912 and decremented each time the LDSU 2411 is moved to the next position. The index column of registers 2902 is set to zero and the offset registers 2906 are also set to zero. This results in a first item of the tensor 3000 being fetched in memory 2450 at the address corresponding to the value stored in the base address register 2910 of the memory 2490 or otherwise determined by the addressing module 2494. Typically, the value in the base address register is a number that corresponds to a memory address in memory 2450 (e.g., in a memory region) and the initial item in tensor 2400 starts at this memory address. Thus, access module 2430 can fetch the first item using only the value in the base address register and loading the item at the memory location corresponding to that value. The stride column of registers 2904 is loaded with the stride values to allow the next portion of tensor 2400 to be fetched in the next iteration shown in FIG. 31.

FIG. 31 shows how memory 2490 is modified in order to move LDSU 2411 to the next position so item 3100 can be obtained, loaded, stored, read, written, and/or otherwise accessed in memory 2450 or register bank 2440. At this step, the index tracking module 2493 can set the first row of the index column of register to 1. The striding module 2496 is called which sets the first-row register in the offset column 2906 to 4. This can cause tensor walking module 2495 to move the LDSU 2411 to the next position corresponding to the new offset value in the first row of the offset column of registers 2906. Thereafter, an effective address can be obtained by the addressing module 2494 using the new offset value in the first row of the offset column of registers 2906 and adding it to the value in the base address register yielding the location of the first bit of item 3100 in the memory 2450. Thereafter, the loop count registers 2912 can be modified, for example by the loop tracking module 2492, so the system can track when the last item of the tensor 2400 has been reached. This operation can occur, for example, each time a next item in tensor 2400 is obtained and/or each time the LDSU 2411 is moved to a next position.

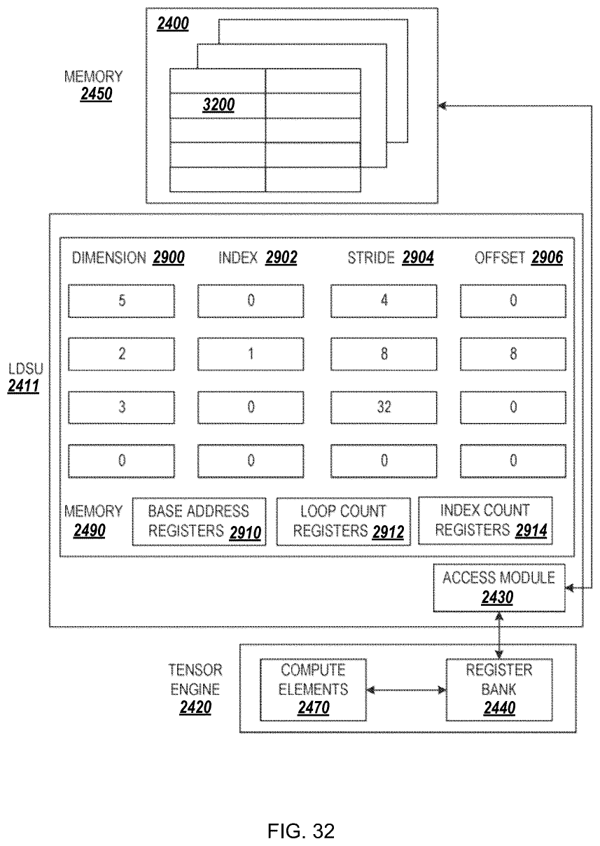

FIG. 32 shows how memory 2490 is modified in order to move LDSU 2411 to the next position so item 3200 can be obtained, loaded, stored, read, written, and/or otherwise accessed in memory 2450 or register bank 2440. At this step, the index tracking module 2493 can set the second row of the index column of registers 2902 to 1 and the first row of the index column of registers 2902 to 0. The striding module 2496 is called which sets the second-row register in the offset column 2906 to 8 and the first-row register in the offset column 2906 to 0. This an cause tensor walking module 2495 to move the LDSU 2411 to the next position corresponding to the new offset value (which is obtained by adding the values in the first-row and second-row registers of the offset column of registers 2906. Thereafter, an effective address can be obtained by the addressing module 2494 using the new offset value in the first and second rows of the offset column of registers 2906 and adding it to the value in the base address register yielding the location of the first bit of item 3200 in the memory 2450. In operation, a second counting module or counter, such as index counting register 2914 can be used to determine when a last item in any given dimension of tensor 2400 is reached. For example, in FIG. 32, the second counter can be used to ensure that the dimension value in any of the registers in the dimension column of registers 2900 is always larger than the index value in any of the registers in the index column of registers 2902 in the same row. Once the index value equals the dimension value in the registers, the system determines that the last item in the dimension has been reached. In response, the index for the current dimension is modified and/or set to zero and the next dimension or row in the index column or registers 2902 is incremented. Moreover, the stride in the next dimension is determined such that the stride for the next item 3200 accounts for the stride in the next dimension.

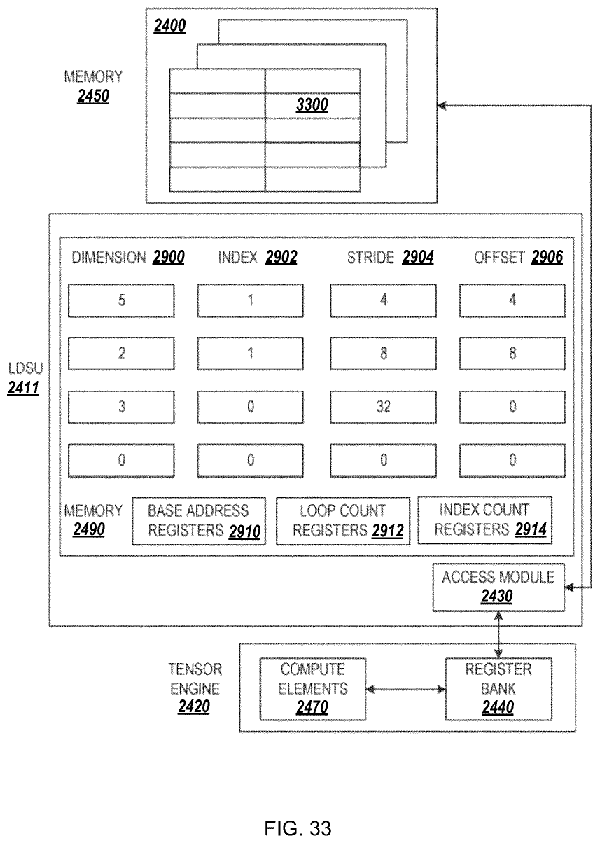

FIG. 33 shows how memory 2490 is modified in order to move LDSU 2411 to the next position so item 3300 can be obtained, loaded, stored, read, written, and/or otherwise accessed in memory 2450 or register bank 2440. At this step, index tracking module 2493 can set the first row of the index column of registers 2902 to 1. The striding module 2496 is called which sets the first-row register in the offset column 2906 to 4. This can cause tensor walking module 2495 to move the LDSU 2411 to the next position corresponding to the new offset value (which is obtained by adding the values in the first-row and second-row registers of the offset column of registers 2906). Thereafter, an effective address can be obtained by the addressing module 2494 using the new offset value in the first and second rows of the offset column of registers 2906 and adding it to the value in the base address register yielding the location of the first bit of item 3300 in the memory 2450.

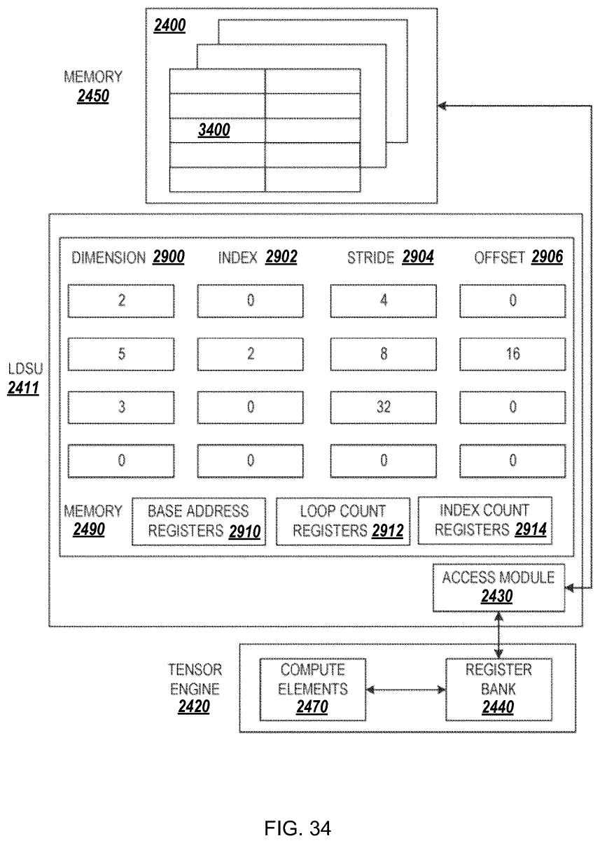

FIG. 34 shows how memory 2490 is modified in order to move LDSU 2411 to the next position so item 24100 can be obtained, loaded, stored, read, written, and/or otherwise accessed in memory 2450 or register bank 2440. At this step, index tracking module 2493 can set the first row of the index column of registers 2902 to 0 and the second row of the index column of registers 2902 to 2. The striding module 2496 is called which sets the first-row register in the offset column 2906 to 0 and the second-row register in the offset column 2906 to 16. This can cause tensor walking module 2495 to move the LDSU 2411 to the next position corresponding to the new offset value (which is obtained by adding the values in the first-row and second-row registers of the offset column of registers 2906). Thereafter, an effective address can be obtained by the addressing module 2494 using the new offset value in the first and second rows of the offset column of registers 2906 and adding it to the value in the base address register yielding the location of the first bit of item 3300 in the memory 2450.

The process repeats over an arbitrary height, width, channel, and any additional dimensions of any tensor the system walks. Moreover, the system can support any number of tensors and any arbitrary size for the primitive data elements from one bit to BFP-32, for example. Furthermore, the registers in memory 2490 of LDSU 2411 can be laid out, by a compiler, for example, such that user or the input data is capable of determining the order that the dimensions are walked. In one implementation, the height dimension can be walked first, and in another implementation the channel dimension can be walked first, for example. This could provide advantages and/or optimizations for different types of input data sets when used by a system that takes advantage of a tensor engine with LDSU 2411. In one implementation, a layout module 2455 can be used which can receive input from the compiler, a user interface, or other system to enable the rows in memory 2490 to be traversed in an arbitrary order. It should also be noted that anywhere the present disclosure describes a tensor being obtained from a memory, various implementations could also obtain the tensor from a register bank in the tensor engine itself, or elsewhere. Moreover, when an effective address is determined, it can be used to load or store a tensor at the determined address.

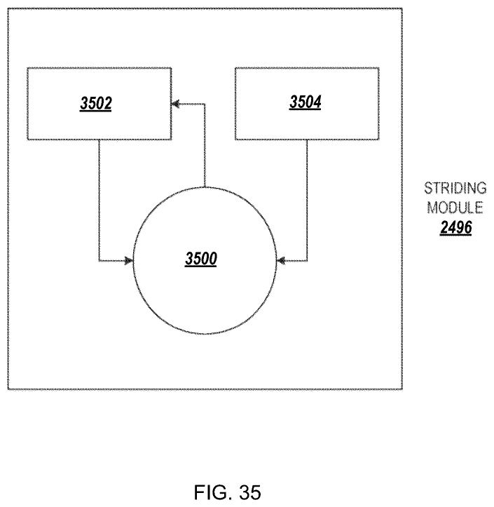

FIG. 35 is a block diagram illustrating details of striding module 2496 according to one implementation. Offset register 3502 and stride register 3504 represent an arbitrary row of registers in memory 2490 of the LDSU 2411. An adder 3500 can be used to add the current offset with the stride each time the LDSU 2411 moves to the next position.

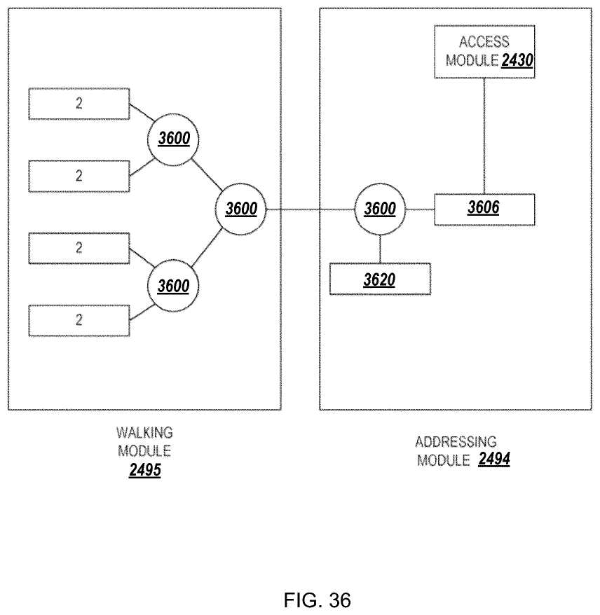

FIG. 36 is a block diagram illustrating details of the tensor walking module 2495 and the addressing module 2494 according to one implementation. An offset column of registers 3610 in the tensor walking module 2495 has current offset values for each dimension of a tensor that is being walked. Adders 3600, 3601, and 3602 are used in this implementation to combine 4 dimensions together and sum them with a value in a base address register 3620 using adder 3603 in the addressing module 2494. The result is placed in an effective address register 3606. The values stored in the effective address register 3606 can be used by the access module 2430 to obtain, load, store, read, write, and/or otherwise access either memory 2450 or register bank 2440 to obtain an item in an n-dimensional tensor.

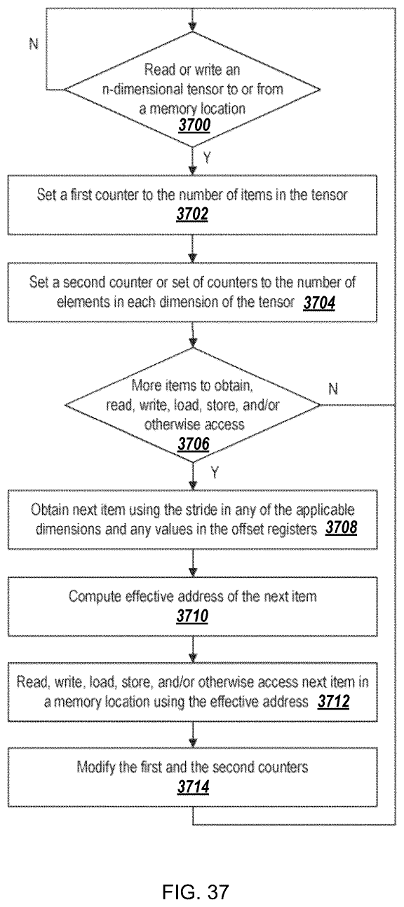

FIG. 37 is a flowchart illustrating the operation of a tensor engine with an LDSU according to one implementation. At operation 3700, a system, such as an ML accelerator, a general-purpose computing device, or other execution environment determines it needs to read or write an n-dimensional tensor to or from a memory location. At operation 3702, a first counter, such as an item counter, a loop counter, or other variable is set to the number of items in the tensor. This could occur, for example, by taking the product of the number of elements in each dimension of the tensor and storing it in a register. At operation 3704, a second counter, or set of counters, such as an index counter or register, is set to the number of elements in each dimension of the tensor. This could be stored in a plurality of registers in the memory of the LDSU, with at least one register for each dimension of the tensor to store the number of items and current index position in the current dimension, so it can be compared against the number of elements in the dimension. For example, when the number of elements equals the current index position, a system can determine it has reached the last item in a given dimension.

When there are more items at operation 3706 to obtain, read, write, load, store, and/or otherwise access, the tensor can be walked as follows. The next item is obtained at operation 1408 using the stride in any of the applicable dimensions and any values in the offset registers. One implementation uses a striding module for each axis of the tensor that is being traversed, which enables the system to update offset registers every time the LDSU is moved without needing any nested loop operations. At operation 3710, the effective address of the next item is computed. An address module can be used to add a value in a base register with the current offset values summed from a tensor walking module 2495, for instance. At operation 3712, the next item is read, written, loaded, stored, and/or otherwise accessed in a memory location using the effective address. Thereafter, at operation 3714, the first and the second counters are modified.

When there are no more items at operation 3706, the last item in the tensor was reached. Control can return to the main system, ML accelerator, computing device, or other process at operation 3700 that called the LDSU functionality and/or otherwise needed to process a tensor. Operation 3700 repeats until the LDSU functionality needs to be called again and operation 3700 becomes true.

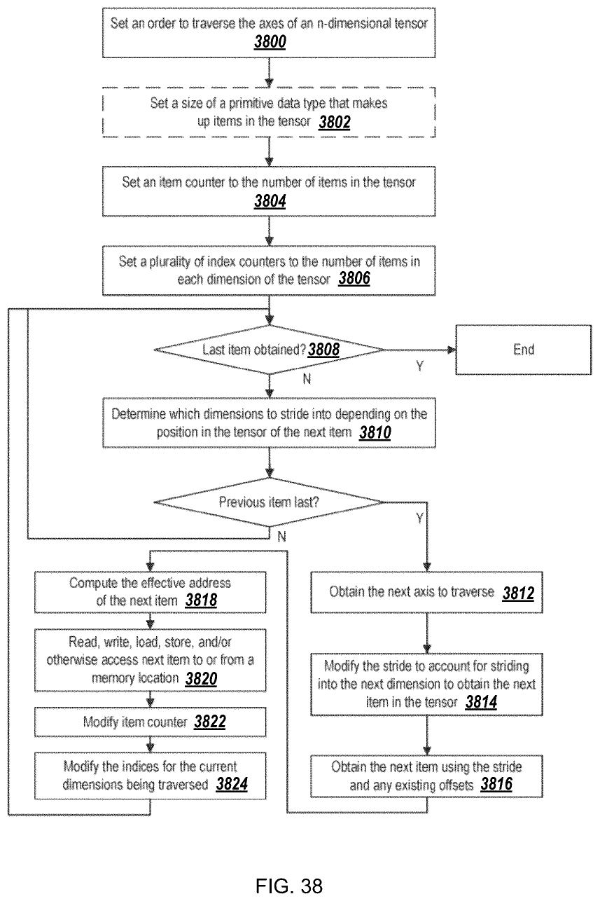

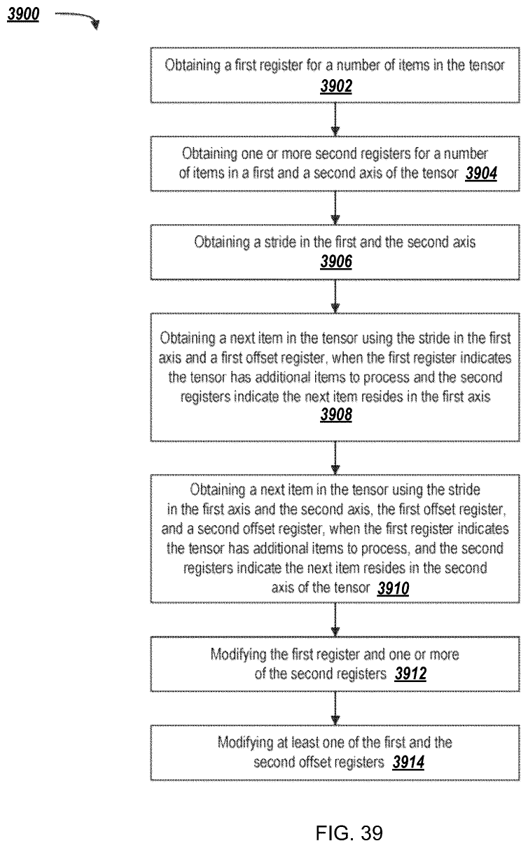

FIG. 38 is a flowchart illustrating the operation of a tensor walking module according to one implementation. At operation 3800, an order to traverse the axes of an n-dimensional tensor is set. At operation 3802, an optional operation of setting a size of a primitive data type that makes up items in the tensor. At operation 3804, an item counter is set to the number of items in the tensor. At operation 3806, a collection of index counters are set to the number of items in each dimension of the tensor. The tensor can be processed one item at a time, in a deterministic fashion, until the last item is obtained. When the last item is obtained at operation 3808, the process ends. Otherwise, there are more items in the tensor, so at operation 3810 the system determines which dimensions to stride into depending on the position in the tensor of the next item. If the previous item was the last item in the current axis at operation 3810, then the next axis to traverse is obtained at operation 3812. At operation 3814, the stride is modified to account for striding into the next dimension to obtain the next item in the tensor.

Thereafter, or if the current item was not the last item at operation 3810, the next item is obtained using the stride and any existing offsets at operation 3816. At operation 3818, the effective address of the next item is computed. At operation 3820, the next item is read, written, loaded, stored, and/or otherwise accessed to or from a memory location such as a memory or a register bank. At operation 3822, the item counter is modified. At operation 3824, the indices for the current dimensions being traversed are modified. The process repeats at operation 3808 until the last item in the tensor is processed.

FIG. 16 is a flowchart illustrating the operation of a method 3900 for processing a tensor. At operation 3902, a first register is obtained for a number of items in the tensor. At operation 3904, one or more second registers are obtained for a number of items in a first and a second axis of the tensor. At operation 3906, a stride is obtained in the first and the second axis. At operation 3908, a next item in the tensor is obtained using the stride in the first axis and a first offset register, when the first register indicates the tensor has additional items to process and the second registers indicate the next item resides in the first axis. At operation 3910, a next item in the tensor is obtained using the stride in the first axis and the second axis, the first offset register, and a second offset register, when the first register indicates the tensor has additional items to process, and the second registers indicate the next item resides in the second axis of the tensor. At operation 3912, the first register and one or more of the second registers is modified. At operation 3914, at least one of the first and the second offset registers is modified.

The following numbered examples provide illustrative embodiments.
Example 1 is a data processing apparatus comprising a first processor node comprising a first processor circuit, a first memory switch in electrical communication with the first processor circuit, and a first on-chip memory in electrical communication with the first memory switch, a first photonic transceiver in electrical communication with the first memory switch in parallel with the first processor circuit and in photonic communication with a photonic link, a second processor node comprising a second processor circuit, a second memory switch in electrical communication with the second processor circuit, and a second on-chip memory in electrical communication with the second processor circuit, and a second photonic transceiver in electrical communication with the second memory switch in parallel with the second processor circuit and in photonic communication with the photonic link.
Example 2 is the data processing apparatus of example 1, wherein the photonic link is a bidirectional photonic link.
Example 3 is the data processing apparatus of example 1 or 2, wherein the photonic link comprises an optical waveguide.
Example 4 is the data processing apparatus of any one of examples 1-3, further comprising a first electronic integrated circuit comprising the first processor node, a second electronic integrated circuit comprising the second processor node, a first photonic integrated circuit comprising the first photonic transceiver, and a second photonic integrated circuit comprising the second photonic transceiver.
Example 5 is the data processing apparatus of example 4, wherein the photonic link is optically coupled to the first photonic integrated circuit and the second photonic integrated circuit.
Example 6 is the data processing apparatus of any one of examples 1-5, further comprising a non-transitory computer storage medium encoded with a computer program, the computer program comprising instructions that when executed by data processing apparatus cause the data processing apparatus to perform operations comprising receiving, by the first photonic transceiver, data from the first on-chip memory, transmitting, by the first photonic transceiver over the photonic link, the data to the second photonic transceiver, receiving, by the second photonic transceiver from the photonic link, the data, and storing, the data in the second on-chip memory.
Example 7 is the data processing apparatus of any one of examples 1-6, wherein at least one of the first on-chip memory and the second on-chip memory comprise static random-access memory (SRAM) circuitry.
Example 8 is the data processing apparatus of any one of examples 1-7, wherein the first on-chip memory and the second on-chip memory are level 1 (L1) processor cache memories.
Example 9 is a method for processing data, the method comprising receiving, by a first memory switch of a first processor node, data from a first on-chip memory of the first processor node, wherein the first processor node comprises a first processor circuit, receiving, by a first photonic transceiver, the data from the first memory switch, wherein the first photonic transceiver is in electrical communication with the first memory switch in parallel with the first processor circuit, transmitting, by the first photonic transceiver, the data over a photonic link, receiving, by a second photonic transceiver, the data from the photonic link, transmitting, by the second photonic transceiver, the data to a second memory switch of a second processor node comprising a second processor circuit, wherein the second photonic transceiver is in electrical communication with the second memory switch in parallel with the second processor circuit, and storing, by the second memory switch, the data in a second on-chip memory of the second processor node.
Example 10 is the method of example 9, wherein the photonic link is a bidirectional photonic link.
Example 11 is the method of example 9 or 10, wherein the photonic link is an optical waveguide.
Example 12 is the method of any one of examples 9-11, wherein the photonic link is optically coupled to a first photonic integrated circuit comprising the first photonic transceiver and a second photonic integrated circuit comprising the second photonic transceiver.
Example 13 is the method of any one of examples 9-12, wherein a first electronic integrated circuit comprises the first processor node and a second electronic integrated circuit comprises the second processor node.
Example 14 is the method of any one of examples 9-13, wherein at least one of the first on-chip memory and the second on-chip memory comprise static random-access memory (SRAM) circuitry.
Example 15 is the method of any one of examples 9-14, wherein the first on-chip memory and the second on-chip memory are level 1 (L1) processor cache memories.
Example 16 is a method for processing data, the method comprising requesting, by a first processor circuit of a first processor node, data from a first on-chip memory of the first processor node, determining, by a first memory switch, that the requested data is at least partly not stored in the first on-chip memory, transmitting, by the first memory switch and in response to the determining, the requested data to a first photonic transceiver of the first processor node, wherein the first photonic transceiver is in electrical communication with the first memory switch in parallel with the first processor circuit, transmitting, by the first photonic transceiver, a memory request over a photonic link to a second photonic transceiver, receiving, by the second photonic transceiver, the memory request from the photonic link, requesting, by the second photonic transceiver and based on the memory request, the requested data from a second memory switch of a second processor node comprising a second processor circuit, wherein the second photonic transceiver is in electrical communication with the second memory switch in parallel with the second processor circuit, retrieving, by the second memory switch and based on the memory request, the requested data from a second on-chip memory of the second processor node, transmitting, by the second memory switch, the requested data, receiving, by the second photonic transceiver, the requested data, transmitting, by the second photonic transceiver, the retrieved data over the photonic link to the first photonic transceiver, receiving, by the first photonic transceiver, the retrieved data from the photonic link, transmitting, by the first photonic transceiver, the retrieved data to the first memory switch, and providing, by the first memory switch, the retrieved data as the requested data to the first processor circuit.
Example 17 is the method of example 16, wherein the photonic link is an optical waveguide.
Example 18 is the method of example 16 or 17, wherein the photonic link is optically coupled to a first photonic integrated circuit comprising the first photonic transceiver and a second photonic integrated circuit comprising the second photonic transceiver.
Example 19 is the method of any one of examples 16-18, wherein a first electronic integrated circuit comprises the first processor node and a second electronic integrated circuit comprises the second processor node.
Example 20 is the method of any one of examples 16-19, wherein at least one of the first on-chip memory and the second on-chip memory comprise static random-access memory (SRAM) circuitry.
Example 21 is the method of any one of examples 16-20, wherein the first on-chip memory and the second on-chip memory are level 1 (L1) processor cache memories.
Example 22 is a data processing apparatus comprising a first processor node comprising one or more first processor circuits, a first memory switch in electrical communication with the first processor circuit, a first on-chip memory in electrical communication with the first memory switch, and a first non-transitory memory, computer-readable medium storing one or more machine-readable instructions that, when executed, cause the one or more first processor circuits to perform first operations, a first photonic transceiver in electrical communication with the first memory switch in parallel with the first processor circuit and in photonic communication with a photonic link, a second processor node comprising one or more second processor circuits, a second memory switch in electrical communication with the second processor circuit, a second on-chip memory in electrical communication with the second processor circuit, and a second non-transitory memory, computer-readable medium storing one or more machine-readable instructions that, when executed, cause the one or more second processor circuits to perform second operations, and a second photonic transceiver in electrical communication with the second memory switch in parallel with the second processor circuit and in photonic communication with the photonic link, wherein the first operations and the second operations comprise performing a matrix multiplication operation in which operation data is transported between the first memory switch and the second memory switch over the photonic link.
Example 23 is the data processing apparatus of example 22, wherein performing a matrix multiplication operation in which operation data is transported between the first memory switch and the second memory switch over the photonic link comprises requesting, by a first processor circuit of a first processor node, data from a first on-chip memory of the first processor node, determining, by a first memory switch, that the requested data is at least partly not stored in the first on-chip memory, transmitting, by the first memory switch and in response to the determining, the requested data to a first photonic transceiver, wherein the first photonic transceiver is in electrical communication with the first memory switch in parallel with the first processor circuit, transmitting, by the first photonic transceiver of the first processor node, a memory request over a photonic link to a second photonic transceiver, receiving, by the second photonic transceiver, the memory request from the photonic link, requesting, by the second photonic transceiver and based on the memory request, the requested data from a second memory switch of a second processor node comprising a second processor circuit, wherein the second photonic transceiver is in electrical communication with the second memory switch in parallel with the second processor circuit, retrieving, by the second memory switch and based on the memory request, the requested data from the second on-chip memory of the second processor node, transmitting, by the second memory switch, the requested data, receiving, by the second photonic transceiver; the requested data, transmitting, by the second photonic transceiver, the retrieved data over the photonic link to the first photonic transceiver, receiving, by the first photonic transceiver, the retrieved data from the photonic link, transmitting, by the first photonic transceiver, the retrieved data to the first memory switch, and providing, by the first memory switch, the retrieved data as the requested data to the first processor circuit.
Example 24 is the data processing apparatus of example 22 or 23, wherein performing a matrix multiplication operation in which operation data is transported between the first memory switch and the second memory switch over the photonic link comprises receiving, by the first processor node, a first collection of data, performing multiplication operations on the first collection of data, storing, by the first processor node, first intermediate results of the multiplication operations in an accumulator partly comprising at least a portion of the first on-chip memory, receiving, by the second processor node, a second collection of data, performing multiplication operations on the second collection of data, and storing, by the second processor node, second intermediate results of the multiplication operations in the accumulator, the accumulator partly comprising at least a portion of the second on-chip memory, wherein the first on-chip memory and the second on-chip memory are communicatively connected by the photonic link.
Example 25 is the data processing apparatus of any one of examples 22-24, wherein the photonic link is a bidirectional photonic link.
Example 26 is the data processing apparatus of any one of examples 22-25, wherein the photonic link comprises an optical waveguide.
Example 27 is the data processing apparatus of any one of examples 22-26, further comprising a first electronic integrated circuit comprising the first processor node, a second electronic integrated circuit comprising the second processor node, a first photonic integrated circuit comprising the first photonic transceiver, and a second photonic integrated circuit comprising the second photonic transceiver.
Example 28 is the data processing apparatus of example 27, wherein the photonic link is optically coupled to the first photonic integrated circuit and the second photonic integrated circuit.
Example 29 is the data processing apparatus of any one of examples 22 to 28, further comprising a non-transitory computer storage medium encoded with a computer program, the computer program comprising instructions that when executed by data processing apparatus cause the data processing apparatus to perform operations comprising receiving, by the first photonic transceiver, data from the first on-chip memory, transmitting, by the first photonic transceiver over the photonic link, the data to the second photonic transceiver, receiving, by the second photonic transceiver from the photonic link, the data, and storing, the data in the second on-chip memory.
Example 30 is the data processing apparatus of any one of examples 22-29, wherein at least one of the first on-chip memory and the second on-chip memory comprise static random-access memory (SRAM) circuitry.
Example 31 is the data processing apparatus of any one of examples 22-30, wherein the first on-chip memory and the second on-chip memory are level 1 (L1) processor cache memories.
Example 32 is a method of performing a computerized matrix multiplication operation, the method comprising receiving, by a first compute node comprising a first on-chip memory, a first collection of data, performing multiplication operations on the first collection of data, storing, by the first compute node, first intermediate results of the multiplication operations in an accumulator partly comprising at least a portion of the first on-chip memory, receiving, by a second compute node comprising a second on-chip memory, a second collection of data, performing multiplication operations on the second collection of data, and storing, by the second compute node, second intermediate results of the multiplication operations in the accumulator, the accumulator partly comprising at least a portion of the second on-chip memory, wherein the first on-chip memory and the second on-chip memory are communicatively connected by one or more photonic links.
Example 33 is the method of example 32, wherein one or both of the first collection of data and the second collection of data are at least one of row data and column data.
Example 34 is the method of example 32 or 33, further comprising requesting, by a first compute node, first data from the first on-chip memory, determining, by a first memory switch, that the requested data is at least partly not stored in the first on-chip memory, transmitting, by the first memory switch and in response to the determining, the requested data to a first photonic transceiver, wherein the first photonic transceiver is in electrical communication with the first memory switch in parallel with the a first processor circuit of the first compute node, transmitting, by the first photonic transceiver of the first compute node, a memory request over one or more of the photonic links to a second photonic transceiver of the second compute node, receiving, by the second photonic transceiver, the memory request from the one or more photonic links, requesting, by the second photonic transceiver and based on the memory request, the requested data from a second memory switch of the second compute node, wherein the second compute node comprises a second processor circuit and the second photonic transceiver is in electrical communication with the second memory switch in parallel with the second processor circuit, retrieving, by the second memory switch and based on the memory request, the requested data from the second on-chip memory, transmitting, by the second memory switch, the requested data, receiving, by the second photonic transceiver; the requested data, transmitting, by the second photonic transceiver, the retrieved data over one or more of the photonic links to the first photonic transceiver, receiving, by the first photonic transceiver, the retrieved data from the one or more photonic links, transmitting, by the first photonic transceiver, the retrieved data to the first memory switch, and providing, by the first memory switch, the retrieved data as the requested data to the first processor circuit.
Example 35 is the method of any one of examples 32-34, wherein one or more of the photonic links is an optical waveguide.
Example 36 is the method of any one of examples 32-35, wherein one or more of the photonic links is optically coupled to a first photonic integrated circuit comprising a first photonic transceiver and second photonic integrated circuit comprising a second photonic transceiver.
Example 37 is the method of any one of examples 32-36, wherein a first electronic integrated circuit comprises the first compute node and a second electronic integrated circuit comprises the second compute node.
Example 38 is the method of any one of examples 32-37, wherein at least one of the first on-chip memory and the second on-chip memory comprise static random-access memory (SRAM) circuitry.
Example 39 is the method of any one of examples 32-38, wherein the first on-chip memory and the second on-chip memory are level 1 (L1) processor cache memories.

As discussed herein in detail, the present disclosure includes a number of practical applications having features described herein that provide benefits and/or solve problems associated with providing a multi-node computing system with sufficient memory, processing, bandwidth, and energy efficiency constraints for effective operation of AI and/or ML models. Some example benefits are discussed herein in connection with various features and functionalities provided by the computing system as described. It will be appreciated that benefits explicitly discussed in connection with one or more embodiments described herein are provided by way of example and are not intended to be an exhaustive list of all possible benefits of the computing system.

For example, the various circuit packages described herein and connections thereof may enable the construction of complex topologies of compute and memory nodes that can best serve a specific application. In a simple example, a set of photonic links connect memory circuit packages with memory nodes (e.g., memory resources) to one or more compute circuit packages with compute nodes. The compute circuit packages and memory circuit packages can be connected and configured in any number of network topologies which may be facilitated through the use of one or more photonic links include optical fibers. This may provide the benefit of relieving distance constraints between nodes (compute and/or memory) and, for example, the memory circuit packages can physically be placed arbitrarily far from the compute circuit packages (within the optical budget of the photonic links).

The various network topologies may provide significant speed and energy savings. For example, photonic transport of data is typically more efficient than an equivalent high-bandwidth electrical interconnect in an EIC of the circuit package itself. By implementing one or more photonic links, the electrical cost of transmitting data may be significantly reduced. Additionally, photonic links are typically much faster than electrical interconnects, and thus the use of photonic links permits the grouping and topology configurations of memory and compute circuit packages that best serve the bandwidth and connectivity needs of a given application. Indeed, the architectural split of memory and compute networks allows each to be optimized for the magnitude of data, traffic patterns, and bandwidth of each network applications. A further added benefit is that of being able to control the power density of the system by spacing memory and compute circuit packages to optimize cooling efficiency, as the distances and arrangements are not dictated by electrical interfaces.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A data processing apparatus comprising:
a first processor node comprising:
a first processor circuit;
a first memory switch in electrical communication with the first processor circuit; and
a first on-chip memory in electrical communication with the first memory switch;
a first photonic transceiver in electrical communication with the first memory switch in parallel with the first processor circuit and in photonic communication with a photonic link;
a second processor node comprising:
a second processor circuit;
a second memory switch in electrical communication with the second processor circuit; and
a second on-chip memory in electrical communication with the second processor circuit; and
a second photonic transceiver in electrical communication with the second memory switch in parallel with the second processor circuit and in photonic communication with the photonic link.

2. The data processing apparatus of claim 1, wherein the photonic link is a bidirectional photonic link.

3. The data processing apparatus of claim 1, wherein the photonic link comprises an optical waveguide.

4. The data processing apparatus of claim 1, further comprising:
a first electronic integrated circuit comprising the first processor node;
a second electronic integrated circuit comprising the second processor node;
a first photonic integrated circuit comprising the first photonic transceiver; and
a second photonic integrated circuit comprising the second photonic transceiver.

5. The data processing apparatus of claim 4, wherein the photonic link is optically coupled to the first photonic integrated circuit and the second photonic integrated circuit.

6. The data processing apparatus of claim 1, further comprising a non-transitory computer storage medium encoded with a computer program, the computer program comprising instructions that when executed by data processing apparatus cause the data processing apparatus to perform operations comprising:
receiving, by the first photonic transceiver, data from the first on-chip memory;
transmitting, by the first photonic transceiver over the photonic link, the data to the second photonic transceiver;
receiving, by the second photonic transceiver from the photonic link, the data; and
storing, the data in the second on-chip memory.

7. The data processing apparatus of claim 1, wherein at least one of the first on-chip memory and the second on-chip memory comprise static random-access memory (SRAM) circuitry.

8. The data processing apparatus of claim 1, wherein the first on-chip memory and the second on-chip memory are level 1 (L1) processor cache memories.

9. A method for processing data, the method comprising:
receiving, by a first memory switch of a first processor node, data from a first on-chip memory of the first processor node, wherein the first processor node comprises a first processor circuit;
receiving, by a first photonic transceiver, the data from the first memory switch, wherein the first photonic transceiver is in electrical communication with the first memory switch in parallel with the first processor circuit;
transmitting, by the first photonic transceiver, the data over a photonic link;
receiving, by a second photonic transceiver, the data from the photonic link;
transmitting, by the second photonic transceiver, the data to a second memory switch of a second processor node comprising a second processor circuit, wherein the second photonic transceiver is in electrical communication with the second memory switch in parallel with the second processor circuit; and
storing, by the second memory switch, the data in a second on-chip memory of the second processor node.

10. The method of claim 9, wherein the photonic link is a bidirectional photonic link.

11. The method of claim 9, wherein the photonic link is an optical waveguide.

12. The method of claim 9, wherein the photonic link is optically coupled to a first photonic integrated circuit comprising the first photonic transceiver and a second photonic integrated circuit comprising the second photonic transceiver.

13. The method of claim 9, wherein a first electronic integrated circuit comprises the first processor node and a second electronic integrated circuit comprises the second processor node.

14. The method of claim 9, wherein at least one of the first on-chip memory and the second on-chip memory comprise static random-access memory (SRAM) circuitry.

15. The method of claim 9, wherein the first on-chip memory and the second on-chip memory are level 1 (L1) processor cache memories.

16. A method for processing data, the method comprising:
a first processor node comprising:
one or more first processor circuits;
a first memory switch in electrical communication with the first processor circuit;
a first on-chip memory in electrical communication with the first memory switch; and
a first non-transitory memory, computer-readable medium storing one or more machine-readable instructions that, when executed, cause the one or more first processor circuits to perform first operations;
a first photonic transceiver in electrical communication with the first memory switch in parallel with the first processor circuit and in photonic communication with a photonic link;
a second processor node comprising:
one or more second processor circuits;
a second memory switch in electrical communication with the second processor circuit;
a second on-chip memory in electrical communication with the second processor circuit; and
a second non-transitory memory, computer-readable medium storing one or more machine-readable instructions that, when executed, cause the one or more second processor circuits to perform second operations; and
a second photonic transceiver in electrical communication with the second memory switch in parallel with the second processor circuit and in photonic communication with the photonic link,
wherein the first operations and the second operations comprise performing a matrix multiplication operation in which operation data is transported between the first memory switch and the second memory switch over the photonic link.

17. The method of claim 16, wherein the photonic link is an optical waveguide.

18. The method of claim 16, wherein the photonic link is optically coupled to a first photonic integrated circuit comprising the first photonic transceiver and a second photonic integrated circuit comprising the second photonic transceiver.

19. The method of claim 16, wherein a first electronic integrated circuit comprises the first processor node and a second electronic integrated circuit comprises the second processor node.

20. The method of claim 16, wherein at least one of the first on-chip memory and the second on-chip memory comprise static random-access memory (SRAM) circuitry.

21. The method of claim 16, wherein the first on-chip memory and the second on-chip memory are level 1 (L1) processor cache memories.
